(19) United States
(12) Patent Application Publication
(10) Pub. No.: US 2025/0319521 A1
(43) Pub. Date: Oct. 16, 2025

(54) NON-DESTRUCTIVE IDENTIFICATION, EVALUATION AND CALIBRATION TECHNIQUE FOR FUSIBLE POWDERS

(71) Applicant: The Research Foundation for The State University of New York, Binghamton, NY (US)

(72) Inventors: Scott N. Schiffres, Vestal, NY (US); Srikanth Rangarajan, Binghamton, NY (US); Sina Ghadi, Binghamton, NY (US)

(21) Appl. No.: 19/177,470

(22) Filed: Apr. 11, 2025

Related U.S. Application Data
(60) Provisional application No. 63/633,025, filed on Apr. 11, 2024.

(51) Int. Cl. B22F 10/85; B22F 12/90; B33Y 30/00; B33Y 50/02; G01N 25/18

(52) U.S. Cl. CPC B22F 10/85; B22F 12/90; B33Y 30/00; B33Y 50/02; G01N 25/18; B22F 2301/052; B22F 2301/10; B22F 2301/15; B22F 2301/205; B22F 2301/35; B22F 2304/10

(57) ABSTRACT

A method of analyzing an additive manufacturing powder, comprising: providing a layer of the additive manufacturing powder on a structure; irradiating the powder with a localized energy beam; measuring a thermal response over time of a region of the additive manufacturing powder in conjunction with the irradiating; and processing the measured thermal response with a classification processor trained with data dependent on at least one classification criterion selected from the group consisting of a composition of the additive manufacturing powder, a reuse history of a portion of the additive manufacturing powder, particle size characteristics of the additive manufacturing powder, an aging of the additive manufacturing powder, an oxidation of the additive manufacturing powder, and an adulteration of the additive manufacturing powder.

### CROSS REFERENCE TO RELATED APPLICATIONS

This application is a Non-provisional of, and claims benefit of priority under 35 U.S.C. § 119(c) of, U.S. Provisional Patent Application No. 63/633,025, filed Apr. 11, 2024, the entirety of which is expressly incorporated herein by reference.

### GOVERNMENT SUPPORT CLAUSE

This invention was made with government support under Contract No. 70NANB22H085 awarded by NIST. The government has certain rights in the invention.

### FIELD OF THE INVENTION

The present invention relates to the field of identification and evaluation of powders, especially for powder based additive manufacturing processes including laser powder bed fusion (L-PBF), electron beam powder bed fusion (EB-PBF), and directed energy deposition (DED), and/or calibration of these machine's energy source and steering mechanisms.

### INCORPORATION BY REFERENCE AND INTERPRETATION OF LANGUAGE

Citation or identification of any reference herein, in any section of this application, shall not be construed as an admission that such reference is necessarily available as prior art to the present application. The disclosures of each reference disclosed herein, whether U.S. or foreign patent literature, or non-patent literature, are hereby incorporated by reference in their entirety in this application, and shall be treated as if the entirety thereof forms a part of this application.

All cited or identified references are provided for their disclosure of technologies to enable practice of the present invention, to provide basis for claim language, and to make clear applicant's possession of the invention with respect to the various aggregates, combinations, and subcombinations of the respective disclosures or portions thereof (within a particular reference or across multiple references). The citation of references is intended to be part of the disclosure of the invention, and not merely supplementary background information. The incorporation by reference does not extend to teachings which are inconsistent with the invention as expressly described herein (which may be treated as counter examples), and is evidence of a proper interpretation by persons of ordinary skill in the art of the terms, phrase and concepts discussed herein, without being limiting as the sole interpretation available.

The present specification is not to be interpreted by recourse to lay dictionaries in preference to field-specific dictionaries or usage. Where a conflict of interpretation exists, the hierarchy of resolution shall be the express specification, references cited for propositions, incorporated references, the inventors' prior publications relating to the field, academic literature in the field, commercial literature in the field, field-specific dictionaries, lay literature in the field, general purpose dictionaries, and common understanding. Where the issue of interpretation of claim amendments arises, the hierarchy is modified to include arguments presented during the prosecution, relating to an element present in a respective claim, and accepted to overcome a rejection, without retained recourse.

### BACKGROUND OF THE INVENTION

While additive manufacturing (AM) has emerged as a transformative technology for various industries (Azizi et al., 2019; Bourell, 2016), the presence of random defects within printed parts remains a significant hindrance to its widespread adoption. The occurrence of defects in the metal 3D printing process demands constant monitoring to ensure the production of a final 3D metal part meets quality requirements (Brennan et al., 2021). Commonly, defects may arise in three distinct sections: (1) powder feedstock (2) defects as a result of the printing process, and (3) during the post-processing treatment (Cunningham et al., 2017; Cunningham, 2018; Gong et al., 2014; Ng et al., 2009; Slotwinski et al., 2014; Tammas-Williams et al., 2015).

There are various technologies describing additive in situ non-destructive testing for techniques that use coaxial thermography, total bed thermography, optical monitoring, and recoater vibration. (Cheverton and Jr, 2015; Clijsters et al., 2014; Craeghs et al., 2012; Grasso and Colosimo, 2017; Kleszczynski, 1973.; Mani et al., 2015; Toeppel et al., 2016). There is a lack of technology for identifying powders (other than by declarative identification).

While optical techniques can use image processing or reflectivity to determine the roughness of surfaces and can detect powder feed issues, they are at a loss to determine many critical physical properties of the printed part or powder, such as the thermal conductivity, powder size, and microstructure. Recoater vibration, another in situ monitoring technique, measures recoater acceleration during powder deposition. Recoater acceleration can detect part failures, like those that occur when critical overhang geometries warp severely, or it can detect grossly incorrect processing parameters (e.g., surface roughness or balling), but it fails to detect many defect types.

The importance of feedstock quality assessment and assurance to the field has been noted as high priority by the Standardization Roadmap for Additive Manufacturing v2.0 (ANSI, 2018). In particular, PM5: Metal Powder Feedstock Sampling identified that the methods to test powder feedstock, the sampling interval, and quantity sampled are not well standardized. The environmental condition directly impacts powder quality through the formation of oxide/hydroxide and adsorbed water films (Derimow and Hrabe, 2021; Rock et al., 2021; Tang et al., 2015). The importance of understanding these conditions was highlighted in Gap PC9: Environmental conditions: Effects on Materials and Gap PC7: Recycle & Re-use of Materials. For instance, hollow powder particles are also an issue.

Direct degradation of powder is not currently measured in the field, but instead estimated by tracking the number of reuse cycles and spot checking of elemental composition (Groarke et al., 2021; Gruber et al., 2024). Field testing of powder is currently limited to flowability testing (Zegzulka et al., 2020). Flowability testing involves measuring the time it takes for powder to flow through a small funnel (B09 Committee). This testing can detect certain anomalies that affect flowability, but is very crude and does not allow distinct measurement of oxide thickness, internal oxide concentration, and powder size distribution. More precise characterization of the powder is typically conducted by external testing labs at the request of the system integrators who purchase printed components. Many L-PBF part customers have prior experience that demonstrates suitability for a certain number reuse cycles. However, this knowledge does not translate between builds or truly track the evolution of powder, hence the need for better characterization.

The literature has found defects in powder in terms of roughness of the powder, for instance due to an oxide layer, powder size distribution that reduces packing density of powder, internal oxygen content, aging induced elemental composition (e.g., fade of V/Al in Ti64), hollow particles, satellite particles (Brennan et al., 2021; Fu et al., 2022; Kim and Moylan, 2018). Moreover, powders can become contaminated with the welding and splatter debris. Mixing up powders, like Grade 5 vs 23 Ti64, or accidental contamination (e.g., from seals) or mixing of different powder types by accident are also possible (Montazeri et al., 2018; Santecchia et al., 2019). A method to detect these properties of powders in the field would be valuable, as characterizing these properties requires expensive specialized equipment (e.g., scanning electron microscopy, transmission electron microscopy, powder size distribution tester, x-ray photospectroscopy, LECO). See, Kleszczynski, 1973.

Various techniques are available for classification, identification, or quantification of a source of an effect in data. Sec, e.g., Osisanwo, F. Y., J. E. T. Akinsola, O. Awodele, J. O. Hinmikaiye, O. Olakanmi, and J. Akinjobi. “Supervised machine learning algorithms: classification and comparison.” International Journal of Computer Trends and Technology (IJCTT) 48, no. 3 (2017): 128-138.

Supervised Machine Learning (SML) is the search for algorithms that reason from externally supplied instances to produce general hypotheses, which then make predictions about future instances. Supervised classification is one of the tasks most frequently carried out by intelligent systems. Seven different machine learning algorithms are common: Decision Table, Random Forest (RF), Naïve Bayes (NB), Support Vector Machine (SVM), Neural Networks (Perceptron), JRip and Decision Tree.

Supervised machine learning algorithms useful for classification include: Linear Classifiers, Logistic Regression, Naïve Bayes Classifier, Perceptron, Support Vector Machine; Quadratic Classifiers, K-Means Clustering, Boosting, Decision Tree, Random Forest (RF); Neural networks, Bayesian Networks, etc.

UMAP (Uniform Manifold Approximation and Projection): A manifold learning technique for dimension reduction. UMAP is constructed from a theoretical framework based in Riemannian geometry and algebraic topology. At a high level, UMAP uses local manifold approximations and patches together their local fuzzy simplicial set representations to construct a topological representation of the high dimensional data. Given some low dimensional representation of the data, a similar process can be used to construct an equivalent topological representation. UMAP then optimizes the layout of the data representation in the low dimensional space, to minimize the cross-entropy between the two topological representations. Furthermore, UMAP has no computational restrictions on embedding dimension, making it viable as a general purpose dimension reduction technique for machine learning.

Linear Classifiers: Linear models for classification separate input vectors into classes using linear (hyperplane) decision boundaries. The goal of classification in linear classifiers in machine learning, is to group items that have similar feature values, into groups. A linear classifier achieves this goal by making a classification decision based on the value of the linear combination of the features. A linear classifier is often used in situations where the speed of classification is an issue, since it is rated the fastest classifier. Also, linear classifiers often work very well when the number of dimensions is large, as in document classification, where each element is typically the number of counts of a word in a document. The rate of convergence among data set variables however depends on the margin. Roughly speaking, the margin quantifies how linearly separable a dataset is, and hence how easy it is to solve a given classification problem.

Logistic regression: This is a classification function that uses class for building and uses a single multinomial logistic regression model with a single estimator. Logistic regression usually states where the boundary between the classes exists, also states the class probabilities depend on distance from the boundary, in a specific approach. This moves towards the extremes (0 and 1) more rapidly when data set is larger. These statements about probabilities which make logistic regression more than just a classifier. It makes stronger, more detailed predictions, and can be fit in a different way; but those strong predictions could be wrong. Logistic regression is an approach to prediction, like Ordinary Least Squares (OLS) regression. However, with logistic regression, prediction results in a dichotomous outcome. Logistic regression is one of the most commonly used tools for applied statistics and discrete data analysis. Logistic regression is linear interpolation.

Naive Bayesian (NB) Networks: These are very simple Bayesian networks which are composed of directed acyclic graphs with only one parent (representing the unobserved node) and several children (corresponding to observed nodes) with a strong assumption of independence among child nodes in the context of their parent. Thus, the independence model (Naive Bayes) is based on estimating. Bayes classifiers are usually less accurate that other more sophisticated learning algorithms (such as ANNs).

Multi-layer Perceptron: This is a classifier in which the weights of the network are found by solving a quadratic programming problem with linear constraints, rather than by solving a non-convex, unconstrained minimization problem as in standard neural network training. Other well-known algorithms are based on the notion of perceptron. The Perceptron algorithm is used for learning from a batch of training instances by running the algorithm repeatedly through the training set until it finds a prediction vector which is correct on all of the training set. This prediction rule is then used for predicting the labels on the test set.

Support Vector Machines (SVMs): Support Vector Machine (SVM) models are closely related to classical multilayer perceptron neural networks. SVMs revolve around the notion of a “margin”, either side of a hyperplane that separates two data classes. Maximizing the margin and thereby creating the largest possible distance between the separating hyperplane and the instances on either side of it has been proven to reduce an upper bound on the expected generalization error.

Independent Component Analysis: Independent component analysis (ICA) is an unsupervised method for extracting individual signals from a multivariate signal. ICA decomposes the given dataset into components so that each component is statistically independent from the others and assumed to be non-Gaussian.

Principal component analysis (PCA) (also known as Karhunen-Loeve expansion): PCA is a classical feature extraction and data representation algorithm. Principal component analysis identifies uncorrelated components from correlated variables, and a few of these uncorrelated components usually account for most of the information in the input variables. The main purpose of principle component analysis (PCA) is to transform correlated metric variables into a much smaller number of uncorrelated variables called principal components (PCs), which contain most of the information from the original variables. Each component is interpreted as a separate entity representing a latent trait or profile in a population. If the normality assumption does not hold, components are guaranteed to be uncorrelated, but not independent. If the independence assumption is violated, each component cannot be uniquely interpreted because of contamination by other components.

Singular Value Decomposition (SVD): a generalization of the eigen-decomposition which can be used to analyze rectangular matrices (the eigen-decomposition is defined only for squared matrices). By analogy with the eigen-decomposition, which decomposes a matrix into two simple matrices, the main idea of the SVD is to decompose a rectangular matrix into three simple matrices: Two orthogonal matrices and one diagonal matrix.

K-means: K-means is one of the simplest unsupervised learning algorithms that solve the well-known clustering problem. The procedure follows a simple and easy way to classify a given data set through a certain number of clusters (assume k clusters) fixed a priori K-Means algorithm is be employed when labeled data is not available.

Decision Trees: Decision Trees (DT) are trees that classify instances by sorting them based on feature values. Each node in a decision tree represents a feature in an instance to be classified, and each branch represents a value that the node can assume. Instances are classified starting at the root node and sorted based on their feature values. Decision tree learning, used in data mining and machine learning, uses a decision tree as a predictive model which maps observations about an item to conclusions about the item's target value. More descriptive names for such tree models are classification trees or regression trees. Decision tree classifiers usually employ post-pruning techniques that evaluate the performance of decision trees, as they are pruned by using a validation set. Any node can be removed and assigned the most common class of the training instances that are sorted to it.

Instance-based Learning: Instance-based learning algorithms are lazy-learning algorithms, as they delay the induction or generalization process until classification is performed. Lazy-learning algorithms require less computation time during the training phase than eager-learning algorithms (such as decision trees, neural and Bayes nets) but more computation time during the classification process. One of the most straightforward instance-based learning algorithms is the nearest neighbor algorithm. Networks: Neural Networks (NN) that can actually perform a number of regression and/or classification tasks at once, especially when the NN is a deep neural network (DNN), stacked neural network, or parallel NN. The network may have a single output variable, although in the case of many-state classification problems, this may correspond to a number of output units (the post-processing stage takes care of the mapping from output units to output variables). Artificial Neural Networks (ANN) depend upon three fundamental aspects, input and activation functions of the unit, network architecture and the weight of each input connection. Given that the first two aspects are fixed, the behavior of the ANN is defined by the current values of the weights. The weights of the net to be trained are initially set to random values, and then instances of the training set are repeatedly exposed to the net. The values for the input of an instance are placed on the input units and the output of the net is compared with the desired output for this instance. Then, all the weights in the net are adjusted slightly in the direction that would bring the output values of the net closer to the values for the desired output. There are several algorithms with which a network can be trained.

Bayesian Network: A Bayesian Network (BN) is a graphical model for probability relationships among a set of variables (features). Bayesian networks are the most well-known representative of statistical learning algorithms. BNs, compared to decision trees or neural networks, may take into account prior information about a given problem, in terms of structural relationships among its features. A problem of BN classifiers is that they are not suitable for datasets with many features.

Generally, SVMs and neural networks tend to perform much better when dealing with multi-dimensions and continuous features. On the other hand, logic-based systems tend to perform better when dealing with discrete/categorical features. For neural network models and SVMs, a large sample size is required in order to achieve its maximum prediction accuracy whereas NB may need a relatively small dataset.

k-NN is very sensitive to irrelevant features. The presence of irrelevant features can make neural network training inefficient. Most decision tree algorithms cannot perform well with problems that require diagonal partitioning. The division of the instance space is orthogonal to the axis of one variable and parallel to all other axes. Therefore, the resulting regions after partitioning are all hyperrectangles. ANNs and the SVMs perform well when multi-collinearity is present and a nonlinear relationship exists between the input and output features.

Naive Bayes (NB) requires little storage space during both the training and classification stages: the strict minimum is the memory needed to store the prior and conditional probabilities. The basic kNN algorithm uses a great deal of storage space for the training phase, and its execution space is at least as big as its training space. On the contrary, for all non-lazy learners, execution space is usually much smaller than training space, since the resulting classifier is usually a highly condensed summary of the data. Moreover, Naive Bayes and the kNN can be easily used as incremental learners whereas rule algorithms cannot. Naive Bayes is naturally robust to missing values since these are simply ignored in computing probabilities and hence have no impact on the final decision. On the contrary, kNN and neural networks require complete records to do their work.

Classifiers may be implemented using specialized processors, e.g., to perform matrix operations and transformations in parallel o otherwise speed up the processing. Such processors may have a single instruction-multiple data (SIMD) architecture, common in graphics processing units (GPU).

### SUMMARY OF THE INVENTION

The present technology employs an analysis of a thermal response over time of an additive manufacturing powder to a localized heating with an energy source, to determine a classification, identification, parametric quantification, or characteristics of the additive manufacturing powder.

Typically, the thermal response is obtained by a photoelectric thermometer, though the sensor itself is not limited to optical pyrometers, and may include various types of non-contact thermal sensing and thermal radiation or emissivity sensing devices.

The input data may be calibrated or otherwise normalized before classification.

Typically, the thermal response is subjected to a Fourier transform (e.g., FFT) or Wavelet transform (e.g., DWT), though some processing embodiments do not require an explicit transform to precede other processing.

The data or transformed data is then classified using a statistical or machine learning algorithm trained based on samples of additive manufacturing powder over a range of conditions. For example, virgin additive manufacturing powder may be mixed in various percentages with sieved reused additive manufacturing powder, and the classification algorithm trained based on the thermal response of each sample. The samples may be over a full range of compositions, e.g., 1%, 2%, 3%, . . . , 99%, 100% virgin powder (including each and every percentage in between).

Alternately, one or both of the powders may include a tracer that does not interfere with processing, such as fluoresceine and/or rhodamine B, rhodamine 6G, in some cases, and the proportion of each powder determined by a fluorescent response. If the tracer is evenly distributed through the sample, a simple ratiometric fluorescent determination may be used to determine the local mix of powders on a surface. On this way, individual samples need not be prepared, and rather a non-deterministic process which results in variation in composition of the powder layer is sufficient.

The additive manufacturing powder may consist of a metal, a polymer, a ceramic, a hybrid. In some embodiments, the additive manufacturing powder may be used in laser or electron-beam based additive manufacturing. In some embodiments, the additive manufacturing powder may be used in binder jet-based additive manufacturing. It may also be used in pastes or slurries used for layerwise-templated additive manufacturing methods. While the invention was initially invented for additive manufacturing, broader applications exist to applications like batteries (e.g., analysis of cathode or anode), electronics (solder pastes and conductive inks), and other powder-based technologies.

This tracer technique may also be used to classify ternary, quaternary or higher mixtures, with a limit being the hyperspectral detection of the plurality of fluorescences.

Advantageously, the tracer is volatile or decomposes when the powder is used in an actual additive manufacturing (AM) process, allowing the used powder to relabeled with a different tracer after use without interference, and to determine the actual ratio of reuse in a powder sample.

A similar artificial blending of powders may be used to generate data exploring other classification criteria, such as (i) a composition of the additive manufacturing powder, (ii) a reuse history of a portion of the additive manufacturing powder, (iii) particle size characteristics of the additive manufacturing powder, an (iv) aging of the additive manufacturing powder, (v) an oxidation of the additive manufacturing powder, and (vi) an adulteration of the additive manufacturing powder. Note that there is no guaranty of linear response between these different classification conditions, and therefore classifier training should seek to encompass and label the range of all variables varied between samples, rather than presuming lack of interaction.

To detect the thermal response, a number of options are available. First, the powder may be monitored during an actual AM build process. In this case, one would naturally expect the quality of the powder to change during reuse, with a tendency toward degraded quality over time.

It is possible that small amounts of reuse may initially improve performance. Further, the virgin powder may be designed as slightly suboptimal, such that an improvement with initial reuse is expected. This may lead to improved cost efficiency, build quality, or reduced waste. Further, the reuse and replenishment may be synchronized with the build layers (or portions of layer), so that layers that require superior properties are formed with optimal powder to achieve those qualities, while layers that can tolerate diminished qualities may be built with powder that can only achieve the required quality. Note that the qualities of a powder are not unidimensional, and the set of qualities do not vary in strict relation. For example, while oxide may diminish strength, it may increase abrasivity and resistance to corrosion after build. Therefore, the controller may optimize the powder replenishment according to the state of the build. Further, according to the powder characteristics, which vary as a function of reuse, the controller may also vary the power, pulse duration, temperature, or other characteristics or parameters.

The system also seeks to determine when the bulk powder which is partly reused is beyond limits for the application. In some cases, the powder may be acceptable for some applications but not others, and therefore the AM powder may be collected and reused in a different machine or time (within the same build), or the AM device shifted to a different product.

When a laser energy source used in the test is also used for the AM powder classification, advantageously, the same laser optics as used for the manufacturing process may also be used to conduct the sensing. However, other optics may be employed.

The testing condition according to a preferred embodiment requires a dynamic state of the energy source which may be the same or distinct from the normal operational mode of the energy source during manufacturing. Two main options are available: spatial modulation and temporal modulation, or a combination. In the spatial modulation scheme, the energy source heats a local region, and is then moved to heat a different region, sufficiently far away that the desired thermal modulation exciting signal is generated. In the temporal modulation, the energy source is amplitude modulated, typically in a binary fashion, according to a desired pattern. For example, a laser energy source may be modulated at 100-1,000 Hz, and the response detected at regions surrounding the localized heating. Assuming that a laser is used for the sensing, frequency modulation of the laser beam is typically not available, though in some cases it can be achieved, or multiple emitters controlled to achieve a varying frequency and wavelength beam, which may represent multiple wavelengths concurrently.

The powder may also be assessed in a different location of the AM build chamber, using the normal energy source, before the powder is sought to be used in the product being manufactured. This allows the type and quality of the powder to be determined before it can contaminate a build.

The powder may also be assessed using a different energy source, either on the build or off the build. The energy source need not heat the powder to melting or sintering temperature, since the technology may rely on thermal transfer in the powder, and not thermal response of a melt pool.

After the machine intelligence (e.g., machine learning or classifier) is trained, one or more data samples is obtained, and classified using the machine learning (ML) or statistical classifier. The input is essentially a (normalized) magnitude of response and a change over time, and thus may be two data points. Practically, a much larger volume of data may be obtained, providing a full excitation and decay response. The classifier then produces a classification output, which typically is represented as one or more decisions. In other embodiments, the classifier may produce a partial membership function for one or more classes, i.e., a distance.

By providing different types of dynamic excitation of the powder, it is possible to interrogate a plurality of different properties of the AM powder. Thus, where a binary decision is required on a single parameter, a single type of interrogation may be sufficient. On the other hand, where multiple characteristics are sought to be interrogated and distinguished, such as particle size, roughness, oxides, contamination, etc., different types of interrogation may be used to distinguish and quantify these characteristics. Typically, a thermal sensing cannot orthogonally extract characteristics from the ASM powder, and therefore the machine intelligence is employed to separate the effects of the various characteristics. In some cases, another type of sensing may be employed in addition to the thermal interrogation. For example, oxidized AM powder may have different optical spectral characteristics than non-oxidized powder, and therefore a spectrometer employed to test the surface of the AM powder.

The present technology enables a method that can be implemented in the field to in-situ identify, characterize and evaluate powder. This technique can identify the powder material (e.g., AlSi10Mg, Ti64, Cu, SS316L, . . . ) core, powder type according to their chemical contents like oxygen (e.g., Ti64 G5 vs G23), powder age (e.g., fresh vs reused), powder deposition thickness and the substrate.

The technology essentially measures depth-resolved thermal conductivity and heat capacity. It does so by periodically modulating the laser heating source to thermally interrogate variable distances into the sample. The amplitude and phase versus frequency information versus time is dictated by powder composition, powder geometry, powder size distribution, packing density, interfacial resistance between powder particles, thermal conductivity of the core, the powder deposition thickness and the substrate material. The powder interfacial resistance is a function of contact area, roughness of the contact patch, particle sizes, exterior films (oxide films), multiple powder elements (e.g., two different materials). There can also be smaller particles touching only one other particle that do not contribute to thermal transport but have heat capacity. In some implementations the heat source is not a laser but a less focused energy source like an infrared lamp or LED. In some embodiments, the energy source is not modulated, but modulation-like heating is effected by the time-varying the spatial distribution of delivered energy.

This technology in some embodiments can be implemented using the heat source of the additive manufacturing tool, or alternately or in addition using a separate or standalone heat source unit. One benefit of implementing this technology within the tool is that the print can be assured of its powder quality throughout the print, and in some cases, feedback of powder quality may be used to control the heat source or other parameters of the process.

For instance, if powder is replenished during the print incorrectly due to negligence (e.g., sloppiness) or malfeasance (e.g., sabotage), it could be detected. In certain implementations, the key powder properties can be output by the tool such that an airgapped (or non-airgapped) processing computer can output a file with key properties. This file can be transmitted to customers and regulatory agencies. The file can contain the key powder identification data, and possibly also unique identifying information about the parts and batch. The file can use encryption to prevent unauthorized tampering. This file may form part of a permanent record associated with the manufactured part, and may be stored in a centralized database or on a blockchain, for example. The data on the blockchain may be public, or encrypted and limited to private access.

Further, in some implementations, an RF-ID or other tag or digital (physical or virtual) token may be associated with the build, and the manufacturing data, including data provided according to the present technology, loaded into the tag during manufacture. In a sequence of manufacturing steps, the tag may be used to control subsequent processes. For example, a downstream heat treatment or passivation step may be optimized based on prior determination of material quality and characteristics. The data may also be stored in a centralized database, on a blockchain (or data file referenced by a blockchain record), or other type of storage system.

The AM powder may also be associated with a datafile describing its provenance and characteristics on a blockchain or in a centralized database, which may record, for example, reference characteristics and tolerances on a lot-by-lot or batch-by-batch basis, which can facilitate in-process interrogation and characterization of the powder. Thus, the parameters of a neural network or classification algorithm may be provided with or associated with the AM powder, for example linked by a QR code on a container. The sensor system of the AM manufacturing system is first calibrated so that the output is normalized, and then the parameters used to classify the AM powder after reuse, without having to locally train a classifier. Alternately, the classification may be performed remotely or in the “cloud”, and not locally to the AM machine.

The present technology allows facile “fingerprinting” or identification of powders by analyzing the thermal frequency domain radiated signal from the powder bed. In particular, a frequency response of the powder or fused powder to a dynamically change in a heating excitation is measured at several times to determine the powder type and/or characteristics. In a typical case, the heating capability is sufficient to cause a melting or fusion of the powder at the heating location, which achieves a number of advantages. First, by causing a consolidation of the powder, the air gaps are removed, and the characteristics of the solid resulting material may be interrogated. Second, the characteristics of the powder within a critical regime (sintering, melting and/or fusion) is determined, since the purpose of the powder and machine is to build a solid structure from the powder. Third, the frequency domain characteristics are more pronounced and reliable in the consolidated material than in the unconsolidated powder with air interfaces. However, the interrogation of powder characteristics need not involve heating the powder to a fusion, melting or sintering temperature. In particular, where the characteristics interrogation is performed separately from an additive manufacturing process, the fusion, melting or sintering would be considered a destructive testing and should not be performed on the portion of the powder which is to become part of the end product. Where the interrogation of characteristics is performed as part of the additive manufacturing process, the fusion, melting or sintering would be considered intrinsic, and may be readily performed on the portion of the powder which is to become part of the end product.

Traditional thermal modeling and simulations cannot be readily used to estimate the exact experimentally observed radiated thermal response, as the properties of the powder layer are not well known. The number of variables needed are staggering, from contact resistances between particles (which depends on geometry of particles, their surface roughness, oxide films), the powder surface's spectral emissivity versus temperature, the powder size distribution, deposition method, packing density. While certain approximations can currently be made treating the layer as having lumped properties, they will not predict the experimental data with high precision, as the input properties are not fully known. These difficult to know properties are what lead to unique responses of different powders using this technique.

This technology uses the dynamic thermal response of each powder deposition to identify powder characteristics. The thermal response is detected, for example, through optical (infrared) emissions from the heated portion of the powder. The thermal response may be detected in a small spatial region around the heating spot, or using a thermal array imager to detect thermal responses over a larger area.

The method for obtaining the thermal response data can take several forms. One implementation takes the frequency response phase and/or amplitude data versus time from the thermal sensor, and then reduces the data (e.g., down-sample to just a few points or use a polynomial to describe those points) and do this for several frequencies. The reduced data is then analyzed onboard the machine or possibly or in the cloud. Alternatively, the data can be stored and analyzed after the print or build.

In any case, processing of the reduced dataset can be used to measure closeness to a library of powders with known or reference characteristics (powder core material, powder size distribution, deposition thickness, age, reuse cycles, substrate) and the closeness of the sample under study to this library of properties can inform what the properties are. The techniques to derive important variables can be determined using machine learning (“ML”) and/or artificial intelligence (“AI”) techniques including neural networks (“NN”), k-nearest neighbors, principal component analysis (“PCA”), and a uniform manifold approximation and projection (UMAP).

The machine learning can be trained with a complete data set and all characteristics at once, or using a layered process that first identifies the core material and using that finding to send the reduced data to AI/ML function specifically trained for that material set. Where the training data is obtained in an experimental paradigm, changes in single properties may be isolated, and the effect of such single variation determined. Where the data is obtained from specimens, multiple variables may change between tests, and the data analysis must account for the full range of variations.

The power can be set to minimally impact the powder, or higher to sinter or melt the powder after a short period of time (˜10 microseconds to ˜1 second). The data may be obtained over a range of power levels. Note that when an imaging array is used to obtain the thermal response data, the peak temperature distant from the nominal heating point will be lower than at the center, and therefore the range of peak heating temperatures is available without explicit interrogation at that temperature. However, there are other reasons to control the peak thermal energy and therefore temperature of the nominal interrogation spot.

In many embodiments, the interrogation heating can be delivered by the heat source used in the manufacturing process (e.g., laser for laser powder bed fusion, or electron beam for electron beam powder bed fusion), but it could also be a stand-alone heat source (e.g., laser) for a process unrelated to powder bed fusion. To reduce power or make the spot size approach a common uniform size, defocusing can be done intentionally in some applications.

The technology measures a phase lag using the difference between the heating (e.g., laser heating) and radiated thermal emission. The phase lag requires measuring the phase difference between the laser heating and radiated thermal response. The periodic signal to the laser could be used as a reference to determine the phase of the laser, however, the electronics of the laser driver could lead to an additional phase dependent lag. This frequency dependent lag can be corrected by measuring the phase lag of the driver system by measuring the laser response with a photodiode. Alternatively, a second photodiode can measure the thermal input and serve as the reference from which phase is measured.

The view factor from the build plate to the photodiode will not affect the frequency-domain phase signal, but will impact the amplitude signal. Installations of the system may therefore benefit from calibration. To do this, a solid metal surface or a known powder of uniform character can be used to normalize the signal spatially. In particular, specific transitions in phase and amplitude can indicate when a certain temperature has been surpassed (e.g., melting, or removal of oxide). This signal can then be used to calibrate relative amplitudes to those in the library of known powder responses. The calibration can also help calibrate the lasers themselves and the relative power of the lasers. If the sensing optics do not maintain position with respect to the concentrated energy spot, then a calibration for parallax, i.e., x and y offset, may also be performed.

In some embodiments, the calibration of the laser power and optics will proceed by using a material over the build platform with a known melting point. From the temperature sensing data, the time of melting or other phase change can be inferred due to a transitory period of relatively constant temperature followed by an again increasing temperature. The laser power can therefore be inferred from the time to melt or have a phase change. Shorter times to melt indicate greater heating than slower. By setting the time to melt to that in a standard operating procedure or calibration procedure, the absorbed power can be calibrated. The material used for calibration on the buildplate or test platform can be a solid that melts at a temperature near to materials of interest that does not readily oxidize, so storage of the test artifact has minimal impact on calibration. It could also be powder that is deposited a controllable thickness over the buildplate.

The electromagnetic waves emitted from the surface collected by a sensor detecting these waves is a function of the sensitivity of the diode, the view factor of the heated region to the diode, and the emissivity of the surface weighted by the spectral sensitivity of the sensor. These sensors can broadly be called a pyrometers, which encompasses infrared detectors, photodiodes, infrared cameras, bolometers, and optical cameras. The calibration of the photodiode with powder with controllable emissivity can be used to calibrate a photodiodes view factor and sensitivity. A point heated far off axis from the detector on the edge of the build platform or test plate will have a smaller percentage of emitted radiation collected by the sensor owing to the reduced view factor, while an axis point will have more. Having the power already calibrated by per the above procedure or another means, the amplitude of the signal by the photodiode can be calibrated for multiple points on the buildplate and interpolated between.

The calibration can also help calibrate any phase lag in pump driving electronics and the sensing electronics. This can be done by removing any optical filters that block the pump (heating source) wavelengths and looking at the frequency-dependent phase lag picked up by the electronics. This phase lag can then be subtracted off future measurements. An alternative calibration, or validation, that does not require removal of the pump-blocking filter uses a known material (powder of known thickness, or solid material) and checks the phase lag (or delay) of the thermal signal with a reference response.

The technology can also be used to calibrate the laser for use in melting and account for spatial variation in the laser power over the buildplate to account. This can be helpful as laser power can drift over time. The technology can also be used to calibrate any galvanometer (galvo) or steering system. A buildplate with defined regions of calibration material can also be used, so that the response can be located to a specific region on the buildplate, and therefore permit calibration of the spatial map of the steering system.

The classifier or machine learning model can also be calibrated either with or without the aforementioned calibration. The classifier calibration or validation can be samples similar to the materials of interest by that user. Samples of known good and bad quality can be used so the classifier can detect. The test samples can be multi-dimensional, and vary not just between known good and bad samples, but in many cases also varying powder size distribution, age, powder core material, oxide thickness, shell thickness, inter-particle contact resistance, roughness, moisture content of powder, deposition thickness, underlying substrate, and packing density.

The view factor from the build plate to the photodiode will not affect the frequency-domain phase signal, but will impact the amplitude signal. Installations of the system may therefore benefit from calibration. To do this, a solid metal surface or a known powder of uniform character can be used to normalize the signal spatially. In particular, specific transitions in phase and amplitude can indicate when a certain temperature has been surpassed (e.g., melting, or removal of oxide). This signal can then be used to calibrate relative amplitudes to those in the library of known powder responses. The calibration can also help calibrate the lasers themselves and the relative power of the lasers. If the sensing optics do not maintain position with respect to the concentrated energy spot, then a calibration for parallax, i.e., x and y offset, may also be performed.

The technology embodies a method to detect adulteration of the powder by comparing known good powder or powders and a library of other powders. For example, the powder being assessed is a virgin powder, though adulteration or counterfeiting can also be assessed in reused powders. The “distance” of the measured signal to known good powder or powders signal can trigger an alarm or note to check the powder. The “distance” of the signal can be calculated by a square error to a “known good” powder, or by using a transform basis set (principal component analysis transform).

Reuse extent can be determined by training machine learning algorithms with known fresh, and excessively reused powders, and typically the range of powders as they evolve during use/reuse. In some embodiments, acceptable but reused powders will also be in the library and the distance of the reduced experimental data set can be compared with the distance to different reuse extents. The distance calculating function can be determined from ML/AI techniques. Similarly, oxidation extent can also be determined by comparison to known oxidized samples (e.g., using LECO values from G5 and G23 Ti64 samples).

Powder size distribution can also be estimated from the signal by comparison to datasets from the same powder that has been sieved for different particle size distributions. The powder size influences the thermal response, as it controls the number of interfaces heat has to travel through. Smaller powder particles may also add thermal capacity by sticking to another larger particle while not contributing to vertical and lateral thermal transport. Therefore, the powder size distribution can greatly impact the periodic thermal response.

Counterfeit or adulterated powders can also be detected due to differences in the powder size distribution and powder morphology that change the thermal response of the powder. In some cases, an authentic powder supplier will include a tracer that is specifically detectable in the sensor (or alternate sensor) response, without otherwise interfering with normal processing of the powder. For example, the tracer may be a thermally decomposing component in small concentration, such as titanium tetraiodide

In some embodiments, identification of the powder by closeness to a known loci of acceptable powders can be recognized by the software or algorithm.

Embodiments of this technology can also identify powder thickness, or lack of powder and the identity of the substrate. The thickness of powder could be used to infer issues in powder recoating, or flatness of the buildplate relative to the recoater for automatic leveling in some embodiments.

In some embodiments, this framework can also identify fade of alloying elements by comparing to an experimental library of powders with observed fade. Fade is particularly an issue in electron beam additive manufacturing, where the combination of high bed temperature and vacuum can fade lower vapor pressure metals.

The mixing of powders can also be identified, if two materials are being used for multi-material printing. The loci of mixed powders can be determined by using a library including mixed metal combinations. Multi-material printers (e.g., directed energy deposition machines with multiple material feedstocks, or L-PBF machines with multiple powder recoaters) have certain multi-material systems that are used and mixtures of these powders can be added to the library of known powders for distinguishing between mixtures of these powders.

The process exposures can be tuned based on the thermal determination from the low power interrogation. In particular, the processing can apply knowledge of the substrate and powder from the identification.

In machines that lack the ability to modulate the power of the laser on a part, an input part file that achieves spatial modulation in a spot over time during the build can be used to achieve a similar effect to direct modulation of the laser. For instance, a small region can be exposed for 1 ms, then laser exposure paused at that location, by writing a region with no laser powder, writing a spatially distant region, or skywriting, and then repeating this process.

The powder test can be done for some embodiments in a vessel with depressions for the different powder species. The different depressions can be filled with a known calibration powder for calibration of the setup.

With this technology, testing can occur at the beginning of the print at certain points on the build plate that are reserved for powder testing. The testing can continue periodically as the part builds up. If a shortfeed is detected, it can alert an alarm that pauses the print. Likewise, if the powder quality is somehow found non-standard it can also trigger an alert.

The signals from the photodiode sensing thermal signal can be read with a digital data acquisition system, with the frequency domain transformation implemented in software. Alternatively, a hardware lock-in amplifier can convert the measured signal to the frequency domain.

The modulation in some embodiments can be achieved by intercepting the analog signal to the laser and modulating it at certain points in the print. For instance, the first part file printed can be dummy part that is for testing powder quality, and therefore modulation of the laser power during a build independent of the build geometry would not be unacceptable.

This technology enables multiple modulation frequencies to be tested concurrently at either one spot, or to have multiple spots tested simultaneously that are tested at non-overlapping frequencies (to avoid cross-talk). The driving heating waveform can be composed of a plurality of frequencies and the thermal response can simultaneously measure these simultaneously by Fourier transform.

A particular embodiment employs a photodiode with a laser blocking filter and a collecting optic (imaging or non-imaging optic). It is preferred to collect as much of the emitted radiation as possible, so mounting the optics on the top with a large lens or reflection-based collector is desired. The photodiode is responsive to photons in the infrared spectrum, and therefore the total emission to which the photodiode is responsive corresponds to the temperature.

Some embodiments can observe the response using a photodiode inline with the laser beam, but this is not required. In some embodiments a 2D camera can be employed that is sensitive to the thermal emissions in the infrared or visible spectra.

The technology provides a method to tune and/or calibrate single or multiple lasers, or other power sources, so that they have similar powers. Calibration of multiple lasers having different spatial orientation can be an issue. The maximum thermal response will occur when the two lasers are co-aligned, so the laser beams can be spatially swept in the expected region to find the area of maximal radiated signal. Doing this in the frequency domain can be a further benefit, as multiple lasers can be calibrated simultaneously. This method for tuning the lasers can also be used to adjust the focus, as the focal point of the laser will be minimized when the amplitude signal is maximized.

It is therefore an object to provide a method of analyzing an additive manufacturing powder, comprising: measuring a dynamic thermal response over time to a thermal wave propagating through a layer of additive manufacturing powder; and classifying at least one characteristic of the additive manufacturing powder based on the measured dynamic thermal response to the thermal wave and at least one classification criterion.

The method may further comprise irradiating a portion of the layer with a localized energy beam, to excite the thermal wave. The portion of the layer irradiated by the localized energy beam may be displaced from a location of measurement of the dynamic thermal response over time to the thermal wave in the layer.

The at least one characteristic of the additive manufacturing powder may be selected from the group consisting of a composition, a reuse history, a particle size characteristic, an aging, an oxidation, a density, a specific heat, a volumetric heat capacity, an effective thermal conductivity, a thermal conductivity of particle core, a thermal conductivity of particle shell, an interfacial thermal resistance, a phase change temperature, a phase change energy, an optical absorptivity, an infrared emissivity, a deposition thickness, an inter-particle thermal resistance, a substrate-particle thermal resistance, and an adulteration.

The classification may comprise using a classification processor trained with empirical data, to classify the additive manufacturing powder.

The classification processor may comprise a statistical classifier. The classification processor may implement at least one of a neural network, a linear discriminant analysis, a naïve Bayesian classification, a K-nearest neighbors analysis, a support vector machine, an independent component analysis, a principal component analysis, a kernel principal component analysis, a uniform manifold approximation and projection, graph network analysis, a blind source separation, a factor analysis, a non-negative matrix factorization, a multidimensional scaling, a singular value decomposition, a local linear embedding, a Laplacian Eigenmapping, and a t-Distributed Stochastic Neighbor Embedding.

The method may further comprise calibrating at least one of a characteristic of the additive manufacturing powder, and a measurement of the dynamic thermal response over time.

The layer may be within an additive manufacturing machine having a localized energy beam adapted in a first state to excite the dynamic thermal response without causing fusion of the powder, and in a second state to induce fusion of the powder.

The layer may also be within an additive manufacturing machine having a localized energy beam to induce fusion of the powder, further comprising adjusting at least one of a focus, an energy, a scanning speed, and a scanning path of the localized energy beam in dependence on the measured dynamic thermal response.

The method may further comprise detecting a phase transition of the additive manufacturing powder in dependence on the measured dynamically measured thermal response.

It is also an object to provide a method of analyzing a powder, comprising: providing a layer of the powder on a structure; irradiating a region of the powder with a localized energy beam; measuring a dynamic thermal response of the layer of powder outside of the region to the irradiating over time; and classifying the measured thermal dynamic thermal response using a machine learning processor trained with data dependent on at least one classification criterion of the powder selected from the group consisting of a composition, a history of use, a particle size characteristic, an aging, an oxidation, a density, a specific heat, a volumetric heat capacity, a effective thermal conductivity, thermal conductivity of particle core, a thermal conductivity of particle shell, an interfacial thermal resistance, a phase change temperature, a phase change energy, an optical absorptivity, an infrared emissivity, a deposition thickness, an inter-particle thermal resistance, a substrate-particle thermal resistance, and an adulteration.

The at least one classification criterion may be the composition of the powder.

The machine learning processor may comprise a neural network.

The layer may be provided within an additive manufacturing machine having the localized energy beam adapted in a first state to excite the dynamic thermal response without causing fusion of the powder, and in a second state to induce fusion of the powder.

The layer may be provided within an additive manufacturing machine having the localized energy beam to induce fusion of the powder, further comprising adjusting at least one of a focus, an or energy, a scanning speed, and a scanning path of the localized energy beam in dependence on the measured dynamic thermal response.

The layer may be provided within an additive manufacturing machine having the localized energy beam adapted in a first state to induce fusion of the powder, and in a second state to excite the dynamic thermal response without causing fusion of the powder, and wherein a first location of the localized energy beam on the layer of powder in the first state is different from a second location of the localized energy beam on the layer of powder in the second state.

The method may further comprise detecting a phase transition of the additive manufacturing powder in dependence on the measured dynamically measured thermal response.

It is a further object to provide a system for analyzing an additive manufacturing powder, e.g., a metal or polymer powder, comprising: an energy source configured to heat a region of a layer of the additive manufacturing metal powder with a time varying energy irradiation, to induce a thermal wave in the layer emanating from the region; a pyrometer or thermometer configured to measure an amplitude and phase of the induced thermal wave in the layer of powder from region spot over time; and a machine learning processor configured to predict a characteristic of the additive manufacturing metal powder in dependence on the measured amplitude and phase of the induced thermal wave in the layer of powder and training data for the machine learning processor.

The characteristic of the additive manufacturing powder may be selected from the group consisting of at least one of a composition, a mixture ratio, a reuse, a particle size characteristic, an aging, an oxidation, a density, a specific heat, a volumetric heat capacity, an effective thermal conductivity, a thermal conductivity of a particle core, a thermal conductivity of a particle shell, an interfacial thermal resistance, a phase change temperature, a phase change energy, an optical absorptivity, an infrared emissivity, a deposition thickness, an inter-particle thermal resistance, a substrate-particle thermal resistance, and an adulteration of the additive manufacturing powder.

The machine learning processor may implement at least one of a neural network, linear discriminant analysis, naïve Bayesian classification, a K-nearest neighbors analysis, a support vector machine, independent component analysis, principal component analysis, kernel principal component analysis, a uniform manifold approximation and projection analysis, graph network analysis, blind source separation, factor analysis, non-negative matrix factorization, multidimensional scaling, singular value decomposition, local linear embedding, Laplacian Eigenmapping, and a t-Distributed Stochastic Neighbor Embedding.

It is also an object to provide a method of analyzing a powder, comprising: providing a layer of the powder on a structure; irradiating a region of the powder with a localized energy beam; measuring a dynamic thermal response of the layer of powder outside of the region to the irradiating over time; and classifying the measured thermal dynamic thermal response using a machine learning processor trained with data dependent on at least one classification criterion selected from the group consisting of a composition of the powder, a history of the powder, a particle size characteristics of the powder, an aging of the powder, an oxidation of the additive, and an adulteration of the powder. The machine learning processor may comprise statistical classifier and/or a neural network.

The method may further comprise irradiating a portion of the layer with a localized energy beam, to excite the thermal wave. The portion of the layer irradiated by the localized energy beam may be displaced from a location of measurement of the dynamic thermal response over time to the thermal wave in the layer.

Wherein the localized energy beam will in many cases be a laser, but can include a laser, focused LED, electron beam, or infrared heat lamps. The localized energy beam can be focused to a small spot for applications to Laser Powder Bed Fusion (LPBF) or Electron Beam Powder bed Fusion (EBPBF), but may be diffuse for applications to binder jet applications.

The at least one characteristic may be selected from the group consisting of a composition of the additive manufacturing powder, a reuse history of the additive manufacturing powder, a particle size characteristic of the additive manufacturing powder, an aging of the additive manufacturing powder, an oxidation of the additive manufacturing powder, and an adulteration of the additive manufacturing powder.

The classification may comprise using a classification processor trained with empirical data, to classify the additive manufacturing powder. The classification processor may comprise a statistical classifier and/or an artificial neural network. The classification processor may implement at least one of a neural network, a linear discriminant analysis, a naïve Bayesian classification, a K-nearest neighbors analysis, a support vector machine, an independent component analysis, a principal component analysis, a kernel principal component analysis, a uniform manifold approximation and projection, a blind source separation, a factor analysis, a non-negative matrix factorization, a multidimensional scaling, a singular value decomposition, a local linear embedding, a Laplacian Eigenmapping, and a t-Distributed Stochastic Neighbor Embedding.

The layer may be provided within an additive manufacturing machine having a localized energy beam adapted in a first state to excite the dynamic thermal response without causing fusion of the powder, and in a second state to induce fusion of the powder.

The layer may be provided within an additive manufacturing machine having a localized energy beam to induce fusion of the powder, the method further comprising adjusting a focus or energy of the localized energy beam in dependence on the measured dynamic thermal response.

The method may further comprise detecting a phase transition of the additive manufacturing powder in dependence on the measured dynamically measured thermal response.

The layer may be provided within an additive manufacturing machine having the localized energy beam adapted in a first state to induce fusion of the powder, and in a second state to excite the dynamic thermal response without causing fusion of the powder, and wherein a first location of the localized energy beam on the layer of powder in the first state is different from a second location of the localized energy beam on the layer of powder in the second state.

Where fusion of the powder may encompass melting of the powder, fusing the powder by sintering at sub-melting point temperatures, or fusing into a green mediated by a binder.

The method may further comprise detecting a phase transition of the additive manufacturing powder in dependence on the measured dynamically measured thermal response.

Another object provides a system for analyzing an additive manufacturing metal powder, comprising: an energy source configured to heat a region of a layer of the additive manufacturing metal powder with a time varying energy irradiation, to induce a thermal wave in the layer emanating from the region; a pyrometer or thermometer configured to measure an amplitude and phase of the induced thermal wave in the layer of powder from region spot over time; and a machine learning processor configured to predict a characteristic of the additive manufacturing metal powder in dependence on the measured amplitude and phase of the induced thermal wave in the layer of powder and training data for the machine learning processor.

The characteristic may be at least one of a composition of the additive manufacturing powder, a mixture ratio of the additive manufacturing powder, a reuse of the additive manufacturing powder, particle size characteristics of the additive manufacturing powder, an aging of the additive manufacturing powder, an oxidation of the additive manufacturing powder, and an adulteration of the additive manufacturing powder.

The machine learning processor may implement at least one of a neural network, linear discriminant analysis, naïve Bayesian classification, a K-nearest neighbors analysis, a support vector machine, independent component analysis, principal component analysis, kernel principal component analysis, a uniform manifold approximation and projection analysis, blind source separation, factor analysis, non-negative matrix factorization, multidimensional scaling, singular value decomposition, local linear embedding, Laplacian Eigenmapping, and t-Distributed Stochastic Neighbor Embedding.

It is also an object to provide a method of analyzing an additive manufacturing powder, comprising: providing a layer of the additive manufacturing powder on a structure; irradiating the additive manufacturing powder with a localized energy beam; measuring a thermal response over time of a region of the additive manufacturing powder in conjunction with the irradiating; and processing the measured thermal response with a classification processor trained with data dependent on at least one classification criterion selected from the group consisting of a composition of the additive manufacturing powder, a reuse history of a portion of the additive manufacturing powder, particle size characteristics of the additive manufacturing powder, an aging of the additive manufacturing powder, an oxidation of the additive manufacturing powder, and an adulteration of the additive manufacturing powder.

The classification processor may implement a neural network, a discriminant analysis, a naïve Bayesian classification, a K-nearest neighbors analysis, a support vector machine, a principal component analysis, and/or a uniform manifold approximation and projection (UMAP).

A focus of the localized energy beam may be adjusted in dependence on the measured thermal response.

An energy level of the localized energy beam may be adjusted in dependence on the measured thermal response.

A phase transition of the additive manufacturing powder may be detected in dependence on the measured thermal response. This phase transition may then be used to adjust the power of the localized energy beam.

It is also an object to provide a method of analyzing a powder, comprising: providing a layer of the powder on a structure; irradiating a region of the powder with a localized energy beam; measuring a thermal response over time of the powder outside of the region to the irradiating; and classifying the measured thermal response using machine learning trained with data dependent on at least one classification criterion selected from the group consisting of a composition of the powder, a history of the powder, particle size characteristics of the powder, an aging of the powder, an oxidation of the additive, and an adulteration of the powder.

The classification processor may comprise a neural network. The classifying may comprise performing discriminant analysis, naïve Bayesian classification, a K-nearest neighbors analysis, implementation of a support vector machine, principal component analysis, and/or uniform manifold approximation and projection (UMAP).

A focus or power level of the localized energy beam may be adjusted in dependence on the measured thermal response. A phase transition of the powder may be detected in dependence on the measured thermal response. The phase transition will typically alter both an emissivity of the region in which the phase transition occurs, as well as thermal propagation properties of the region.

It is a further object to provide a method of analyzing a powder, comprising: providing a layer of the powder on a substrate; inducing a thermal transient in a potion of the powder; measuring an amplitude and phase propagation of the thermal transient in the layer of powder; and employing a deep neural network trained on at least one classification criterion selected from the group consisting of a composition of the powder, a reuse history of a portion of the powder, particle size characteristics of the powder, an aging of the powder, an oxidation of the powder, and an adulteration of the powder.

It is another object to provide a method of analyzing a powder, comprising: providing a layer of the powder; inducing a thermal transient in a region of the powder that propagates into surrounding regions of the powder; measuring an amplitude and phase delay of the thermal transient in the surrounding regions; and employing machine learning trained on powder characteristics selected from the group consisting of a composition of the powder, a reuse history of a portion of the additive manufacturing powder, particle size characteristics of the additive manufacturing powder, an aging of the additive manufacturing powder, an oxidation of the additive manufacturing powder, and an adulteration of the additive manufacturing powder.

It is a still further object to provide a method of analyzing a powder, comprising: providing a layer of the powder on a substrate; heating a spot of the powder with a time varying energy irradiation; measuring a spread of heat through the layer of powder over time; and employing a neural network to predict at least one of a thickness of the layer of the powder, a composition of the powder, a mixture ratio of the powder, a reuse history of the powder, particle size characteristics of the powder, an aging of the powder, an oxidation of the powder, and an adulteration of the powder.

A further object provides a method of analyzing an additive manufacturing metal powder, comprising: providing a layer of the additive manufacturing metal powder on a substrate; heating a spot of the additive manufacturing metal powder with a time varying energy irradiation, to induce a series of thermal waves emanating from the spot; measuring amplitudes and phases of the propagating thermal waves through the layer of powder from the spot over time; and employing a machine learning processor to predict at least one of a composition of the powder, a mixture ratio of the powder, a reuse history of the powder, particle size characteristics of the powder, an aging of the powder, an oxidation of the powder, and an adulteration of the powder.

The powder may be an additive manufacturing powder. The thermal transient may be induced by a targeted energy beam of an additive manufacturing machine. A focus and/or energy level of the localized energy beam may be adjusted in dependence on the measured thermal response. A phase transition of the powder (such as due to the targeted energy beam) may be detected in dependence on the measured thermal response.

The machine learning may be performed by at least one of a neural network, linear discriminant analysis, naïve Bayesian classification, a K-nearest neighbors analysis, a support vector machine, independent component analysis, principal component analysis, uniform manifold approximation and projection (UMAP), kernel principal component analysis, blind source separation, factor analysis, non-negative matrix factorization, multidimensional scaling, singular value decomposition, local linear embedding, Laplacian Eigenmapping, and t-Distributed Stochastic Neighbor Embedding. Fundamental algorithms such as linear regression, logistic regression, decision tree learning, error distance to known good and bad sample, may also be employed.

It is also an object to provide a system for analyzing an additive manufacturing metal powder, comprising: an energy source configured to heat a spot of the additive manufacturing metal powder with a time varying energy irradiation, to induce a series of thermal waves emanating from the spot; a pyrometer or thermometer configured to measure amplitudes and phases of the propagating thermal waves through the layer of powder from the spot over time; and a machine learning processor configured to predict at least one of a composition of the additive manufacturing powder, a mixture ratio of the additive manufacturing powder, a reuse of the additive manufacturing powder, particle size characteristics of the additive manufacturing powder, an aging of the additive manufacturing powder, an oxidation of the additive manufacturing powder, and an adulteration of the additive manufacturing powder.

The machine learning processor may implement at least one of a neural network, linear discriminant analysis, naïve Bayesian classification, a K-nearest neighbors analysis, a support vector machine, independent component analysis, principal component analysis, kernel principal component analysis, uniform manifold approximation and projection, blind source separation, factor analysis, non-negative matrix factorization, multidimensional scaling, singular value decomposition, local linear embedding, Laplacian Eigenmapping, and t-Distributed Stochastic Neighbor Embedding. Fundamental algorithms such as linear regression, logistic regression, Decision tree learning may also be employed for simplicity.

Another object provides a non-transitory computer readable medium, storing therein instructions for controlling at least one programmable processor, comprising: instructions for controlling an energy source to heat a spot of the additive manufacturing metal powder with a time varying energy irradiation, to induce a series of thermal waves emanating from the spot; instructions for receiving a pyrometer or thermometer sensor input for measuring an amplitude and a phase of the propagating thermal waves through the layer of powder from the spot over time; and instructions for implementing a machine learning algorithm to estimate at least one of a composition of the additive manufacturing powder, a mixture ratio of the additive manufacturing powder, a reuse history of the additive manufacturing powder, particle size characteristics of the additive manufacturing powder, an aging of the additive manufacturing powder, an oxidation of the additive manufacturing powder, and an adulteration of the additive manufacturing powder.

A further object provides a non-transitory computer readable medium, storing therein instructions for controlling at least one programmable processor, comprising: instructions for receiving a thermal sensor input for measuring an amplitude and a phase of the propagating thermal waves from a spot heating of a powder; and instructions for implementing a machine learning algorithm trained to estimate at least one of a composition of the powder, a mixture ratio of the powder, a reuse of the powder, particle size characteristics of the powder, an aging of the powder, an oxidation of the powder, and an adulteration of the powder.

Another embodiment provides a method of aligning additive manufacturing energy sources, comprising: emitting energy from a first energy source on a surface along a first axis; emitting energy from a second energy source on the surface along a second axis, the first axis being different from the second axis; at least one of the first and second energy sources being modulated over time; measuring a radiated thermal signal from the surface; and spatially relocating at least one of the first and energy sources to a location where the measured radiated thermal signal from the surface until a maximum is achieved.

The measuring may comprise using a lock-in amplifier to selectively detect the modulated at least one of the first and second energy sources. The measuring may also comprise performing a Fourier transform on the measured radiated thermal signal from the surface. The Fourier transform can isolate the separately modulated signals of the energy sources, and determine a phase delay.

The spatially relocating may comprise searching a range of regions for the location where the measured radiated thermal signal from the surface until a maximum is achieved.

Both the first and second energy sources may be modulated over time, wherein the first energy source is modulated differently, e.g., having a different frequency, from the second energy source.

### BRIEF DESCRIPTION OF THE DRAWINGS

FIG. 1 shows a modulated Laser Thermal Interrogation (MLTI) schematic.

FIG. 2 shows an experimental Setup for MLTI method.

FIGS. 3A and 3B show the distinguished responses of the Cu, AlSi10Mg, IN718, SS316L, and Ti64 G23 by using MLTI technique at the frequency of 100 Hz. The tests were conducted with periodic heating of 5.5 W peak-to-peak and a powder deposition of 240 μm onto a stainless steel substrate. FIG. 3A shows the amplitude of the demodulated thermal response versus laser modulation frequency; and FIG. 3B shows a phase lag between thermal response and laser heating. The radiative current is the periodic component of the photodetector current. Shaded lines indicate the standard deviation between 8 repeat experiments at different locations.

FIGS. 4A and 4B show the capability of the MLTI technique to distinguish Cu, AlSi10Mg, IN718, SS316L, and Ti64 G23 from each other. The tests were conducted with periodic heating of 5.5 W peak-to-peak and a powder deposition of 240 μm onto a stainless steel substrate.

FIGS. 5A-5J show plots of periodic (5A, 5C, 5E, 5G, 5I) radiated current and (5B, 5D, 5F, 5H, 5J) of the fresh vs reused Cu vs time when heated with periodic heating of 5.5 W peak-to-peak at (5A, 5B) 100, (5C,5D) 200, (5E, 5F) 500, (5G, 5H) 1,000, (5I, 5J) 2,000 Hz. Shaded lines indicate the standard deviation between repeated experiments.

FIG. 6 shows absorptivity of two copper powder samples (fresh/reused) in the UV-visible spectra.

FIGS. 7A, 7B. 7C, and 7D show the radiated thermal response of the fresh vs reused (7A, 7B) Cu and (7C, 7D) Ti64 G23 vs frequency when heated with periodic heating of 5.5 W peak-to-peak. Plots (7A, 7C) show the periodic amplitude of thermal emission detected by the photodetector, and (7B, 7D) show the phase lag between laser heating and thermal emission after 1 second of laser exposure. Shaded lines indicate the standard deviation between repeat 8 experiments.

FIGS. 8A and 8B show evaluation of the technique to distinguish between two different Ti64 powder grades (5 and 23). The LECO oxygen weight percent for the Grade 5 was 0.182±0.002 and the Grade 23 was 0.094±0.002. Powder size distribution for the tested G23 and G5 were D90s of 104 and 105 μm, and median of 68 and 76 μm. The periodic heating was at X W peak-to-peak with powder thickness of 240 μm.

FIGS. 9A, 9B, 9C, and 9D show an evaluation of the technique to distinguish powder thickness. Plots of (9A, 9C) periodic radiated current and (9B, 9D) thermal phase lag of fresh (9A, 9B) Cu and (9C, 9D) Ti64 G23 powders of different powder deposition thicknesses versus frequency. The amplitude and phase were acquired after 1 second of 5.5 W peak-to-peak. Shaded lines indicate the standard deviation between 8 repeat experiments.

FIGS. 10A, 10B, and 10C show an evaluation of the technique to distinguish between three different particle size distributions with Ti64 G23 powders. Plots of (10A) periodic radiated current and (10B) thermal phase lag of used Ti64 G23 powders with powder deposition thickness of 240 μm. The amplitude and phase were acquired after 1 second of laser exposure with the power of 5.5 W peak-to-peak. Shaded lines indicate the standard deviation between 8 repeat experiments. Plot (10C) shows the particle size distribution of each sample.

FIGS. 11A, 11B, and 11C show an evaluation of the technique to distinguish between three different particle size distributions with Ti64 G5 powders. Plots of (11A) periodic radiated current and (11B) thermal phase lag of fresh Ti64 G5 powders with powder deposition thickness of 240 μm. The amplitude and phase were acquired after 1 second of laser exposure with the power of 5.5 W peak-to-peak. Shaded lines indicate the standard deviation between 8 repeat experiments. Plot (11C) shows the particle size distribution of each sample.

FIGS. 12A, 12B, and 12C show representative amplitude and phase responses for fresh copper powder with powder thickness deposition of 240 μm with periodic heating of 5.5 W peak-to-peak. The circled points are the ones that are fed into the machine learning model for training and detection. The shaded area indicates the standard deviation between repeated experiments.

FIG. 13 show plots the contribution of each feature to the principal components, providing insights into the importance of individual features in capturing variance within the dataset.

FIG. 14 shows a schematic representation of the cascaded sequential ML algorithm.

FIG. 15 shows a learning curve illustrating the detection of powder core material across 5 different metal powders.

FIG. 16 shows a visualization of Principal Component Analysis (PCA) Results: Reduced feature space representation of multidimensional data using PCA, highlighting distinct clusters and patterns.

FIG. 17 shows a learning curve illustrating the detection of metal powder type (Fresh/Reused) across samples with copper powder.

FIG. 18 shows a visualization of Principal Component Analysis (PCA) Results for detecting powder type (fresh/reused).

FIG. 19 shows a confusion matrix showing accurate determination of powder core material. Data set included powders of multiple thickness, ages, powder size distributions.

FIG. 20 shows a confusion matrix showing accurate determination of powder type (Fresh/Reused). Data set included powders of multiple thickness, ages, powder size distributions.

FIG. 21 shows a confusion matrix for determining thickness of copper powder deposition. Tested for thicknesses of 60, 120, 180, and 240 μm depositions (labeled as states 0,1,2,3 in figure).

FIG. 22 shows a PCA analysis showing clustering for different thicknesses of Cu deposition.

FIG. 23 shows a prior art computer hardware configuration.

### DETAILED DESCRIPTION OF THE PREFERRED EMBODIMENTS

### Modulated Laser Thermal Interrogation of Powders (MLTI)

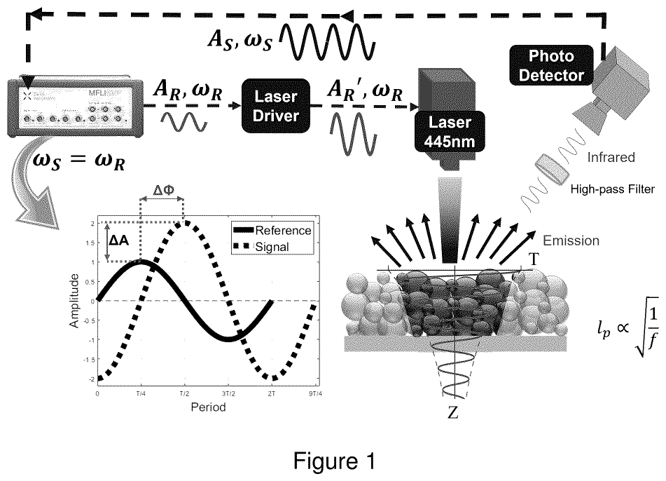

This embodiment provides a periodic modulation to the laser responsible for melting metal powder, and captures the resulting periodic temperature oscillations using an infrared-sensitive photodetector. By varying a modulation frequency, this technique enables spatially resolved thermal property sensing. The modulation frequency determines the thermal penetration depth (Carslaw and Jaeger, 1990). The schematic of how this method works is depicted in FIG. 1. Thermal waves from a periodic heat source penetrate a depth, Lp, proportional to the square root of thermal diffusivity, a, and inversely proportional to the square root of frequency, f.

$${l}_{p} = \sqrt{\frac{α}{π f}} \qquad ( 1 )$$

As the powder is heated by the laser, IR emission of the top layer is captured by a photodetector. By sending these captured signals to the lock-in amplifier, demodulated amplitude and phase can be extracted (R, θ). Since the powder is activated by a modulating source, both the amplitude of radiation and the signal phase lag between the heating waveform and the surface temperature response correspond to the distinct geometry and materials of the system.

The laser, serving as the primary heat source, is modulated by the wave generator. Additionally, a laser driver amplifies the waves in the process. Like Frequency Domain Thermoreflectance (“FDTR”) (Cahill, 2004) embodiments of this invention operate in the frequency domain, but unlike this invention, FDTR uses the thermal radiative emission. Moreover, analysis of FDTR described in the literature analyzes planar homogeneous film layers, and does not capture the unique and important properties of heterogeneous powders. This method obtains additional thermal property information beyond what is seen in conventional thermography, such that it is sensitive to subtle variations in the powder. MLTI response yields depth-dependent thermal information by varying the thermal penetration depth by modulation. Fundamentally, the MLTI response will vary with the thermal properties (thermal conductivity and volumetric specific heat) of the powder core, the contact resistance between powders and the geometry of the powders with each other and any underlying substrate. The MLTI response responds to changes in the core powder metal, age, reuse cycles, powder deposition thickness and substrate, oxygen content, powder size distribution, the geometry of the powder, the contact between powder (roughness, oxides), laser absorbance, spectral emissivity, evolution of powder under heating (as interrogation power and duration increase, powder defects (hollow, satellite agglomeration), packing density. For instance, a powder with smaller powder diameter will have a higher density of powder-powder thermal interfaces, reducing the thermal transport, especially at frequencies deep enough to “sense” these interfaces. Moreover, the frequency at which these interfaces are sensed will depend on the powder size distribution and the metal core properties. The amplitude of the response will vary with the laser absorbance, which varies with oxide film, and the emissivity versus time (also a function of oxide). Contrastingly, the phase response is first-order independent of laser absorbance and blackbody emissivity. The temporal signal changes due to the transient periodic response even if no phase change or oxide evolution; the temporal response at higher powers can also be affected by evolution of oxide, sintering; and/or melting.

A variety of powder samples were tested. A singular stainless steel 316L plate was used as a substrate with different layers of polyimide tape serving as rails to control powder deposition thickness. Experiments were performed across four distinct thicknesses: 60 μm, 120 μm, 180 μm, and 240 μm. A razor blade was used as a recoater. In order to minimize water absorption and oxidation, all samples were stored in a vacuum environment. The test chamber was purged with argon gas prior to each experiment. The comprehensive list of all samples is presented in Table 1. The particle size distribution (“PSD”) of all samples have been measured by using the laser diffraction particle size analyzer (Beckman Coulter LS-13-320).

TABLE 1
Summary of metal powders tested.
(Samples with an asterisk (*) were made and used once with electron
beam powder bed fusion.)

| | | Mean | | | Supplier |
|---|---|---|---|---|---|
| Material | Fresh/Reused | (μm) | Median (μm) | D90 (μm) | (Company) |
| Copper (Cu) | Fresh | 30.2 | 31.1 | 46.1 | EOS |
| Copper (Cu) | Reused | 29.3 | 28.7 | 49.1 | EOS |
| Aluminum Alloy | Reused | 49.3 | 49.2 | 72.3 | EOS |
| (AlSi10Mg) | | | | | |
| Titanium Alloy | Fresh | 73.2 | 67.7 | 103.5 | AP&C |
| (Ti64-G23) | | | | | |
| Titanium Alloy | Reused | 67.7 | 65.9 | 87.2 | AP&C |
| (Ti64-G23)* | | | | | |
| Titanium Alloy | Fresh | 78.3 | 75.7 | 104.5 | AP&C |
| (Ti64-G5)* | | | | | |
| Steel (SS316L) | Fresh | 38.1 | 36.9 | 57.0 | EOS |
| Nickel-Chromium | Reused | 40.0 | 34.4 | 68.2 | SLM |
| Alloy (IN718) | | | | | Solutions |

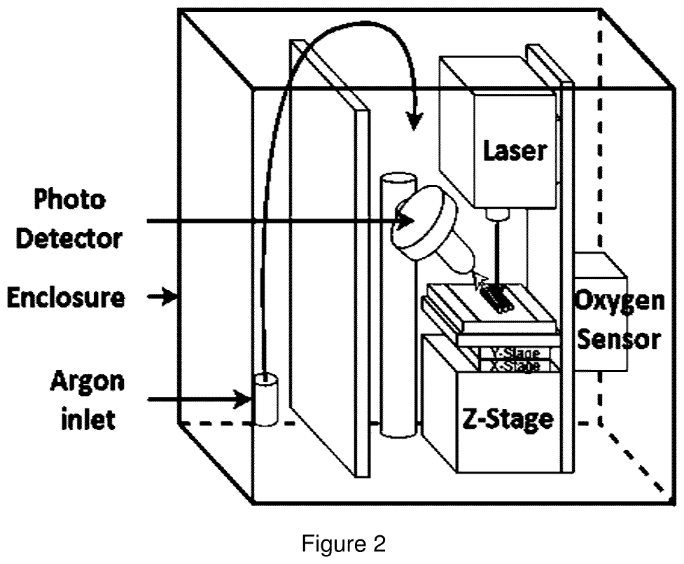

An experimental setup was made for this technique. The schematic of the test chamber is shown in FIG. 2. For the testbed, an enclosure was incorporated to block high power blue laser light (Wavelength=445 nm) using laser safety acrylic (wavelength range=250-520 nm, OD=3+, Visible light transmittance >55%). This also serves as an inert chamber when purged with argon. An oxygen sensor was placed inside of the chamber to read the oxygen levels throughout the process (DDScientific, S+40X, UK).

Two piezo motor stages (NewScale Technologies M3-LS-3.4-15) were used in combination with linear translation stages. The translation stages allowed coarse adjustment for aligning the test artifact and keeping the build plate at the focal length of the laser. A reversed bias photodetector with InGaAs detector (Thorlabs DET08C) with bandwidth of 5 GHz was used to measure the radiative response of the metal powder. A long-pass filter (Thorlabs FEL550) selectively rejects the laser wavelength, only admitting radiative emissions into the photodetector. Lastly, a 445 nm 7 W blue laser diode (Nichia Corp.) was assembled with a prism pair and focusing optical network to provide an elliptical spot size. The laser spot size at the focal distance was measured with PC-Beamage™, revealing an elliptical shape with length of major and minor axis of 253 μm and 93 μm. A thermal electric cooler (TEC) maintained the temperature. The lock-in amplifier (Zurich Instrument MFLI2) generated a reference wave that modulates the laser by way of a custom amplifier, and also performed real-time Fourier transform of the photodiode signal generator. The data acquisition and analysis were performed by MATLAB.

Implementation of this frequency domain method presented new challenges due to the need to modulate the laser at a range of frequencies. For this study, an electronic driver that can apply megahertz level bandwidths and watt level powers could not be sourced without a Pockels cell or ElectroOptic Modulation (“EOM”) technologies (Fu et al. 2013). Thus, a new analog modulation driving technique was implemented to be able to handle these levels of power and speed. APS lasers designed a custom board (APS Lasers, Model ION-10A) to meet these needs. This custom electrical driver allowed modulation at powers of 0-10 W and frequencies up to 10 MHz. The power to the amplifier was provided by a BK Precision 9206.

A series of experiments were performed to evaluate the MLTI method for detection of powder core type (Cu, AlSi10Mg, Ti64, SS316L, IN718), powder age (fresh vs. reused Cu and Ti64 G23), oxide content (Ti64 G5 vs G23), powder layer thickness (0-240 μm), and particle size distribution. Material characterizations of the powders by X-ray diffraction (XRD), X-ray photoelectron spectroscopy (XPS), scanning electron microscopy (SEM) and transmission electron microscopy (TEM) of the MLTI tested powders are also discussed.

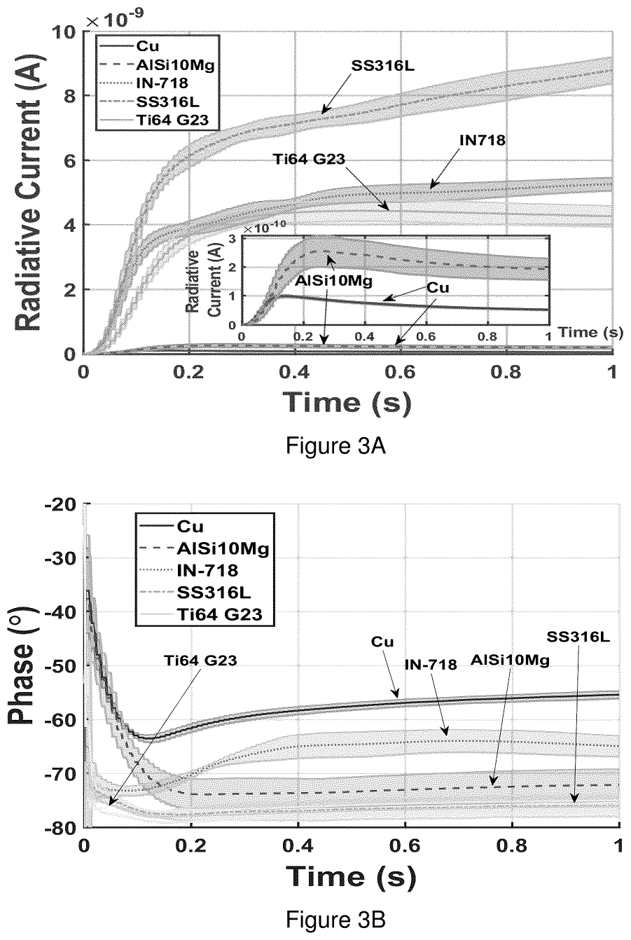

The magnitude of the demodulated amplitude and phase for different powder core types in FIGS. 3A and 3B shows the differentiation capability of this technique with Cu, AlSi10Mg, IN718, SS316L, and Ti64 G23. The shaded areas represent the standard deviation between repeat experiments (at least 8 tests at different locations). The amplitude and phase versus time at various modulation frequencies exhibit distinct responses for the different materials. Consequently, this technique enables the differentiation of materials by machine learning, which is detailed in the following sections. Furthermore, the phase lag responses provide more consistent information about the core material, as the phase lag is inherently dependent on the thermal diffusivity of the material. The demodulated amplitude and phase at the frequency of 100 Hz are illustrated in FIGS. 3A and 3B.

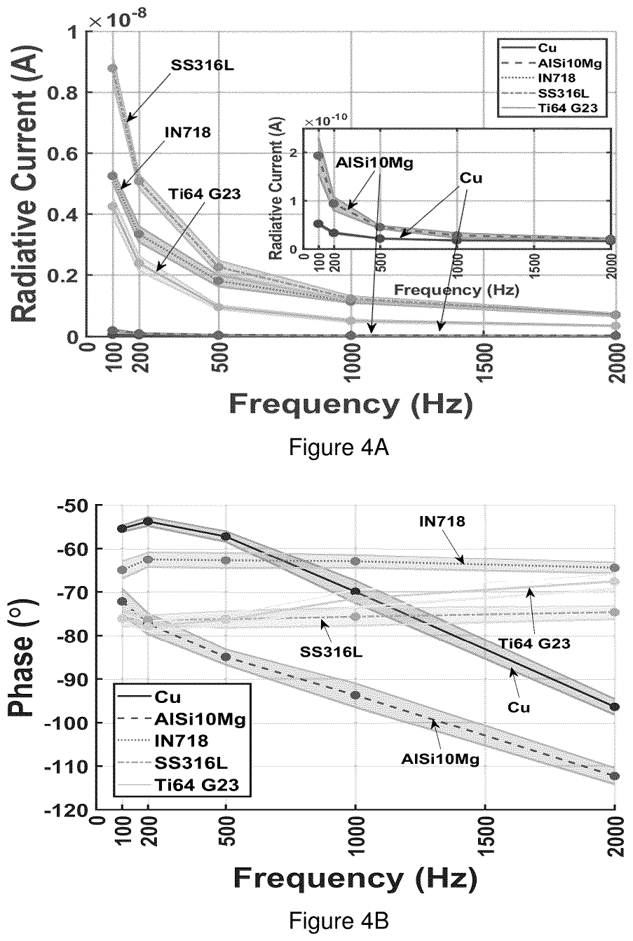

In FIGS. 4A and 4B, the radiative current and phase responses of Cu, AlSi10Mg, In718, SS316L, and Ti64 G23 at one second of laser exposure are shown for the tested frequencies (100 Hz, 200 Hz, 500 Hz, 1 kHz, and 2 kHz). Solid spots represent the average values obtained from conducting the same test at least eight times, while the shaded areas illustrate the standard deviation observed across repeated tests. The distinct responses of these materials were influenced by their unique thermal properties and geometry of powder as deposited.

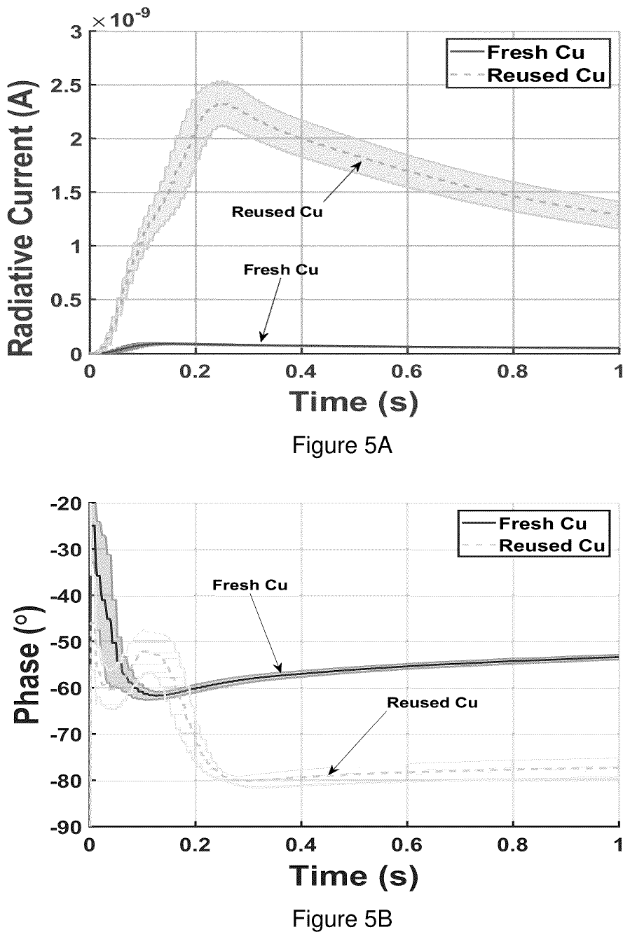

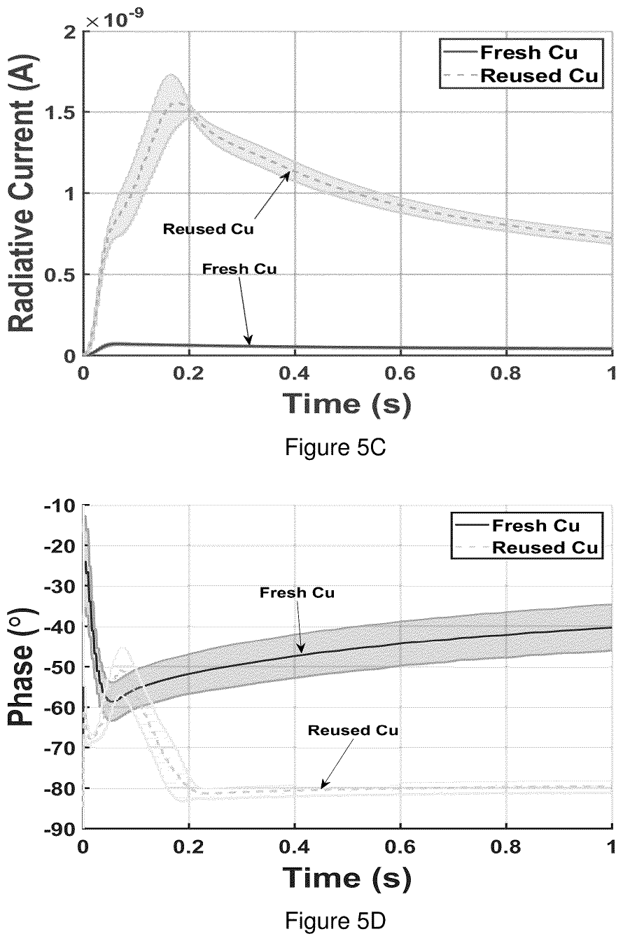

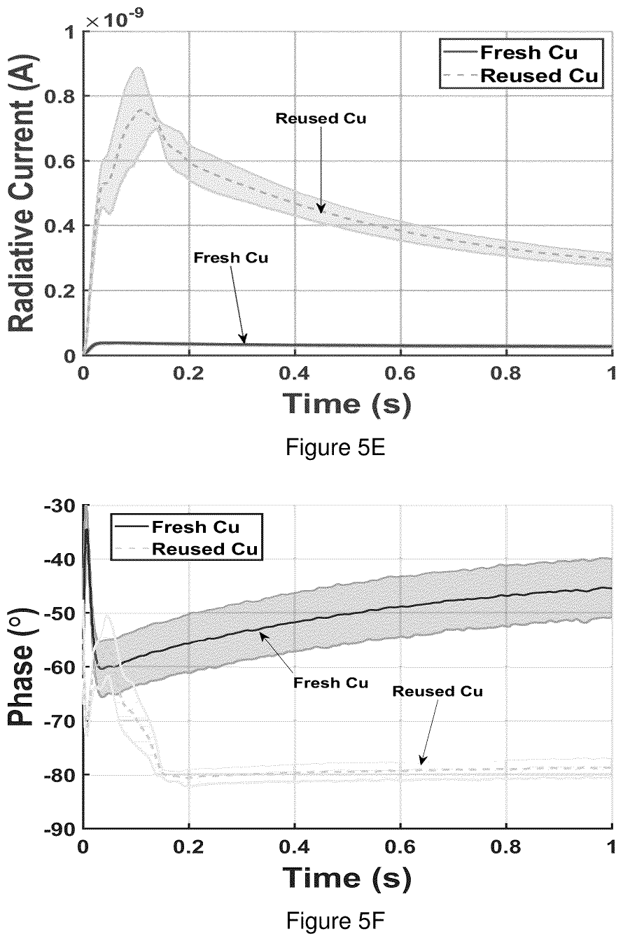

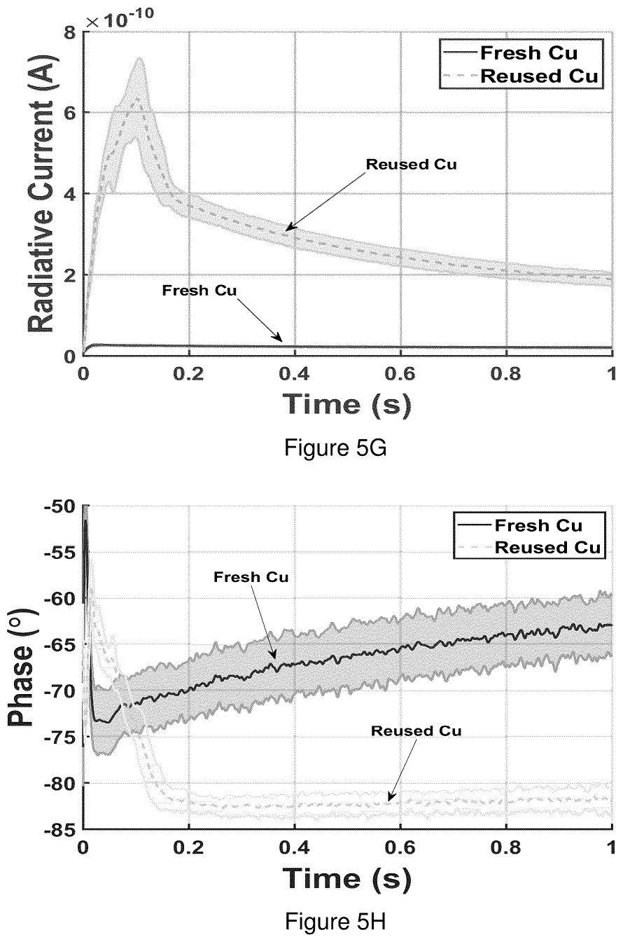

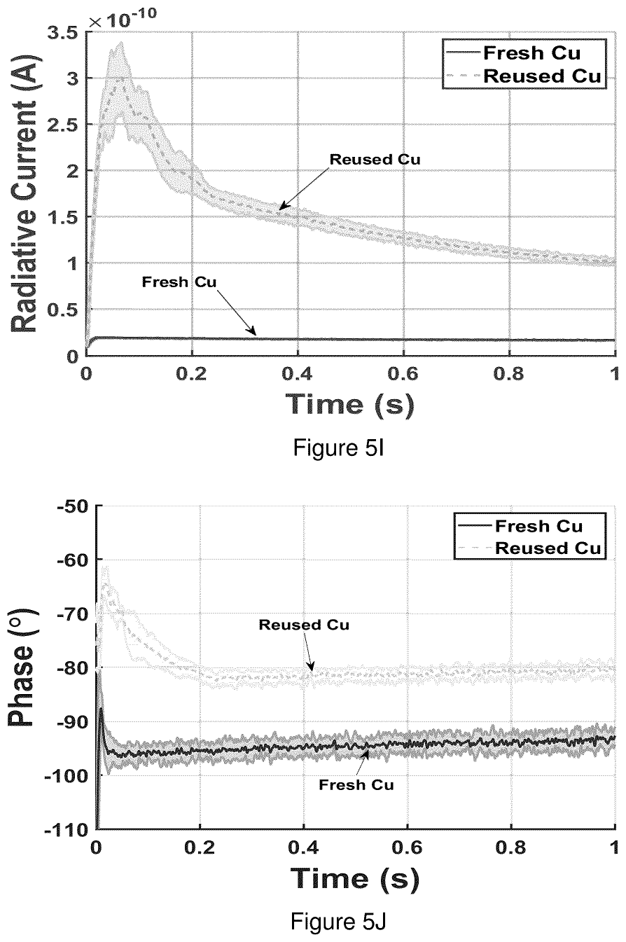

To assess the sensitivity of this method to variations in metal powder composition during printing, experiments were conducted using fresh and reused samples of copper powders. In order to investigate the changes in the powder after several uses, the fresh copper powder underwent multiple printing cycles and sieving processes within the EOS M290 printer. While the exact number of times that the powder was used is unknown, fresh powder was added to the powder reservoir after every several prints. The whole batch was used approximately 6 times and kept in the printer exposed to ambient conditions. During the handling process for sieving or collecting from the printer, copper powder invariably underwent oxidation, visible from color change of powder, optical absorptivity spectra and electron microscopy. Additionally, low quantities of oxygen present in the build chamber from unpurged oxygen and oxygen in the argon cylinders lead to oxidation during the printing process. (Derimow and Hrabe, 2011). The copper surface is prone to oxidation, leading to the formation of an oxide film upon exposure to air. This formation alters the emissivity of the copper surface (Yu et al., 2019). Studies have also indicated that the augmentation of surface roughness exerts a greater influence on emissivity at longer wavelengths compared to shorter wavelengths (Jo et al., 2017; Kong et al., 2017; Yu et al., 2019). To evaluate the absorptivity of the copper samples its absorptivity versus wavelength spectrum was measured by Jasco v-730 with an integrating sphere attachment (FIG. 5).

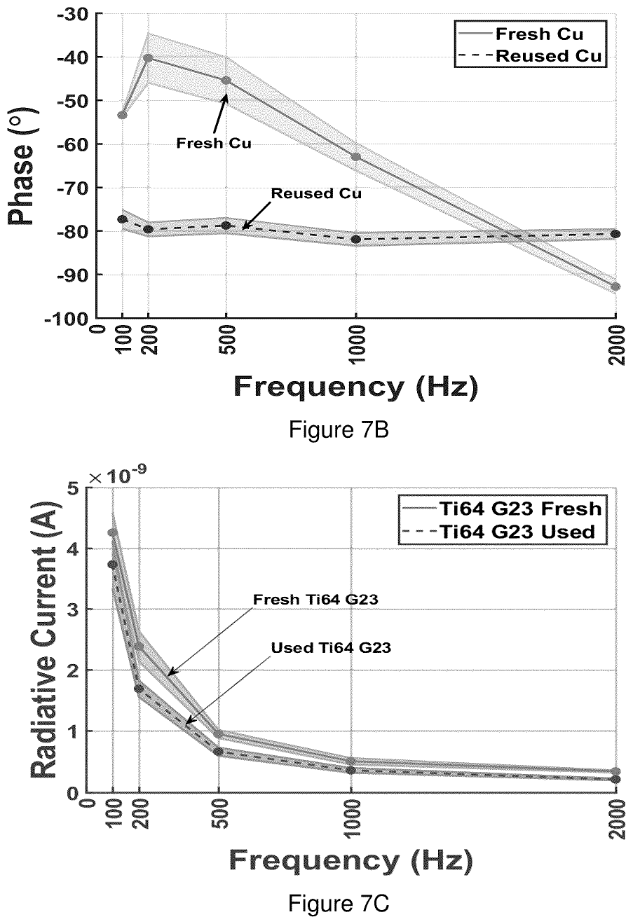

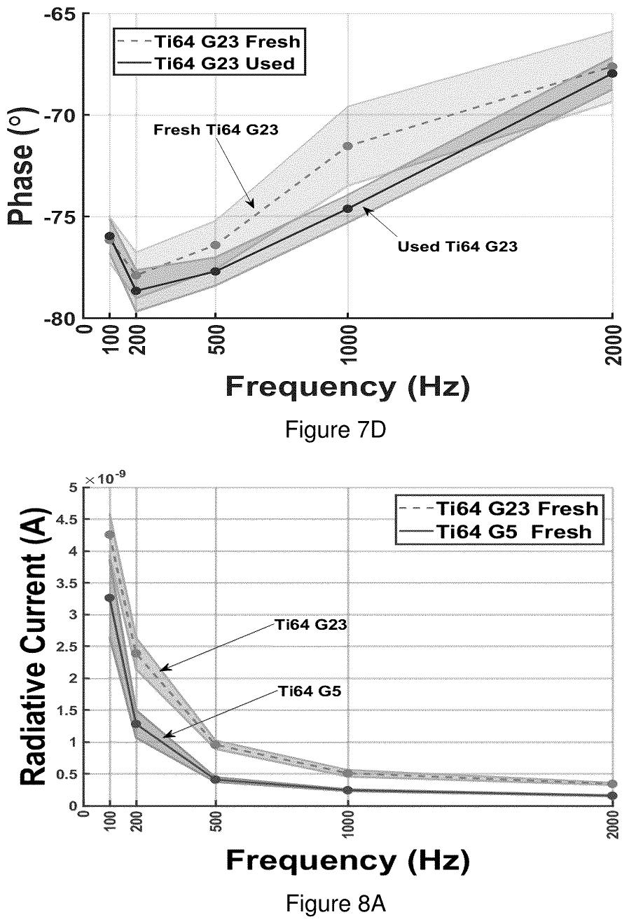

The results from the MLTI technique with fresh and reused Cu powder are shown in FIG. 7 for 100 Hz. The demodulated amplitude and phase of the reused copper powders markedly deviates from that of the fresh. The radiative current of fresh copper is significantly lower than the reused, owing to its lower emissivity, while the phase is also different owing to its different thermal properties.

Scanning electron microscopy (SEM) images vividly exhibit the fresh Cu powders, characterized by their commendable sphericity and smooth surface, showcasing a delicate “net-like” pattern, a consequence of the rapid solidification inherent in the sample synthesis process. Cu powders post-reuse, sourced from the fusion bed after undergoing multiple cycling processes. This cyclic utilization instigates sintering phenomena and consequential deformation within the Cu powders. Notably, a surface morphology shift is discernible, marked by the emergence of a distinctive “tree-like” dendritic structure attributed to the thermal annealing treatment induced by laser printing.

To investigate deeper into the ramifications of cycling usage, cross-section transmission electron microscopy (TEM) characterizations were undertaken for both fresh and reused Cu powders. High-angle annular dark field scanning transmission electron microscopy (HAADF-STEM) reveals the formation of oxide segments on the surface, attributable to exposure to the ambient environment. In contrast, the oxide layer observed on reused Cu powders presents porous characteristics with greater thickness due to the Kirkendall effect (Cao et al., 2023), a consequence of thermal history from L-PBF and storage. This enhanced structural understanding underscores the intricate interplay of L-PBF reuse cycles and storage on the oxide formation dynamics within the Cu powder matrix.

Unlike Cu, Ti-6Al-4V samples have a less noticeable change in optical properties and outer morphology from visual inspection, optical and scanning electron microscopy. Yet the Ti64 the material is known to evolve, especially when used in electron beam laser powder bed fusion (EB-PBF), which imparts a high temperature under vacuum that tends to fade more volatile Al, and form oxides preferentially with Al (Barclay, 2013; Derimow et al., 2022).

FIGS. 7C and 7D show the response of EB-PBF in the fresh vs reused state for the full powder size distribution. It should be noted the reused powder was only used one time, so our sensitivity can distinguish a single EB-PBF use. The effect of the particle size distributions is examined and the result is reported in the following sections.

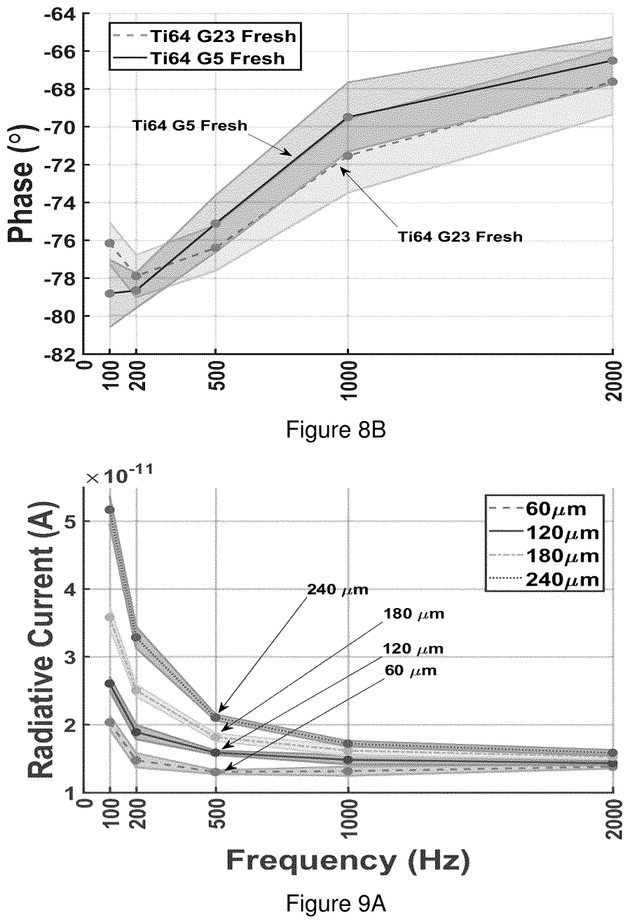

The impact of oxygen content was assessed by comparing fresh Ti64 of grade 5 and grade 23 (G5 and G23). These powders had their oxygen content tested by LECO testing. The oxygen content of the fresh G5 was 0.182±0.002 wt. %, and the fresh G23 was 0.094±0.002 wt. %. The MLTI response, shown in FIGS. 8A and 8B shows a noticeable change in amplitude that is much greater than one standard deviation, while the phase shift is on the order of about one standard deviation separation at 1 second.

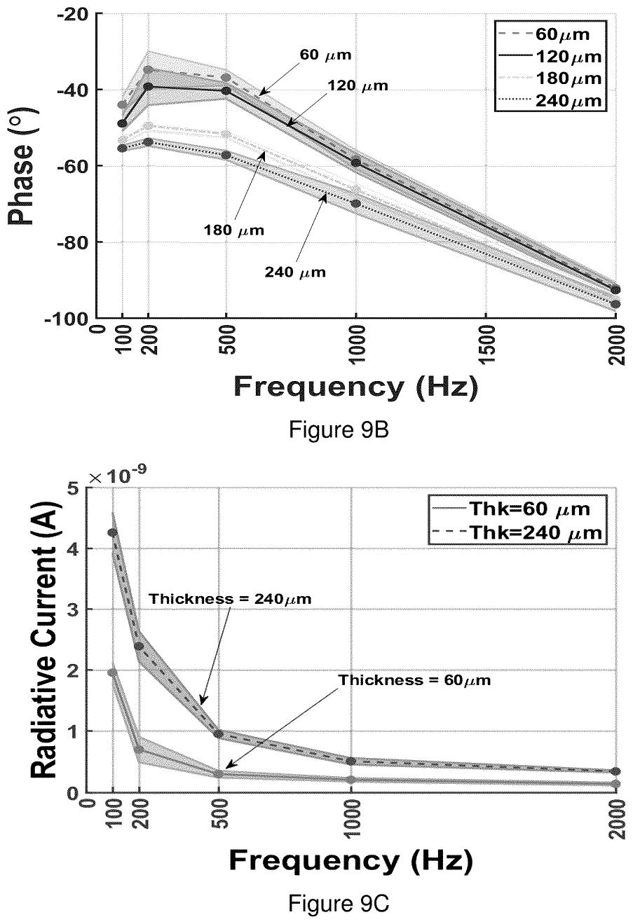

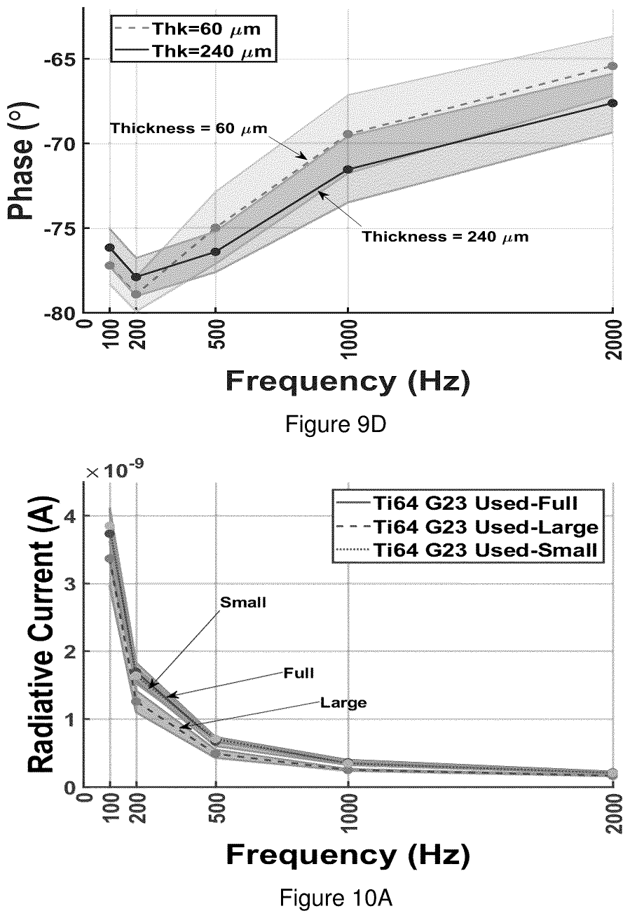

The MLTI method was tested with varying powder deposition thicknesses from 0 to 240 μm in steps of 60 μm. Changing thickness by 60 μm leads to a discernible change in amplitude that is greater than several standard deviations at frequencies of 500 Hz and below (FIG. 9). The phase has differentiation capabilities at lower frequencies but becomes worse as frequency increases. Lower frequencies have longer thermal penetration depths, hence able to better distinguish powder thickness. The amplitude response is also influenced by the absolute temperature under the laser to the fourth power, which will be higher for thicker powder depositions. At higher frequencies the response in phase tends to converge, as it is more sensitive to the surface and less sensitive to the powder deposition depth. Elevated levels of powder deposition thickness result in a larger powder volume subject to temperature oscillations, consequently inducing a greater phase lag in the system's response. It should be noted that even though the periodic thermal penetration depth is less than the deposition layer thickness at higher frequencies, the DC component of the temperature is greater for thicker powder layers, thus making the periodic response intensity larger, as that is proportional to absolute temperature to the fourth power. The apparent density of 5.26 g/cm³, measured in accordance with ASTM B212 (B09 Committee) by using the Hall funnel setup along with the heat capacity of 393 J/kg·K for copper (White and Collocott, 1984) is utilized to estimate the penetration depth of applied heat. The calculated penetration depth is approximately 18 μm at 100 Hz and 4 μm at 2 KHz. However, the real situation is different as changes in the emissivity and reflections between the particles can influence the thermal penetration depth and responses accordingly.

In order to verify and confirm the capability of this technique in showing the sensitivity to the thickness of the powder deposition thickness, Ti-6Al-4V G23 alloy was also tested and the results are shown in FIGS. 9C and 9D.

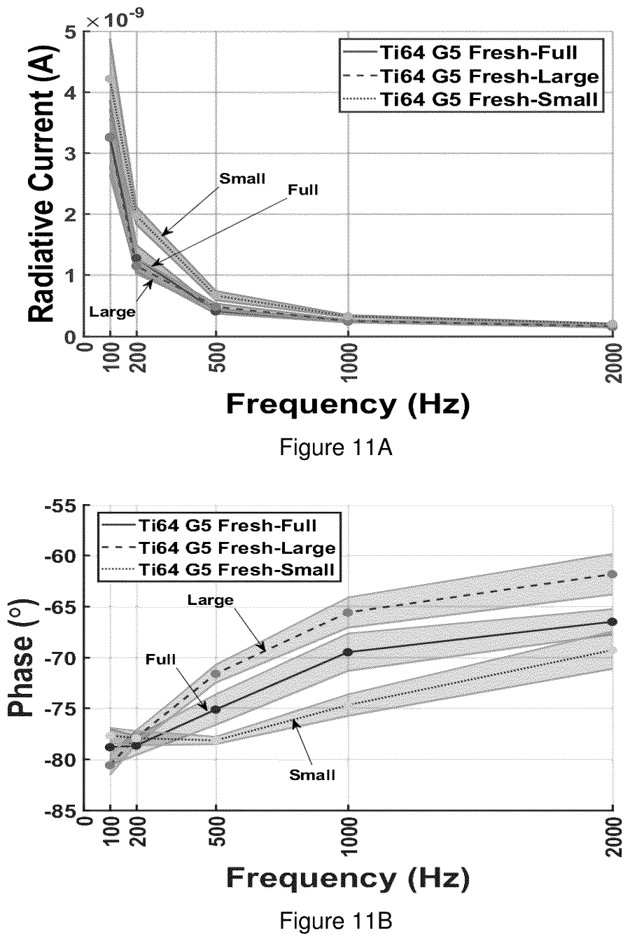

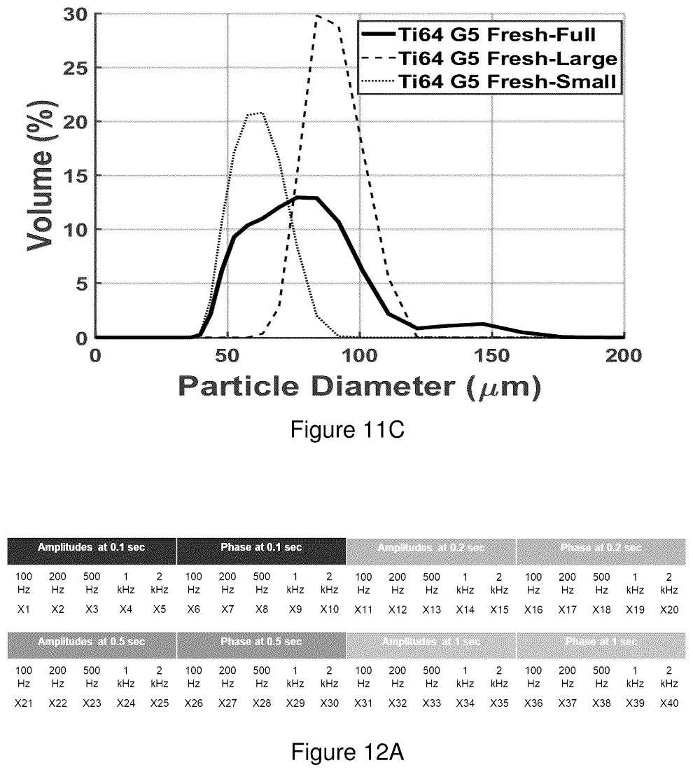

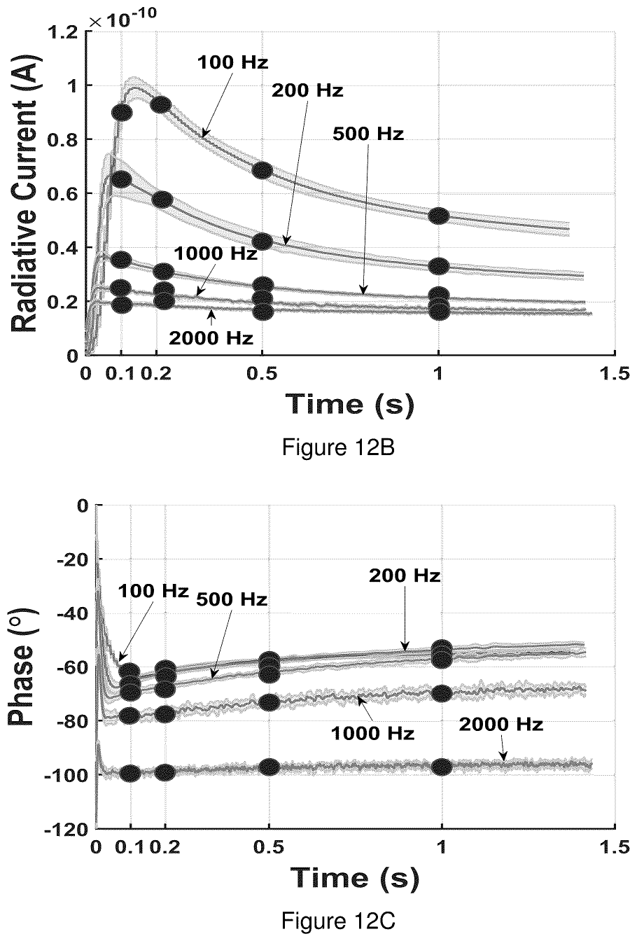

The influence of particle size distribution was examined by sieving powder into sub-ranges of powders termed “small,” and “large.” Each of these sub-distributions was characterized in terms of PSD (FIG. 11 for Ti64 G23 used and FIG. 12 for Ti64 G5 fresh powder). The MLTI responses for sieved fresh Ti64 G5 powder are shown in FIGS. 11A and 11B. These sample of powders were made for EB-PBF with a range of 40-111 μm and D90 of 87 μm for the used Ti64 G23 and range of 36-160 μm and D90 of 105 μm for the fresh Ti64 G5. All the information about the particle size ranges are mentioned in Table 2.

TABLE 2
Summary of Ti64 metal powders tested for evaluating
the sensitivity to the particle size distribution.

| | Sample | | Range | Mean | Median | D90 |
|---|---|---|---|---|---|---|
| Material | ID | Fresh/Reused | (μm) | (μm) | (μm) | (μm) |
| Ti64 G5 | Full | Fresh | 36-160 | 78 | 75.7 | 104.5 |
| Ti64 G5 | Large | Fresh | 64-111 | 93.4 | 92.7 | 108.5 |
| Ti64 G5 | Small | Fresh | 36-92 | 63.4 | 62.8 | 77 |
| Ti64 G23 | Full | Used | 40-111 | 67.7 | 66 | 87.2 |
| Ti64 G23 | Large | Used | 69-101 | 88.2 | 87.7 | 100.2 |
| Ti64 G23 | Small | Used | 36-77 | 58.41 | 59.36 | 69.2 |

In general, smaller powder size distributions have greater number of powder-powder interfaces, leading to larger periodic and DC thermal responses. The phase shows a significant change (greater than standard deviation at certain frequencies) due to its varying number of interfaces and thermal mass of powder. In particular, there are “orphaned powder” that impact the MLTI response. “Orphaned powder” typically includes smaller powder particles that are mixed with large powder particles that do not contribute to thermal conductivity, as they are only contacting one powder, but present a thermal mass. This “orphaned powder” impacts the MLTI powder response.

By training the machine learning models with diverse datasets encompassing various powder compositions and characteristics, robust systems can be developed capable of accurately distinguishing between different powder types, forecasting their behavior during L-PBF, and empowering manufacturers to optimize printing parameters (e.g., energy densities), minimize defects, and enhance overall quality. All the datasets (see Table 1 and 2) were used for machine learning. A cascaded layered machine learning method was employed to first identify the powder type and then based on that material identification, use material-specific models to identify powder age, oxygen content, powder deposition thickness, and powder size distribution. The MLTI data can be used by machine learning to predict key powder characteristics to characterize the powder.

The MLTI experiments contain temporal amplitude and phase data at several modulation frequencies. To streamline the data analysis process, a strategic approach was adopted to utilize output signals at specific time intervals as input into the learning machine. The aim was twofold: to optimize processing time while preserving accuracy. The demodulated amplitude and phase was used at 0.1, 0.2, 0.5, and 1 second, across five frequencies-100 Hz, 200 Hz, 500 Hz, 1 kHz, and 2 kHz (Table 3). Consequently, each experiment contained a total of 40 features that were input into the machine learning model. Representative features used as input to the ML are shown in FIG. 12.

TABLE 3
Features and Their Descriptions - A comprehensive overview of the features along with their corresponding descriptions.

| Amplitudes at 0.1 sec | | | | | Phase at 0.1 sec | | | | | Amplitudes at 0.2 sec |
|---|---|---|---|---|---|---|---|---|---|---|
| 100 Hz | 200 Hz | 500 Hz | 1 kHz | 2 kHz | 100 kHz | 200 kHz | 500 kHz | 1 kHz | 2 kHz | 100 kHz |
| X1 | X2 | X3 | X4 | X5 | X6 | X7 | X8 | X9 | X10 | X11 |

| Amplitudes at 0.2 sec | | | | Phase at 0.2 sec | | | | |
|---|---|---|---|---|---|---|---|---|
| 200 kHz | 500 kHz | 1 kHz | 2 kHz | 100 kHz | 200 kHz | 500 kHz | 1 kHz | 2 kHz |
| X12 | X13 | X14 | X15 | X16 | X17 | X18 | X19 | X20 |

| Amplitudes at 0.5 sec | | | | | Phase at 0.5 sec | | | | | Amplitudes at 1 sec |
|---|---|---|---|---|---|---|---|---|---|---|
| 100 Hz | 200 Hz | 500 Hz | 1 kHz | 2 kHz | 100 kHz | 200 kHz | 500 kHz | 1 kHz | 2 kHz | 100 kHz |
| X21 | X22 | X23 | X24 | X25 | X26 | X27 | X28 | X29 | X30 | X31 |

| Amplitudes at 1 sec | | | | Phase at 1 sec | | | | |
|---|---|---|---|---|---|---|---|---|
| 200 kHz | 500 kHz | 1 kHz | 2 kHz | 100 kHz | 200 kHz | 500 kHz | 1 kHz | 2 kHz |
| X32 | X33 | X34 | X35 | X36 | X37 | X38 | X39 | X40 |

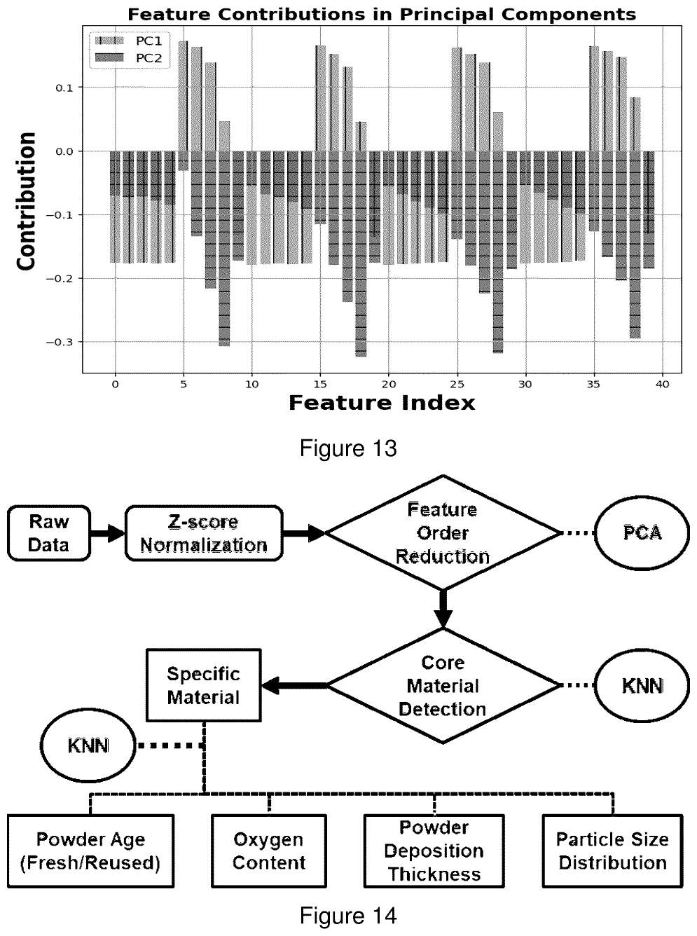

Incorporating PCA transforms data into a lower-dimensional space, preserving the most important information and facilitating visualization of high-dimensional data. These 40 features were first scaled by z-score normalization to bring all features to the same mean and standard deviation, which is important because amplitude and phase are very different magnitudes. These 40 scaled features were then reduced to just two orthogonal features by principal component analysis (PCA). The PCA feature weighting for powder core type identification is shown in FIG. 13B.

When confronted with machine learning tasks involving the characterization of multiple items in the output employing a sequential approach confers the advantage of modularity, simplified debugging (only dealing with one variable at a time), and easier to add additional features (better scalability). At the first step, the model diagnoses the powder core material (e.g., Cu, AlSi10Mg, IN718, SS316L, Ti64), while subsequent powder core type-specific ML algorithms identify powder age, oxygen content, powder deposition thickness, and PSD. More than one ML algorithm could achieve the identification desired, but the K-nearest neighbor algorithm (KNN) was selected as it is a non-parametric algorithm. It makes no assumption about the underlying data distribution. This flexibility allows it to be applied to a wide range of problems without the need for extensive data preprocessing or model tuning. KNN can be used for both classification and regression tasks, making it suitable for various types of predictive modeling problems. KNN is robust to noisy data because it relies on the majority vote or averaging of nearest neighbors. Outliers or noisy data points have less influence on the final prediction compared to other algorithms that use a global model. Overall schematic of running cascaded machine learning on the datasets is depicted in FIG. 14.

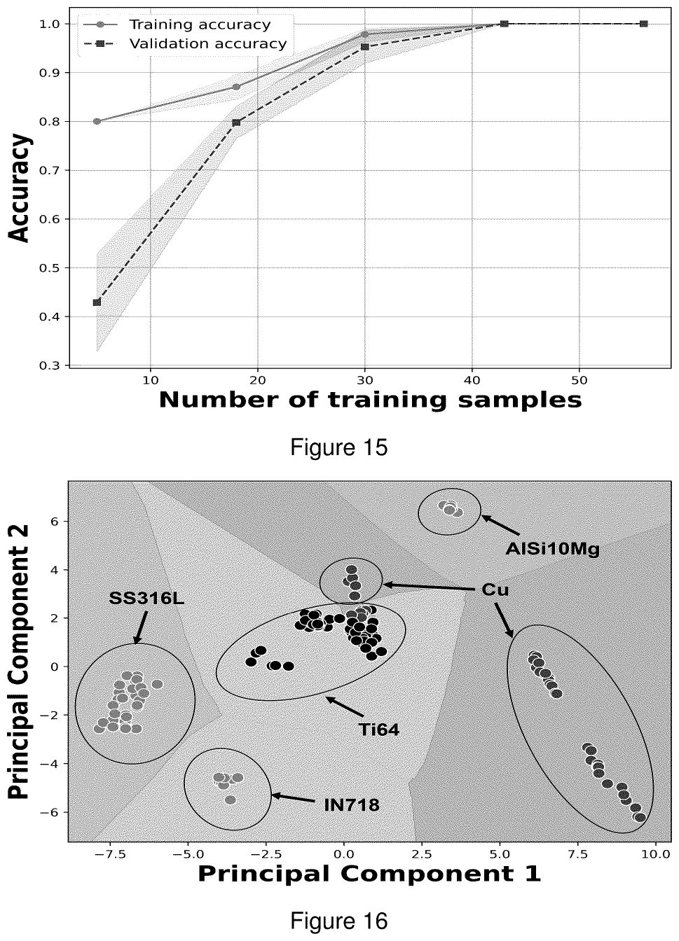

Powder Core Identification: The entire dataset was partitioned into two segments: 60% for training and 40% for testing. The outcomes proved promising, achieving 100% accuracy rate in material detection after running through the training cycles for all tested datasets (includes experiments with varying powder core type, age, oxygen content, powder thickness, and PSD). The learning curve for the powder core material detection shows training and validation accuracy versus number of training samples (FIG. 15). As the validation accuracy is very close to the training accuracy, it seems the model is generalizing well to new, unseen data, and not just memorizing the training data. The shaded areas around both the training and validation lines represent the variance in accuracy across different iterations of training. The shaded area for the training accuracy is relatively smaller compared to the validation accuracy, which is common since the training process is more controlled and less subject to the variability of unseen data. The model appears to have a good performance as the validation accuracy is quite high even with a relatively small number of samples. There is no clear sign of overfitting or underfitting since the training and validation accuracies are close. Overfitting would be indicated if the training accuracy were significantly higher than the validation accuracy. Underfitting would be suggested if both accuracies were low or if the validation accuracy was lower at the beginning and did not increase with more data. The learning curve suggests that the model reaches its optimal performance with around 30 training samples, as the increase in accuracy plateaus beyond this point. The model is relatively data-efficient since it achieves high accuracy with a limited number of samples.

The clusters and boundaries are depicted in FIG. 16 for the 5 tested powder core types versus the two principal reduced order components.

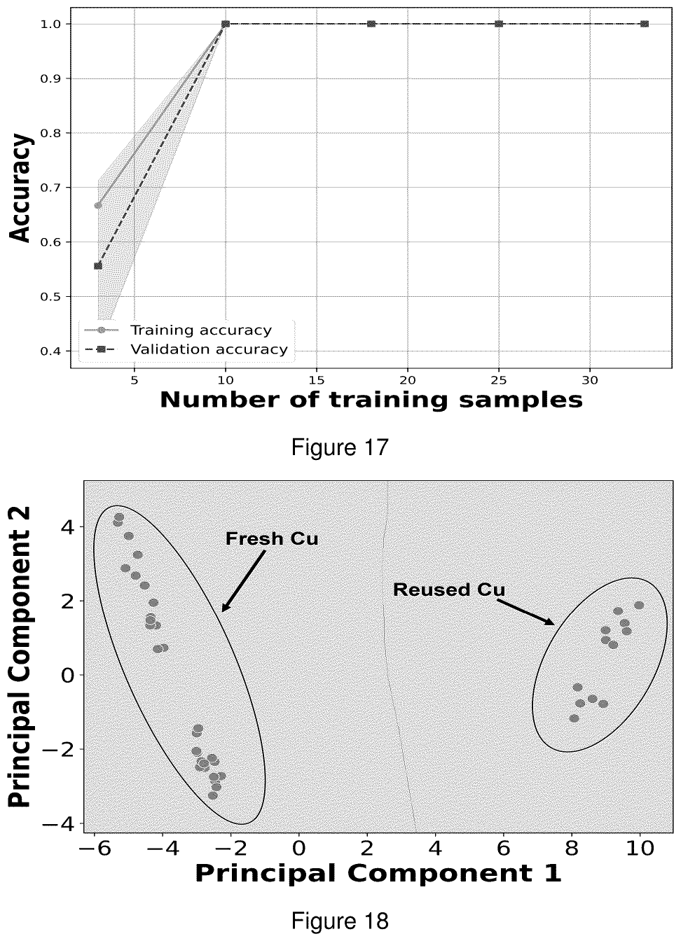

Powder Age Identification: Following the core material detection using the KNN method, the dataset underwent filtration based on the identified core material. This subsequent step aimed to delve deeper into the dataset's additional characteristics, distinguishing between fresh and reused powder. To proceed with the next step, copper powder was chosen. Therefore, all the datasets pertaining to copper were used in this machine learning task (42 datasets). The KNN method was also employed in this scenario. After splitting the dataset into 60% for training and 40% for testing, accuracy of 100% was achieved. The learning curve for this training can be found in FIG. 17.

FIG. 5B shows the clusters for fresh and reused Cu versus the two principal reduced order components.

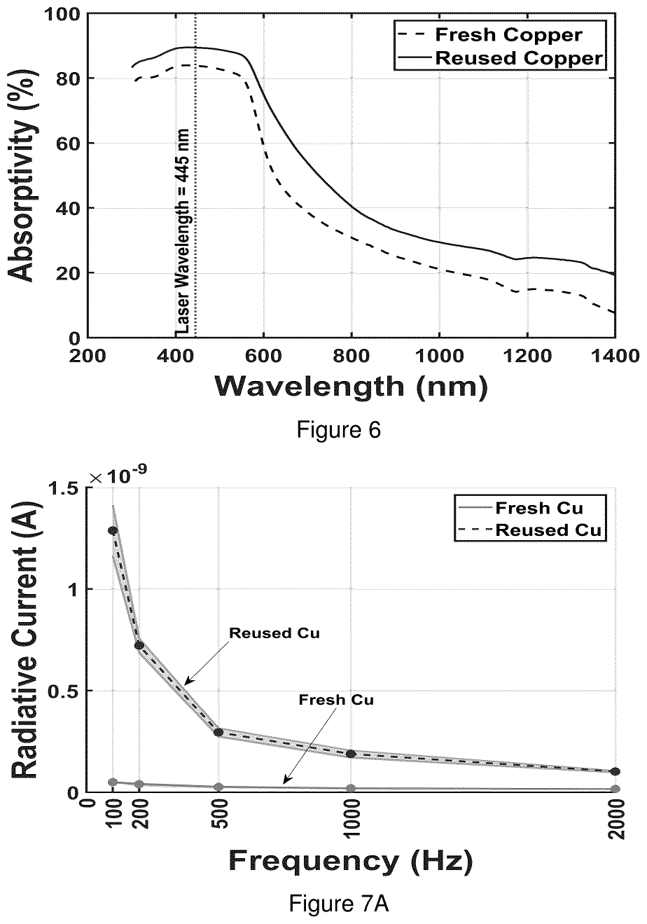

FIGS. 6A-6D show the radiated thermal response of the fresh vs reused (FIGS. 6A, 6B) Cu and (FIGS. 6C, 6D) Ti64 G23 vs frequency when heated with periodic heating of 5.5 W peak-to-peak. Plots (FIGS. 6A, 6C) show the periodic amplitude of thermal emission detected by the photodetector, and (FIGS. 6B, 6D) show the phase lag between laser heating and thermal emission. Shaded lines indicate the standard deviation between repeat 8 experiments.

FIGS. 7A-7D show evaluation of the technique to distinguish powder thickness. Plots of (FIGS. 7A, 7C) periodic radiated current and (FIGS. 7B, 7D) thermal phase lag of fresh (FIGS. 7A, 7B) Cu and (FIGS. 7C, 7D) Ti64 G23 powders of 60 and 240 μm versus frequency. The amplitude and phase were acquired after 1 second of 5.5 W peak-to-peak. Shaded lines indicate the standard deviation between 8 repeat experiments.

FIGS. 8A and 8B show the effect of particle size distribution on the response. The technique is evaluated to distinguish between two different Ti64 powder grades (5 and 23). The LECO oxygen content for the Grade 5 was 0.182±0.002 and the Grade 23 was 0.094±0.002. Powder size distribution for the tested G23 and G5 were D90s of 104 and 105 μm, and median of 68 and 76 μm.

FIGS. 9A, 9B and 9C show an evaluation of the technique to distinguish between three different particle size distributions with Ti64 G23 powders.

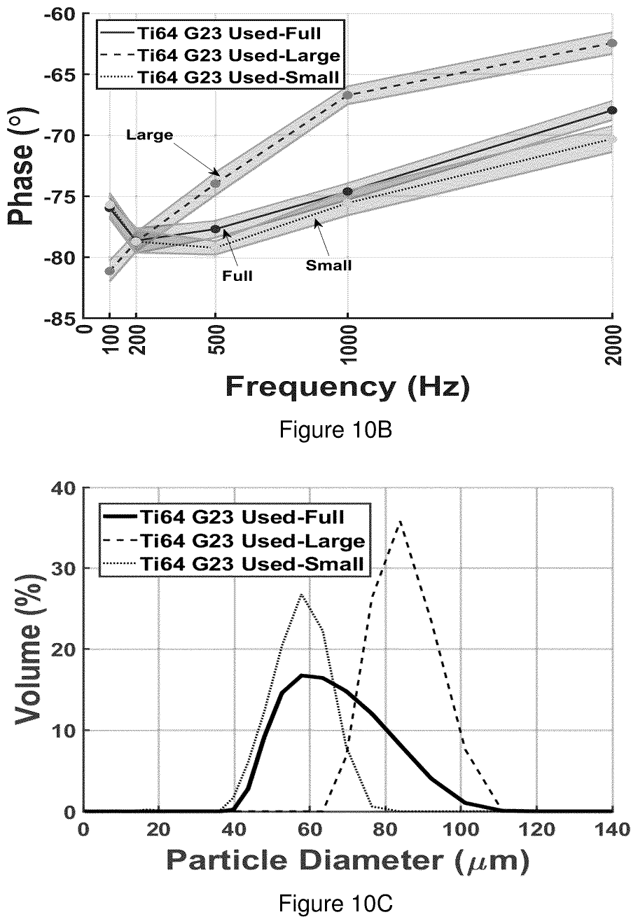

FIGS. 10A, 10B, and 10C show an evaluation of the technique to distinguish between three different particle size distributions with Ti64 G5 virgin powders.

FIGS. 11A, 11B, and 11C show a sampling of the frequency-domain temporal response of the powder.

FIG. 12 shows a PCA decomposition that distinguishes different powder core materials.

FIG. 13 shows a confusion matrix showing accurate determination of powder type. Data set included powders of multiple thickness, ages, powder size distributions.

FIG. 14 shows a layered machine learning approach first identifies powder, and then trains specialized machine learning model specific to each material set.

FIGS. 15A and 15B show a differentiation between fresh and reused copper.

FIG. 16 shows the PCA for fresh vs reused copper using two principal components.

FIG. 17 shows a confusion matrix for determining thickness of copper powder deposition. Tested for thicknesses of 60, 120, 180, and 240 μm depositions (labeled as states 0, 1, 2, 3).

FIG. 18 shows a PCA analysis showing clustering for different thicknesses of Cu deposition.

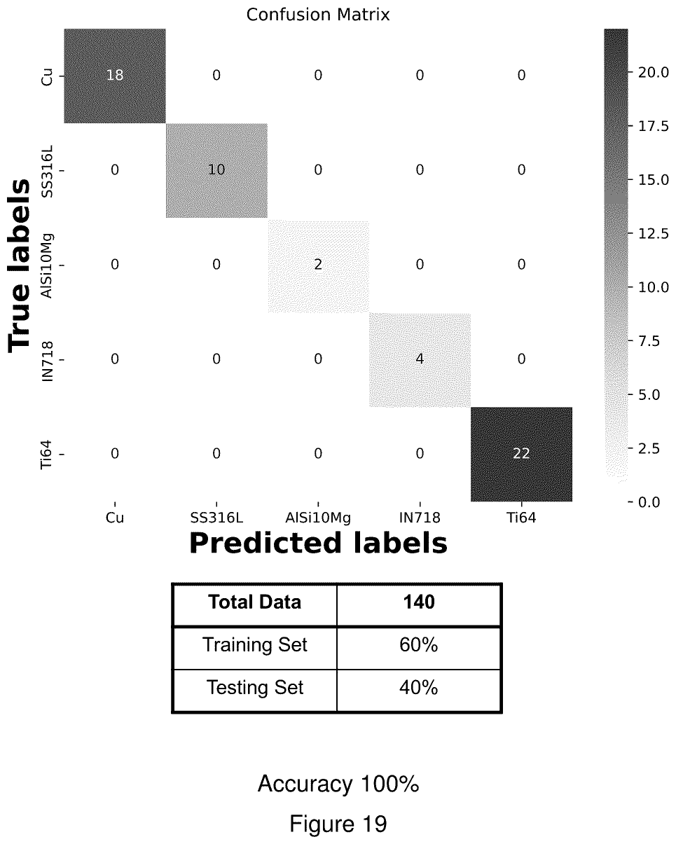

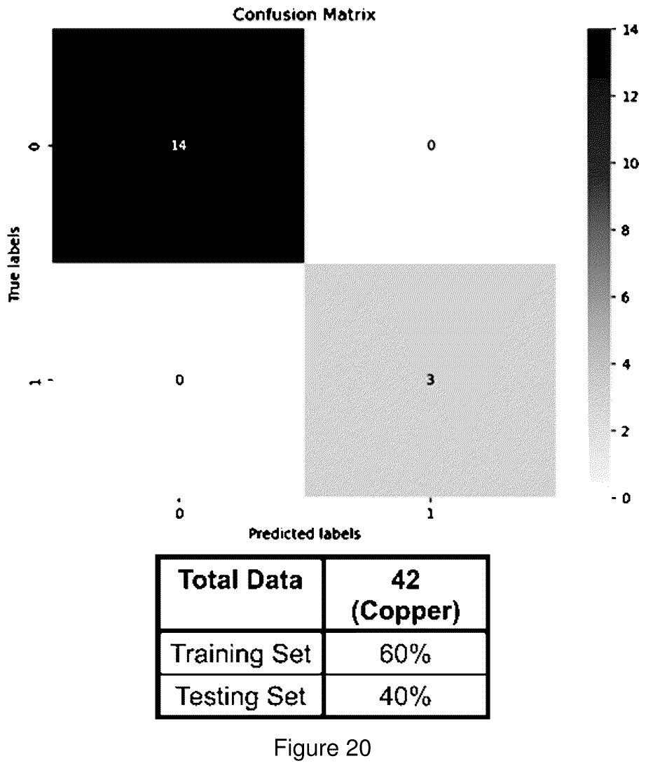

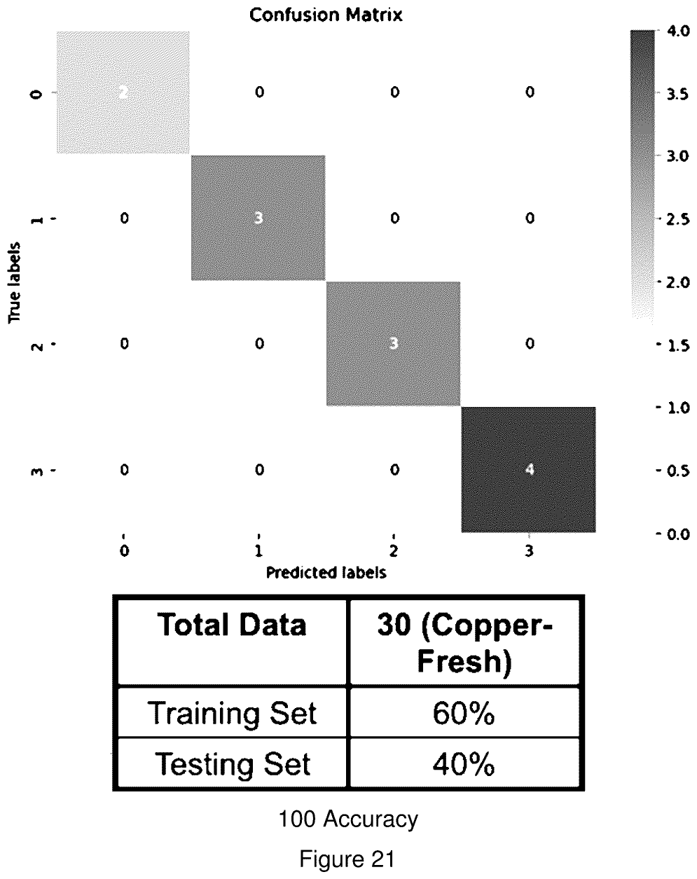

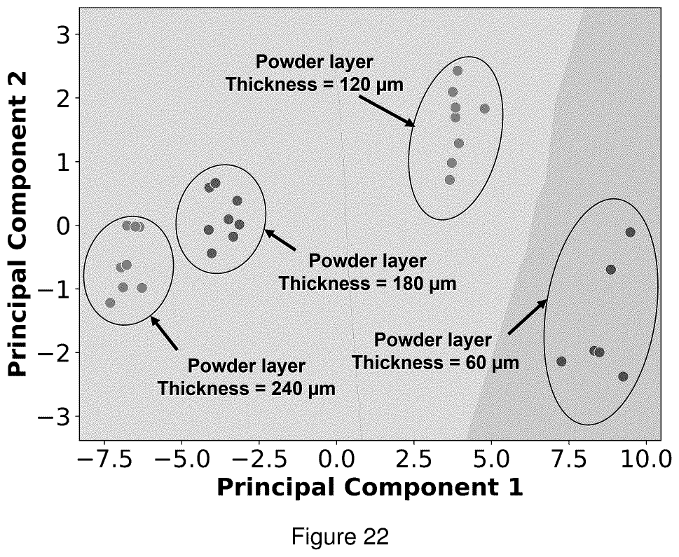

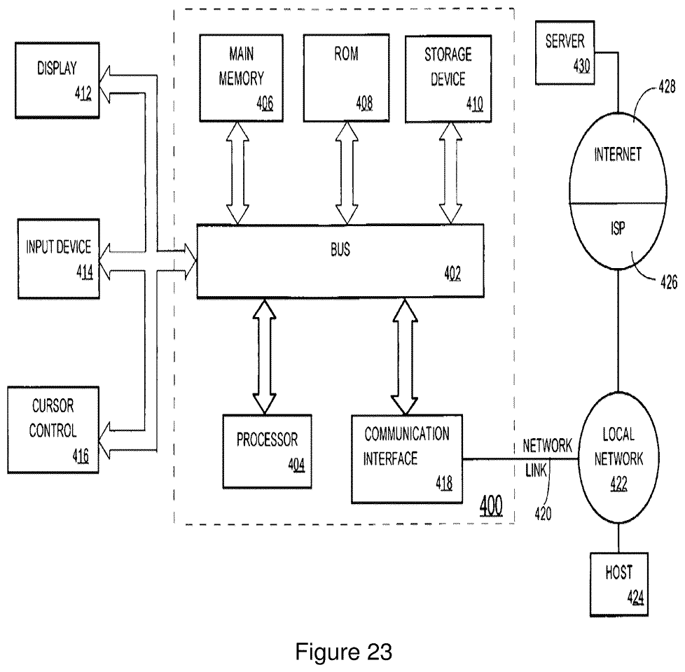

FIG. 19 (see U.S. Pat. No. 7,702,660, expressly incorporated herein by reference), shows a block diagram that illustrates a computer system 400, that may be used to control the additive manufacturing system. Computer system 400 includes a bus 402 or other communication mechanism for communicating information, and a processor 404 coupled with bus 402 for processing information. Computer system 400 also includes a main memory 406, such as a random-access memory (RAM) or other dynamic storage device, coupled to bus 402 for storing information and instructions to be executed by processor 404. Main memory 406 also may be used for storing temporary variables or other intermediate information during execution of instructions to be executed by processor 404. Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions. The computer system may also employ non-volatile memory, such as FRAM and/or MRAM.

The computer system may include a graphics processing unit (GPU), which, for example, provides a parallel processing system which is architected, for example, as a single instruction-multiple data (SIMD) processor. Such a GPU may be used to efficiently compute transforms and other readily parallelized and processed according to mainly consecutive unbranched instruction codes.

While deterministic programs may be employed, machine learning systems, including neural networks, deep neural networks, and clustering algorithms, Gaussian mixture model, spectral clustering, hierarchical clustering may be used to implement various aspects of the signal processing and control.

Computer system 400 may be coupled via bus 402 to a display 412, such as a liquid crystal display (LCD) or organic Light Emitting Diode (oLED) display, for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. A virtual reality interface may also be used. This input device typically has two degrees of freedom in two axes, a first axis (e.g., x) and a second axis (e.g., y), that allows the device to specify positions in a plane.

The computer system has an input for a thermal sensor or imaging thermal sensor, which provides the data for analysis. This may be connected using a Universal Serial Bus (USB) interface, i.e., USB 2, USB 3, USB 3.1, or USB 3.2. On the other hand, the sensor may have a network connection and connect over ethernet (IEEE-802.3ab) or wireless ethernet (IEEE-802.11ax), I2C, SPI, CANbus, or other suitable interface.

According to one embodiment of the invention, those techniques are performed by computer system 400 in response to processor 404 executing one or more sequences of one or more instructions contained in main memory 406. Such instructions may be read into main memory 406 from another machine-readable medium, such as storage device 410. Execution of the sequences of instructions contained in main memory 406 causes processor 404 to perform the process steps described herein. In alternative embodiments, hard-wired circuitry, microcodes, or firmware may be used in place of or in combination with software instructions to implement the invention. Thus, embodiments of the invention are not limited to any specific combination of hardware circuitry and software.

Advantageously, machine learning tasks may be executed on an SIMD processor, commonly available in Graphics Processing Unit (GPU) cards or embedded within CPU or APU processors. A neural network co-processor may also be used. Typically, the sensor data is received and formatted by the CPU of the system, and then passed through a PCIe interface, e.g., PCIe 3, 4 or 5, to the GPU coprocessor which also serves as a graphics engine, though not necessarily concurrently. The GPU hosts the neural network parameters, which then process the stream of data in real time or in a batch mode. Typically, a real time process is advantageous, to detect and permit correction of problems as they occur, rather than after the damage due to defective or deficient powder is done in the build. However, some use cases permit or even demand collection of data for post-processing.

The term “machine-readable medium” as used herein refers to any medium that participates in providing data that causes a machine to operation in a specific fashion. In an embodiment implemented using computer system 400, various machine-readable media are involved, for example, in providing instructions to processor 404 for execution. Such a medium may take many forms, including but not limited to, non-volatile media, volatile media. Non-volatile media includes, for example, semiconductor devices, optical or magnetic disks, such as storage device 410. Volatile media includes dynamic memory, such as main memory 406. All such media are tangible to enable the instructions carried by the media to be detected by a physical mechanism that reads the instructions into a machine. Common forms of machine-readable media include, for example, hard disk (or other magnetic medium), CD-ROM, DVD-ROM (or other optical or magnetoptical medium), semiconductor memory such as RAM, PROM, EPROM, FLASH, any other memory chip or cartridge, or any other medium from which a computer can read. Various forms of machine-readable media may be involved in carrying one or more sequences of one or more instructions to processor 404 for execution.

For example, the instructions may initially be carried on an SSD of a networked computer. The networked computer can load the instructions into its dynamic memory and send the instructions over the Internet or local area network through an automated computer communication network router. An interface local to computer system 400 can receive the data and communicate using an Ethernet protocol (e.g., IEEE-802. X) to a communication port, and place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be a local area network (LAN) card to provide a data communication connection to a compatible LAN. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world-wide packet data communication network now commonly referred to as the “Internet” 428. Local network 422 and Internet 428 may use electrical, electromagnetic or optical signals that carry digital data streams. The signals through the various networks and the signals on network link 420 and through communication interface 418, which carry the digital data to and from computer system 400.

Computer system 400 can send messages and receive data, including memory pages, memory sub-pages, and program code, through the network(s), network link 420 and communication interface 418. In the Internet example, a server 430 might transmit a requested code for an application program through Internet 428, ISP 426, local network 422 and communication interface 418. The received code may be executed by processor 404 as it is received, and/or stored in storage device 410, or other non-volatile storage for later execution.

The computer system may be an embedded computer system of an additive manufacturing system, or a separate system, and may be located remote or local. In one embodiment, the computer system runs Linux, on an Intel-7-14900K processor with an n Vidia RTX 4090 GPU e.g., for executing neural network and other machine learning algorithms. The computer system may also be a laptop computer, e.g., an HP Z-Book 17 G5, or a workstation/server such as an HP 28 workstation.

It will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software.

Although the invention(s) have been described with reference to specific embodiments, it will be understood by those skilled in the art that various changes may be made and equivalents may be substituted for elements thereof without departing from the true spirit and scope of the invention. In addition, modifications may be made without departing from the essential teachings of the invention. The invention is described by way of various embodiments and features. This disclosure is intended to encompass all consistent combinations, subcombinations, and permutations of the different options and features, as if expressly set forth herein individually.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

The disclosure has been described with reference to various specific embodiments and techniques. However, many variations and modifications are possible while remaining within the scope of the disclosure.

As used herein in this document, the terms “coupled to” and “coupled with” are also used cuphemistically to mean “communicatively coupled with” over a network, where two or more devices are able to exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### REFERENCES

Each reference cited herein is expressly incorporated by reference herein in its entirety.
Ahmad, Noor, and Ali Bou Nassif. “Dimensionality reduction: Challenges and solutions.” In ITM Web of Conferences, vol. 43, p. 01017. EDP Sciences, 2022.
Akash, Nazmus Sakib, Shakir Rouf, Sigma Jahan, Amlan Chowdhury, and Jia Uddin. “Botnet detection in IoT devices using random forest classifier with independent component analysis.” Journal of Information and Communication Technology 21, no. 2 (2022): 201-232.
Alkahari, M. R., Furumoto, T., Ueda, T., Hosokawa, A., Tanaka, R., Aziz, A., Sanusi, M., 2012. Thermal conductivity of metal powder and consolidated material fabricated via selective laser melting, in: Key Engineering Materials. Trans Tech Publ, pp. 244-249.
Allaoui, Mebarka, Mohammed Lamine Kherfi, and Abdelhakim Cheriet. “Considerably improving clustering algorithms using UMAP dimensionality reduction technique: a comparative study.” In International conference on image and signal processing, pp. 317-325. Cham: Springer International Publishing, 2020.
Amini, Mahyar, and Ali Rahmani. “Machine learning process evaluating damage classification of composites.” International Journal of Science and Advanced Technology 9, no. 2023 (2023): 240-250.
Anowar, Farzana, Samira Sadaoui, and Bassant Selim. “Conceptual and empirical comparison of dimensionality reduction algorithms (pca, kpca, lda, mds, svd, lle, isomap, le, ica, t-snc).” Computer Science Review 40 (2021): 100378.
Azizi, A., Dacumer, M. A., Schiffres, S. N., 2019. Additive laser metal deposition onto silicon. Addit. Manuf. 25, 390-398. doi.org/10.1016/j.addma.2018.09.027
Azizi, A., Schiffres, S. N., 2018. Laser Metal Additive Manufacturing on Graphite, in: Solid Freeform Fabrication Symposium. Presented at the Solid Freeform Fabrication, Austin, TX, pp. 1-10.
Bagnall, A., J. Lines, J. Hills, A. Bostrom, Time-series classification with COTE: the collective of transformation-based ensembles. IEEE Transactions on Knowledge and Data Engineering 27 (9), 2522-2535 (2015)
Baydogan, M. G., G. Runger, E. Tuv, A bag-of-features framework to classify time series. IEEE Transactions on Pattern Analysis and Machine Intelligence 35 (11), 2796-2802 (2013)
Bergman, T. L., Incropera, F. P., Adrienne, L. S., DeWitt, D. P., 2011. Introduction to heat transfer. John Wiley & Sons.
Bishop, C. M. (1995). Neural Networks for Pattern Recognition. Clarendon Press, Oxford, England. 1995. ISBN: 0198538642 cs.du.edu/˜mitchell/mario_books/Neural_Networks_for_Pattern_Recognition_Christopher_Bis hop.pdf
Bodelot, L., Sabatier, L., Charkaluk, E., Dufrenoy, P., 2009. Experimental setup for fully coupled kinematic and thermal measurements at the microstructure scale of an AISI 316L steel. Mater. Sci. Eng. A 501, 52-60. doi.org/10.1016/j.msca.2008.09.053
Bonnet, C., Valiorgue, F., Rech, J., Claudin, C., Hamdi, H., Bergheau, J. M., Gilles, P., 2008. Identification of a friction model—Application to the context of dry cutting of an AISI 316L austenitic stainless steel with a TiN coated carbide tool. Int. J. Mach. Tools Manuf. 48, 1211-1223. doi.org/10.1016/j.ijmachtools.2008.03.011
Boutsidis, Christos, Anastasios Zouzias, Michael W. Mahoney, and Petros Drincas. “Randomized dimensionality reduction for $ k $-means clustering.” IEEE Transactions on Information Theory 61, no. 2 (2014): 1045-1062.
Brazdil P., Soares C. &da Costa, J. (2003). Ranking Learning Algorithms: Using IBL and Meta-Learning on Accuracy and Time Results. Machine Learning V 50, Issue 3 2003 doi: 10.1023/A: 1021713901879 pp. 251-277.
Brø tan, V., Berg, O.Å., Sørby, K., 2016. Additive Manufacturing for Enhanced Performance of Molds. Procedia CIRP, 6th CIRP Conference on Learning Factories 54, 186-190. doi.org/10.1016/j.procir.2016.05.074
Buchbinder, D., Schleifenbaum, H., Heidrich, S., Meiners, W., Bultmann, J., 2011. High Power Selective Laser Melting (HP SLM) of Aluminum Parts. Phys. Procedia, Lasers in Manufacturing 2011—Proceedings of the Sixth International WLT Conference on Lasers in Manufacturing 12, 271-278. doi.org/10.1016/j.phpro.2011.03.035
Bunnell, D. E., 1995. Fundamentals of selective laser sintering of metals (Ph.D.). The University of Texas at Austin, United States—Texas.
Cahill, D., 2005. Analysis of Heat Flow in Layered Structures for Time-Domain Thermoreflectance. Rev. Sci. Instrum. 75, 5119-5122. doi.org/10.1063/1.1819431
Cahill, David G., “Measurement of Thermal Conductivity”, users.mrl.illinois.edu/cahill/thermal_school09.pdf (2009).
Cai, N., Zhou, G., Müller, K., Starr, D. E., 2013. Comparative Study of the Passivation of Al (111) by Molecular Oxygen and Water Vapor. J. Phys. Chem. C 117, 172-178. doi.org/10.1021/jp305740s
Cao, L. J., Kok Seng Chua, Wai Keong Chong, Heow Pueh Lee, and Q. M. Gu. “A comparison of PCA, KPCA and ICA for dimensionality reduction in support vector machine.” Neurocomputing 55, no. 1-2 (2003): 321-336.
Cao, X., Campbell, J., 2005. Oxide inclusion defects in Al—Si—Mg cast alloys. Can. Metall. Q. 44, 435-449.
Carslaw, H. S., Jaeger, J. C., 1959. Conduction of heat in solids. Oxf. Clarendon Press 1959 2nd Ed 1.
Chang, J. R., Y. S. Chen. Batch-normalized maxout network in network. Computer Science, 2015.
Charbuty, Bahzad, and Adnan Abdulazeez. “Classification based on decision tree algorithm for machine learning.” Journal of Applied Science and Technology Trends 2, no. 01 (2021): 20-28. Wang, Pin, En Fan, and Peng Wang. “Comparative analysis of image classification algorithms based on traditional machine learning and deep learning.” Pattern Recognition Letters 141 (2021): 61-67.
Chen, J. K., Hung, H. Y., Wang, C. F., Tang, N. K., 2017. Effects of casting and heat treatment processes on the thermal conductivity of an Al—Si—Cu—Fe—Zn alloy. Int. J. Heat Mass Transf. 105, 189-195. doi.org/10.1016/j.ijheatmasstransfer.2016.09.090
Chen, X., Li, J., Cheng, X., Wang, H., Huang, Z., 2018. Effect of heat treatment on microstructure, mechanical and corrosion properties of austenitic stainless steel 316L using arc additive manufacturing. Mater. Sci. Eng. A 715, 307-314. doi.org/10.1016/j.msca.2017.10.002
Chen, Y., E. Keogh, B. Hu, N. Begum, A. Bagnall, A. Mucen, and G. Batista, The UCR time series classification archive, 2015, www.cs.ucr.edu/˜camonn/time_series_data/
Cheng, J., Greiner, R., Kelly, J., Bell, D.& Liu, W. (2002). Learning Bayesian networks from data: An information-theory based approach. Artificial Intelligence Volume 137. 2002. pp. 43-90. www.sciencedirect.com/science/article/pii/S00043702 02001911
Cheverton, M. A., Jr, J. B. D., 2015. Systems and methods for monitoring a melt pool using a dedicated scanning device. US20150375456A1.
Clark III, L. M., Taylor, R. E., 1975. Radiation loss in the flash method for thermal diffusivity. J. Appl. Phys. 46, 714-719. doi.org/10.1063/1.321635
Clijsters, S., Craeghs, T., Buls, S., Kempen, K., Kruth, J.-P., 2014. In situ quality control of the selective laser melting process using a high-speed, real-time melt pool monitoring system. Int. J. Adv. Manuf. Technol. 75, 1089-1101. doi.org/10.1007/s00170-014-6214-8
Cohen, Michael B., Sam Elder, Cameron Musco, Christopher Musco, and Madalina Persu. “Dimensionality reduction for k-means clustering and low rank approximation.” In Proceedings of the forty-seventh annual ACM symposium on Theory of computing, pp. 163-172. 2015.
Craeghs, T., Clijsters, S., Kruth, Jean.-P., Bechmann, F., Ebert, Maric.-C., 2012. Detection of Process Failures in Layerwise Laser Melting with Optical Process Monitoring. Phys. Procedia, Laser Assisted Net shape Engineering 7 (LANE 2012) 39, 753-759. doi.org/10.1016/j.phpro.2012.10.097
Cui, Z., W. Chen, Y. Chen, Multi-scale convolutional neural networks for time series classification. CoRR 1603 (06995) (2016)
Domingos, P. & Pazzani, M. (1997). On the optimality of the simple Bayesian classifier under zero-one loss. Machine Learning Volume 29, pp. 103-130 disi.unitn.it/˜p2p/RelatedWork/Matching/domingos9 7optimality.pdf
Dumas, P., Dubarry-Barbe, J., Rivière, D., Levy, Y., Corset, J., 1983. Growth Of Thin Alumina Film On Aluminium At Room Temperature: A Kinetic And Spectroscopic Study By Surface Plasmon Excitation. J. Phys. Colloq. 44, C10-205-C10-208. doi.org/10.1051/jphyscol: 19831042
Dutta, B., Additive Manufacturing by Direct Metal Deposition May 2011 AM&P Technical Articles 169 (5): 33-36 4.
Eagar, T. W., Tsai, N. S., 1983. Temperature Fields Produced by Traveling Distributed Heat Sources. Weld. J. 62, 346-s-355-s.
Elder, J. (2015). Introduction to Machine Learning and Pattern Recognition. Available at Lassonde University EECS Department York website: www.cccs.yorku.ca/course_archive/2011-12/F/4404-5327/lectures/01% 20Introduction.pd
EOSStainlessSteel316L.pdf, EOS.cdn1.scrvt.com/cos/77d285f20ed6ac89/dd6850c010d3/EOSStainlessSteel316L.pdf.
Fawaz, H. I., G. Forestier, J. Weber, et al. Deep learning for time series classification: a review. Data Mining and Knowledge Discovery, 2019, 33 (4): 917-963, 2019.
Feldman, A., 1999. Algorithm for solutions of the thermal diffusion equation in a stratified medium with a modulated heating source. High Temp-High Press 31, 293-298.
Flash Diffusivity Method: A Survey of Capabilities, 2002 . . . . Electron. Cool.www.electronics-cooling.com/2002/05/flash-diffusivity-method-a-survey-of-capabilities/
Fodor, Imola K. A survey of dimension reduction techniques. No. UCRL-ID-148494. Lawrence Livermore National Lab (LLNL), Livermore, CA (United States), 2002.
Frazier, W. E., 2014. Metal Additive Manufacturing: A Review. J. Mater. Eng. Perform. 23, 1917-1928. doi.org/10.1007/s11665-014-0958-z
Geng, Xin, De-Chuan Zhan, and Zhi-Hua Zhou. “Supervised nonlinear dimensionality reduction for visualization and classification.” IEEE Transactions on Systems, Man, and Cybernetics, Part B (Cybernetics) 35, no. 6 (2005): 1098-1107.
Ghojogh, Benyamin, Ali Ghodsi, Fakhri Karray, and Mark Crowley. “Uniform manifold approximation and projection (UMAP) and its variants: tutorial and survey.” arXiv preprint arXiv: 2109.02508 (2021).
Gong, H., 2013. Generation and detection of defects in metallic parts fabricated by selective laser melting and electron beam melting and their effects on mechanical properties.
Gong, W. W., L. Y. Qi, Y. W. Xu. Privacy-aware multidimensional mobile service quality prediction and recommendation in distributed fog environment. Wireless Communications and Mobile Computing, vol. 2018, Article ID 3075849, 8 pages, 2018.
Good, I. J. (1951). Probability and the Weighing of Evidence, Philosophy V. 26, Issue 97, pp. 163-164. doi: doi.org/10.1017/S0031819100026863. www.cambridge.org/core/journals/philosophy/article/probability-and-the-weighing-of-evidence-by-goodi-j-london-charles-griffin-and-company-1950-pp-viii-119-price-16s/7D911224F3713FDCFD1451BBB2982442
Grasso, M., Colosimo, B. M., 2017. Process defects and in situ monitoring methods in metal powder bed fusion: a review. Meas. Sci. Technol. 28, 044005. doi.org/10.1088/1361-6501/aa5c4f
Hariharan, G., Kannan, K., 2014. Review of wavelet methods for the solution of reaction-diffusion problems in science and engineering. Appl. Math. Model. 38, 799-813. doi.org/10.1016/j.apm.2013.08.003
Hastic, T., R. Tibshirani, J. H. Friedman (2001)—The elements of statistical learning, I Data mining, inference, and prediction, 2001, New York: Springer Verlag.
He, K., Zhang X, Ren S, et al. Deep residual learning for image recognition//Proceedings of the IEEE conference on computer vision and pattern recognition. 2016:770-778.
Ho, C. Y., Chu, T. K., 1977. Electrical resistivity and thermal conductivity of nine selected AISI stainless steels. Thermophysical And Electronic Properties Information Analysis Center Lafayette IN.
Hormozi, H., Hormozi, E. & Nohooji, H. R. (2012). The Classification of the Applicable Machine Learning Methods in Robot Manipulators. International Journal of Machine Learning and Computing (IJMLC), Vol. 2, No. 5, 2012 doi: 10.7763/IJMLC.2012. V2.189 pp. 560-563. www.ijmlc.org/papers/189-C00244-001.pdf
ImageJ, imagej.nih.gov/ij/.
Jamshad, A., 2016. A Comparative Study on Modifications of Decomposition Method. Int. J. Adv. Sci. Res. 2, 157-159.
Jiang, P., Qian, X., Yang, R., 2018. Tutorial: Time-domain thermoreflectance (TDTR) for thermal property characterization of bulk and thin film materials. J. Appl. Phys. 124, 161103. doi.org/10.1063/1.5046944
Karim, F., S. Majumdar, H. Darabi, S. Chen, LSTM fully convolutional networks for time series classification. IEEE Access., 1662-1669 (2018)
Kellner, T., 2017. How 3D Printing Will Change Manufacturing. GE Rep.www.ge.com/reports/epiphany-disruption-ge-additive-chief-explains-3d-printing-will-upend-manufacturing/
Khairallah, S. A., Anderson, A. T., Rubenchik, A., King, W. E., 2016. Laser powder-bed fusion additive manufacturing: Physics of complex melt flow and formation mechanisms of pores, spatter, and denudation zones. Acta Mater. 108, 36-45. doi.org/10.1016/j.actamat.2016.02.014
Kleszczynski, S., (1973) Improving Process Stability of Laser Beam Melting Systems 7.
Kobak, Dmitry, and George C. Linderman. “Initialization is critical for preserving global data structure in both t-SNE and UMAP.” Nature biotechnology 39, no. 2 (2021): 156-157.
Koh, J. C. Y., Fortini, A., 1971. Thermal Conductivity and Electrical Resistivity of Porous Material.
Koh, J. C. Y., Fortini, A., 1973. Prediction of thermal conductivity and electrical resistivity of porous metallic materials. Int. J. Heat Mass Transf. 16, 2013-2022. doi.org/10.1016/0017-9310 (73) 90104-X
Kotsiantis, S. B. (2007). Supervised Machine Learning: A Review of Classification Techniques. Informatica 31 (2007). Pp. 249-268. wen.ijs.si/ojs-2.4.3/index.php/informatica/article/download/148/140.
Kotsiantis, Sotiris B., Ioannis D. Zaharakis, and Panayiotis E. Pintelas. “Machine learning: a review of classification and combining techniques.” Artificial Intelligence Review 26 (2006): 159-190.
Kotsiantis, Sotiris B., Ioannis Zaharakis, and P. Pintelas. “Supervised machine learning: A review of classification techniques.” Emerging artificial intelligence applications in computer engineering 160, no. 1 (2007): 3-24.
Krakhmalev, P., Yadroitsava, I., Fredriksson, G., Yadroitsev, I., 2014. Microstructure of SLM manufactured 316L and 420 grades stainless steel. Proceeding RAPDASA 15th Annu. Int. Conf. 2014 Novemb. 6-7 Stellenbosch South Afr. 59-66.
Kurzynowski, T., Gruber, K., Stopyra, W., Kuźnicka, B., Chlebus, E., 2018. Correlation between process parameters, microstructure and properties of 316 L stainless steel processed by selective laser melting. Mater. Sci. Eng. A 718, 64-73. doi.org/10.1016/j.msca.2018.01.103
Kwak, Nojun, Chunghoon Kim, and Hwangnam Kim. “Dimensionality reduction based on ICA for regression problems.” Neurocomputing 71, no. 13-15 (2008): 2596-2603.
Lea, C., R. Vidal, A. Reiter, and G. D. Hager, Temporal convolutional networks: a unified approach to action segmentation. ECCV 2016: Computer Vision-ECCV 2016 Workshops, 2016:47-54.
Lec, H.-M., Tsai, M.-C., Chen, H.-L., Li, H.-Y., 2017. Stainless Steel Heat Pipe Fabrication, Performance Testing and Modeling. Energy Procedia, 8th International Conference on Applied Energy, ICAE2016, 8-11 Oct. 2016, Beijing, China 105, 4745-4750. doi.org/10.1016/j.egypro.2017.03.1032
Lei, Y., Yan, Y. Han, and F. Jiang. The hierarchies of multivalued attribute domains and corresponding applications in data mining. Wireless Communications and Mobile Computing, Volume 2018, Article ID 1789121, 1-11, 2018.
Lemnaru, C. (2012). Strategies for dealing with Real World Classification Problems, (PhD thesis) Faculty of Computer Science and Automation, Universitatea Technica, Din Cluj-Napoca. users.utcluj.ro/˜cameliav/documents/TezaFinalLemna ru.pdf
Lima, W. M., Biondo, V., Weinand, W. R., Nogueira, E. S., Medina, A. N., Baesso, M. L., Bento, A. C., 2005. The effect of porosity on thermal properties: towards a threshold of particle contact in sintered stainless steel. J. Phys. Condens. Matter 17, 1239-1249. doi.org/10.1088/0953-8984/17/7/016
Lin, J., E. Keogh, L. Wei, S. Lonardi, Experiencing SAX: a novel symbolic representation of time series. Data Mining and knowledge discovery 15 (2), 107-144 (2007)
Lines, J., A. Bagnall, Time series classification with ensembles of elastic distance measures. Data Mining and Knowledge Discovery 29 (3), 565-592 (2015)
Liu, H. W., H. Z. Kou, C. Yan, L. Y. Qi, Link prediction in paper citation network to construct paper correlation graph. EURASIP Journal on Wireless Communications and Networking (2019). doi.org/10.1186/s13638-019-1561-7
Liverani, E., Toschi, S., Ceschini, L., Fortunato, A., 2017. Effect of selective laser melting (SLM) process parameters on microstructure and mechanical properties of 316L austenitic stainless steel. J. Mater. Process. Technol. 249, 255-263. doi.org/10.1016/j.jmatprotec.2017.05.042
Loffe S., and C. Szegedy. Batch normalization: accelerating deep network training by reducing internal covariate shift, International Conference on Machine Learning, pp. 448-456, 2015.
Long, J., E. Shelhamer, and T. Darrell, Fully convolutional networks for semantic segmentation, in Proceedings of the IEEE Conference on Computer Vision and Pattern Recognition, 2015, pp. 3431-3440.
Louvis, E., Fox, P., Sutcliffe, C. J., 2011. Selective laser melting of aluminium components. J. Mater. Process. Technol. 211, 275-284. doi.org/10.1016/j.jmatprotec.2010.09.019
Ly, S., Rubenchik, A. M., Khairallah, S. A., Guss, G., Matthews, M. J., 2017. Metal vapor micro-jet controls material redistribution in laser powder bed fusion additive manufacturing. Sci. Rep. 7, 4085. doi.org/10.1038/s41598-017-04237-z
Malen, J. A., Baheti, K., Tong, T., Zhao, Y., Hudgings, J. A., Majumdar, A., 2011. Optical Measurement of Thermal Conductivity Using Fiber Aligned Frequency Domain Thermoreflectance. J. Heat Transf. 133. doi.org/10.1115/1.4003545
Mani, M., Lane, B., Donmez, A., Feng, S., Moylan, S., Fesperman, R., 2015.
Measurement Science Needs for Real-time Control of Additive Manufacturing Powder Bed Fusion Processes (No. NIST IR 8036). National Institute of Standards and Technology. doi.org/10.6028/NIST. IR.8036
Markel, V. A., 2016. Introduction to the Maxwell Garnett approximation: tutorial. J. Opt. Soc. Am. A 33, 1244. doi.org/10.1364/JOSAA.33.001244
Matthews, M. J., Guss, G., Khairallah, S. A., Rubenchik, A. M., Depond, P. J., King, W. E., 2016. Denudation of metal powder layers in laser powder bed fusion processes. Acta Mater. 114, 33-42. doi.org/10.1016/j.actamat.2016.05.017
Maxwell, Aaron E., Timothy A. Warner, and Fang Fang. “Implementation of machine-learning classification in remote sensing: An applied review.” International journal of remote sensing 39, no. 9 (2018): 2784-2817.
McInnes, Leland, John Healy, and James Melville. “Umap: Uniform manifold approximation and projection for dimension reduction.” arXiv preprint arXiv: 1802.03426 (2018).
Muñoz, Mario A., Laura Villanova, Davaatseren Baatar, and Kate Smith-Miles. “Instance spaces for machine learning classification.” Machine Learning 107 (2018): 109-147.
Musa, Abdallah Bashir. “A comparison of [1-regularization, PCA, KPCA and ICA for dimensionality reduction in logistic regression.” International Journal of Machine Learning and Cybernetics 5 (2014): 861-873.
Neocleous C. & Schizas C. (2002). Artificial Neural Network Learning: A Comparative Review. In: Vlahavas I. P., Spyropoulos C. D. (eds) Methods and Applications of Artificial Intelligence. Hellenic Conference on Artificial Intelligence SETN 2002. Lecture Notes in Computer Science, V. 2308. doi: 10.1007/3-540-46014-4_27 pp. 300-313.
Newsom, I. (2015). Data Analysis II: Logistic Regression. web.pdx.edu/˜newsomj/da2/ho_logistic.pdf
Niendorf, T., Leuders, S., Riemer, A., Richard, H. A., Tröster, T., Schwarze, D., 2013. Highly Anisotropic Steel Processed by Selective Laser Melting. Metall. Mater. Trans. B 44, 794-796. doi.org/10.1007/s11663-013-9875-z
Nilsson, N.J. (1965). Learning machines. Journal of IEEE Transactions on Information Theory Volume 12 Issue 3, 1966. doi: 10.1109/TIT.1966.1053912 pp. 407-407. dl.acm.org/citation.cfm?id=2267404
Olakanmi, E. O., Cochrane, R. F., Dalgarno, K. W., 2015. A review on selective laser sintering/melting (SLS/SLM) of aluminium alloy powders: Processing, microstructure, and properties. Prog. Mater. Sci. 74, 401-477. doi.org/10.1016/j.pmatsci.2015.03.002
Olver, P. J., 2017. Topics in Fourier Analysis: DFT & FFT, Wavelets, Laplace Transform 41.
Outeiro, J. C., Umbrello, D., M′Saoubi, R., 2006. Experimental and numerical modelling of the residual stresses induced in orthogonal cutting of AISI 316L steel. Int. J. Mach. Tools Manuf. 46, 1786-1794. doi.org/10.1016/j.ijmachtools.2005.11.013
Parker, W. J., Jenkins, R. J., Butler, C. P., Abbott, G. L., 1961. Flash Method of Determining Thermal Diffusivity, Heat Capacity, and Thermal Conductivity. J. Appl. Phys. 32, 1679-1684. doi.org/10.1063/1.1728417
Pauly, S., Wang, P., Kühn, U., Kosiba, K., 2018. Experimental determination of cooling rates in selectively laser-melted cutectic Al-33Cu. Addit. Manuf. 22, 753-757. doi.org/10.1016/j.addma.2018.05.034
Payandch, M., Sjölander, E., Jarfors, A. E. W., Wessen, M., 2016. Influence of microstructure and heat treatment on thermal conductivity of rheocast and liquid die cast Al-6Si-2Cu—Zn alloy. Int. J. Cast Met. Res. 29, 202-213. doi.org/10.1080/13640461.2015.1125990
Physical Aspects of Process Control in Selective Laser Sintering of Metals-Das-2003-Advanced Engineering Materials-Wiley Online Library, onlinelibrary.wiley.com/doi/abs/10.1002/adem.200310099.
Post, H., 2014. SpaceX Launches 3D-Printed Part to Space, Creates Printed Engine Chamber. SpaceX.www.spacex.com/news/2014/07/31/spacex-launches-3d-printed-part-space-creates-printed-engine-chamber-crewed.
Pradeep, K. R. & Naveen, N. C. (2017). A Collective Study of Machine Learning (ML) Algorithms with Big Data Analytics (BDA) for Healthcare Analytics (HcA). Int. J. of Computer Trends and Technology (IJCTT)-V. 47 No. 3, 2017. ISSN: 2231-2803, doi: 10.14445/22312803/IJCTT-V47P121, pp 149-155. www.ijcttjournal.org/2017/Volume47/number-3/IJCTT-V47P121.pdf
Qi, L. Y., R. L. Wang, S. C. Li, Q. He, X. L. Xu, C. H. Hu, Time-aware distributed service recommendation with privacy-preservation. Information Sciences480, 354-364 (2019)
Qi, L. Y., X. Y. Zhang, W. C Dou, C. H. Hu, C. Yang, J. J. Chen. A two-stage locality-sensitive hashing based approach for privacy-preserving mobile service recommendation in cross-platform edge environment. Future Generation Computer Systems, 2018, 88:636-643.
Qiu, C., Kindi, M. A., Aladawi, A. S., Hatmi, I. A., 2018. A comprehensive study on microstructure and tensile behaviour of a selectively laser melted stainless steel. Sci. Rep. 8, 7785. doi.org/10.1038/s41598-018-26136-7
Raj, A., Lecture 5: Transforms, Fourier and Wavelets.
Rodriguez, P., Selection of Materials for Heat Exchangers 14.
Rosenblatt, F. (1962), Principles of Neurodynamics. Spartan, New York.
Sainburg, Tim, Leland McInnes, and Timothy Q. Gentner. “Parametric UMAP embeddings for representation and semisupervised learning.” Neural Computation 33, no. 11 (2021): 2881-2907.
Saini, Omprakash, and Sumit Sharma. “A review on dimension reduction techniques in data mining.” Comput. Eng. Intell. Syst 9, no. 1 (2018): 7-14.
Schäfer, P., Scalable time series classification. Data Mining and Knowledge Discovery 30 (5), 1273-1298 (2016)
Schäfer, P., The boss is concerned with time series classification in the presence of noise Data Mining and Knowledge Discovery, 2015, 29 (6): 1505-1530.
Schapire, Rob, (2015) Machine Learning Algorithms for Classification. Princeton University 10
Schmidt, A. J., 2008. Optical characterization of thermal transport from the nanoscale to the macroscale. Massachusetts Institute of Technology.
Schmidt, A. J., 2018. Thermal property microscopy with frequency domain thermoreflectance and uses thereof. U.S. Pat. No. 9,927,350B2.
Sen, Pratap Chandra, Mahimarnab Hajra, and Mitadru Ghosh. “Supervised classification algorithms in machine learning: A survey and review.” In Emerging Technology in Modelling and Graphics: Proceedings of IEM Graph 2018, pp. 99-111. Springer Singapore, 2020.
Setiono R. and Loew, W. K. (2000), FERNN: An algorithm for fast extraction of rules from neural networks, Applied Intelligence.
Shalev-Shwartz, Shai, and Shai Ben-David (2014). Understanding Machine Learning From Theory to Algorithms.
Shalizi, C., 36-402, Undergraduate Advanced Data Analysis, Logistic Regression pp. 223-237. www.stat.cmu.edu/˜cshalizi/uADA/12/lectures/ch12.pdf
Silva, D. d O., Richl, R. R., 2016. Thermal behavior of water-copper and water-stainless steel heat pipes operating in cycles, in: 2016 15th IEEE Intersociety Conference on Thermal and Thermomechanical Phenomena in Electronic Systems (ITherm). pp. 6-11. doi.org/10.1109/ITHERM.2016.7517521
Simmons, J., Azizi, A., Dacumer, M., Schiffres, S., 2018. Laser Powder Bed Fusion Processing Parameters Influence on Thermal Properties, in: Solid Freeform Fabrication Symposium. Presented at the Solid Freeform Fabrication Symposium, Solid Freeform Fabrication Symposium, Austin, TX, pp. 1-14.
Simmons, J. C., Chen, X., Azizi, A., Dacumer, M. A., Zavalij, P. Y., Zhou, G., Schiffres, S. N., 2020. Influence of processing and microstructure on the local and bulk thermal conductivity of selective laser melted 316L stainless steel. Addit. Manuf. 32, 100996. doi.org/10.1016/j.addma.2019.100996
Simonelli, M., Tuck, C., Aboulkhair, N. T., Maskery, I., Ashcroft, I., Wildman, R. D., Hague, R., 2015. A Study on the Laser Spatter and the Oxidation Reactions During Selective
Laser Melting of 316L Stainless Steel, Al-Si10-Mg, and Ti-6Al-4V. Metall. Mater. Trans. A 46, 3842-3851. doi.org/10.1007/s11661-015-2882-8
Smola, Alex & Vishwanathan, S. V. N. (2008). Introduction to Machine Learning. Published by the press syndicate of the University of Cambridge 2008. ISBN: 0-521-82583-0. www.kth.se/social/upload/53a14887f276540ebc81ae c3/online.pdf, Retrieved from alex.smola.org/drafts/thebook.pdf
Song, J., Gelin, J. C., Barrière, T., Liu, B., 2006. Experiments and numerical modelling of solid state sintering for 316L stainless steel components. J. Mater. Process. Technol., Proceedings of the 11th International Conference on Metal Forming 2006 177, 352-355. doi.org/10.1016/j.jmatprotec.2006.04.111
Soofi, Aized Amin, and Arshad Awan. “Classification techniques in machine learning: applications and issues.” J. Basic Appl. Sci 13, no. 1 (2017): 459-465.
Srivastava, N., G. E. Hinton, A. Krizhevsky, I. Sutskever, R. Salakhutdinov, Dropout: a simple way to prevent neural networks from overfitting. Journal of Machine Learning Research 15 (1), 1929-1958 (2014)
Stainless Steel-Grade 316L-Properties, Fabrication and Applications (UNS S31603), 2004. AZoM.com.www.azom.com/article.aspx?ArticleID=2382
Stainless Steel-Grade 316L (UNS S31603), 2004. AZoM.com.www.azom.com/article.aspx?ArticleID=2382
Sun, Z., Tan, X., Tor, S. B., Yeong, W. Y., 2016. Selective laser melting of stainless steel 316L with low porosity and high build rates. Mater. Des. 104, 197-204. doi.org/10.1016/j.matdes.2016.05.035
Swift, D. L., 1966. The thermal conductivity of spherical metal powders including the effect of an oxide coating. Int. J. Heat Mass Transf. 9, 1061-1074. doi.org/10.1016/0017-9310 (66) 90028-7
Taiwo, O. A. (2010). Types of Machine Learning Algorithms, New Advances in Machine Learning, Yagang Zhang (Ed.), ISBN: 978-953-307-034-6, InTech, University of Portsmouth United Kingdom. Pp 3-31. www.intechopen.com/books/new-advances-in-machine-learning/types-of-machine-learning-algorithms
Tan, Haoyuan. “Machine learning algorithm for classification.” In Journal of Physics: Conference Series, vol. 1994, no. 1, p. 012016. IOP Publishing, 2021.
Tang, M., Pistorius, P. C., 2017. Oxides, porosity and fatigue performance of AlSi10Mg parts produced by selective laser melting. Int. J. Fatigue, Fatigue and Fracture Behavior of Additive Manufactured Parts 94, 192-201. doi.org/10.1016/j.ijfatigue.2016.06.002
Tapas Kanungo, D. M. (2002). A local search approximation algorithm for k-means clustering. Proceedings of the eighteenth annual symposium on Computational geometry. Barcelona, Spain: ACM Press.
The Role of Stainless Steels Industrial Heat Exchangers, Nickel Inst. www.nickelinstitute.org/media/1783/roleofstainlesssteelsinindustrialheatexchangers_9005_.pdf
Timothy Jason Shepard, P. J. (1998). Decision Fusion Using a Multi-Linear Classifier. In Proceedings of the International Conference on Multisource-Multisensor Information Fusion.
Toeppel, T., Schumann, P., Ebert, M.-C., Bokkes, T., Funke, K., Werner, M., Zeulner, F., Bechmann, D. F., Herzog, F., 2016. 3D Analysis In Laser Beam Melting Based On Real-Time Process Monitoring. Presented at the Materials Science Technology Conference, pp. 123-132.
Tooling: How to Select the Right Tool Steel for Mold Cavities, www.ptonline.com/columns/tooling-how-to-select-the-right-tool-steel-for-mold-cavities
Uvo, C. B., Fourier and Wavelets Transforms.
Vapnik, V. N. (1995). The Nature of Statistical Learning Theory. (2nd ed.). Springer Verlag. Pp. 1-20. www.andrew.cmu.edu/user/kk3n/simplicity/vapnik2 000.pdf
Vilaro, T., Colin, C., Bartout, J. D., 2011. As-Fabricated and Heat-Treated Microstructures of the Ti-6Al-4V Alloy Processed by Selective Laser Melting. Metall. Mater. Trans. A 42, 3190-3199. doi.org/10.1007/s11661-011-0731-y
Wang, D., Song, C., Yang, Y., Bai, Y., 2016. Investigation of crystal growth mechanism during selective laser melting and mechanical property characterization of 316L stainless steel parts. Mater. Des. 100, 291-299. doi.org/10.1016/j.matdes.2016.03.111
Wang, X. K., L. T. Yang, X. Xic, J. R. Jin, M. J. Deen, A cloud-edge computing framework for cyber-physical-social services. IEEE Communications Magazine 55 (11), 80-85 (2017)
Wang, X. K., Laurence T. Yang, H. G. Li, M. Lin, J. J. Han, Bernady O. Apduhan, NQA: a nested anti-collision algorithm for RFID systems. ACM Transactions on Embedded Computing Systems 18 (4) (2019). doi.org/10.1145/3330139
Wang, X. K., Laurence T. Yang, L. W. Kuang, X. G. Liu, Q. X. Zhang and M. Jamal Deen,
A tensor-based big-data-driven routing recommendation approach for heterogeneous networks, IEEE Network Magazine, 2019, 33 (1): 64-69.
Wang, X. K., Laurence T. Yang, Y. H. Wang, X. G. Liu, Q. X. Zhang, and M. Jamal Deen, A distributed tensor-train decomposition method for cyber-physical-social services, ACM Transactions on Cyber-Physical Systems, 3 (4), doi: doi.org/10.1145/3323926, 2019.
Wang, Y. M., Voisin, T., Mckeown, J. T., Ye, J., Calta, N. P., Li, Z., Zeng, Z., Zhang, Y., Chen, W., Rochling, T. T., Ott, R. T., Santala, M. K., Depond, P. J., Matthews, M. J., Hamza, A. V., Zhu, T., 2017. Additively manufactured hierarchical stainless steels with high strength and ductility. Nat. Mater. 17, 63-71. doi.org/10.1038/nmat5021
Wang, Yingfan, Haiyang Huang, Cynthia Rudin, and Yaron Shaposhnik. “Understanding how dimension reduction tools work: an empirical approach to deciphering t-SNE, UMAP, TriMAP, and PaCMAP for data visualization.” Journal of Machine Learning Research 22, no. 201 (2021): 1-73.
Wang, Z., W. Yan and T. Oates. Time series classification from scratch with deep neural networks: a strong baseline. International Joint Conference on Neural Networks (IJCNN). 2017, 1578-1585.
Wazwaz, A.-M., Mchanna, M. S., 2010. The Combined Laplace-Adomian Method for Handling Singular Integral Equation of Heat Transfer 5.
Wei, L. C., Ehrlich, L. E., Powell-Palm, M. J., Montgomery, C., Beuth, J., Malen, J. A., 2018. Thermal conductivity of metal powders for powder bed additive manufacturing. Addit. Manuf. 21, 201-208. doi.org/10.1016/j.addma.2018.02.002
Weiss, Sholom M., and Ioannis Kapouleas. “An empirical comparison of pattern recognition, neural nets, and machine learning classification methods.” In IJCAI, vol. 89, pp. 781-787. 1989.
Willcocks, Simon Robert. “Constrainting Subglacial Heat Flux in Antarctica from Thermal Conductivity and Subglacial Lakes.” PhD diss., 2023.
Witten, I. H. & Frank, E. (2005). Data Mining: Practical machine learning tools and techniques (2nd ed.), ISBN: 0-12-088407-0, ftp://93.63.40.27/pub/manuela.sbarra/Data Mining Practical Machine Learning Tools and Techniques-WEKA.pdf
Xu, X. L., C. X. He, Z. Y. Xu, L. Y. Qi, S. H. Wan, MZA Bhuiyan. Joint optimization of offloading utility and privacy for edge computing enabled IoT. IEEE Internet of Things Journal, 2019, Doi: 10.1109/JIOT.2019.2944007.
Xu, X. L., R. C. Mo, F. Dai, W. M. Lin, S. H. Wan, W. C. Dou, Dynamic resource provisioning with fault tolerance for data-intensive meteorological workflows in cloud. IEEE Transactions on Industrial Informatics (2019). doi.org/10.1109/TII.2019.2959258
Xu, X. L., S. C. Fu, W. M. Li, F. Dai, H. H. Gao, V. Chang, Multi-objective data placement for workflow management in cloud infrastructure using NSGA-II. IEEE Transactions on Emerging Topics in Computational Intelligence (2019)
Xu, X. L., X. H. Liu, Z. Y. Xu, C. J. Wang, S. H. Wan, X. X. Yang, Joint optimization of resource utilization and load balance with privacy preservation for edge services in 5G networks. Mobile Networks and Applications (2019). doi.org/10.1007/s11036-019-01448-8
Xu, Y. W., L. Y. Qi, W. C. Dou, J. G. Yu. Privacy-preserving and scalable service recommendation based on SimHash in a distributed cloud environment. Complexity, Volume 2017, Article ID 3437854, 9 pages, 2017.
Yang, Xin, Haoying Fu, Hongyuan Zha, and Jesse Barlow. “Semi-supervised nonlinear dimensionality reduction.” In Proceedings of the 23rd international conference on Machine learning, pp. 1065-1072. 2006.
Yap, C. Y., Chua, C. K., Dong, Z. L., Liu, Z. H., Zhang, D. Q., Loh, L. E., Sing, S. L., 2015. Review of selective laser melting: Materials and applications. Appl. Phys. Rev. 2, 041101. doi.org/10.1063/1.4935926
Zheng, Y., Q. Liu, E. Chen, Y. Ge, J. L. Zhao, Exploiting multi-channels deep convolutional neural networks for multivariate time series classification. Frontiers of Computer Science 10 (1), 96-112 (2016)
U.S. Pat. Nos. 4,947,040; 5,097,357; 5,128,541; 5,241,965; 5,456,870; 5,644,513; 5,667,300; 5,667,300; 5,748,317; 5,748,318; 5,750,272; 5,774,223; 5,959,735; 5,963,658; 5,983,121; 6,025,918; 6,104,946; 6,175,416; 6,208,418; 6,208,421; 6,233,470; 6,236,871; 6,240,305; 6,271,921; 6,335,792; 6,343,874; 6,373,071; 6,400,449; 6,453,183; 6,567,165; 6,704,110; 6,720,565; 6,734,960; 6,798,537; 6,812,047; 6,812,717; 6,847,737; 6,885,458; 6,906,801; 6,910,060; 6,911,349; 6,940,592; 6,958,814; 6,963,393; 6,971,791; 6,975,401; 7,026,175; 7,045,786; 7,064,822; 7,088,444; 7,098,052; 7,130,055; 7,141,440; 7,260,248; 7,272,265; 7,301,619; 7,379,185; 7,427,269; 7,465,591; 7,502,690; 7,515,763; 7,570,832; 7,646,486; 7,652,764; 7,715,984; 7,755,828; 7,787,688; 7,837,623; 7,885,454; 7,912,648; 7,941,273; 8,031,838; 8,041,008; 8,047,714; 8,083,406; 8,111,809; 8,116,429; 8,130,904; 8,143,897; 8,178,153; 8,217,258; 8,222,510; 8,244,029; 8,249,218; 8,254,524; 8,264,693; 8,274,288; 8,280,488; 8,299,416; 8,300,227; 8,314,406; 8,362,431; 8,404,336; 8,408,786; 8,446,472; 8,481,345; 8,508,370; 8,536,444; 8,541,058; 8,797,052; 8,817,260; 8,861,821; 8,871,463; 9,116,302; 9,171,970; 9,204,862; 9,255,347; 9,269,880; 9,411,002; 9,466, 113; 9,477,161; 9,563,950; 9,714,900; 9,722,533; 9,739,663; 9,746,435; 9,765,934; 9,825,229; 9,882,526; 9,927,350; 9,933,376; 9,950,406; 10,072,983; 10,088,418; 10,214,833; 20010038454; 20020011852; 20020018510; 20020148978; 20030041084; 20030078503; 20030144585; 20040071363; 20040183019; 20040193670; 20050053305; 20050270903; 20050276504; 20050277824; 20060100666; 20060114965; 20060203613; 20070055175; 20070149891; 20070230135; 20070239036; 20070248785; 20080065332; 20080125643; 20080208061; 20080226890; 20080278794; 20080292840; 20090084959; 20090138202; 20090184259; 20090204330; 20090212769; 20090245322; 20090297017; 20100051079; 20100078576; 20100187304; 20100189219; 20100189224; 20100191091; 20100191092; 20100191093; 20100191094; 20100191105; 20100191107; 20100201367; 20100219327; 20100232017; 20100286525; 20100315088; 20100315646; 20110007166; 20110020539; 20120025101; 20120327420; 20130012819; 20130110485; 20130295288; 20140018649; 20140039320; 20140093490; 20140231696; 20150063410; 20150109617; 20150110150; 20150119661; 20150144588; 20150178970; 20150241798; 20150316496; 20160133843; 20160178583; 20160178680; 20160235304; 20160300352; 20170173757; 20170219489; 20170271235; 20170279024; 20170291817; 20170322084; 20180156674; 20180219519; 20190033135; and 20190094166;

Additive manufacturing is well known. See the following U.S. patents and published patent applications: U.S. Pat. Nos. 4,748,085; 4,863,538; 4,938,816; 4,944,817; 5,053,090; 5,076,869; 5,132,143; 5,147,587; 5,155,321; 5,155,324; 5,156,697; 5,182,170; 5,207,371; 5,281,789; 5,296,062; 5,304,329; 5,316,580; 5,382,308; 5,431,967; 5,433,280; 5,544,550; 5,597,589; 5,616,294; 5,622,577; 5,639,070; 5,730,925; 5,957,006; 6,046,426; 6,085,122; 6,143,378; 6,144,008; 6,202,734; 6,215,093; 6,261,493; 6,341,952; 6,391,251; 6,397,922; 6,454,811; 6,459,069; 6,476,343; 6,583,379; 6,596,224; 6,629,559; 6,676,892; 6,730,252; 6,756,561; 6,767,499; 6,811,744; 6,814,823; 6,830,643; 6,833,185; 6,925,346; 6,930,278; 6,995,334; 7,020,539; 7,034,246; 7,043,330; 7,045,738; 7,212,095; 7,305,367; 7,387,187; 7,521,652; 7,537,664; 7,686,995; 7,695,248; 7,705,264; 7,716,802; 7,777,155; 7,878,430; 7,887,316; 7,887,734; 7,968,026; 8,007,705; 8,017,055; 8,021,138; 8,071,007; 8,104,702; 8,124,245; 8,137,609; 8,173,258; 8,211,226; 8,236,418; 8,268,099; 8,268,100; 8,326,024; 8,359,744; 8,372,330; 8,375,581; 8,383,985; 8,387,229; 8,394,168; 8,457,930; 8,479,393; 8,480,754; 8,488,994; 8,509,933; 8,513,562; 8,535,049; 8,546,717; 8,556,981; 8,556,983; 8,575,513; 8,598,523; 8,606,540; 8,610,761; 8,617,661; 8,623,026; 8,642,965; 8,666,142; 8,671,726; 8,678,802; 8,685,520; 8,690,472; 8,691,333; 8,718,522; 8,728,387; 8,728,807; 8,729,371; 8,735,773; 8,740,598; 8,746,013; 8,753,105; 8,775,133; 8,790,858; 8,801,418; 8,809,780; 8,821,060; 8,822,875; 8,826,511; 8,828,311; 8,844,877; 8,871,132; 8,875,976; 8,879,957; 8,906,107; 8,915,728; 8,916,085; 8,926,706; 8,931,171; 8,931,880; 8,952,678; 8,974,539; 8,985,497; 8,986,234; 8,992,703; 9,020,788; 9,023,566; 9,029,058; 9,034,048; 9,061,465; 9,073,150; 9,073,260; 9,073,261; 9,073,262; 9,075,409; 9,079,248; 9,079,355; 9,079,386; 9,090,428; 9,102,099; 9,107,725; 9,112,272; 9,114,478; 9,114,567; 9,120,270; 9,126,365; 9,126,367; 9,133,429; 9,141,015; 9,144,940; 9,144,961; 9,149,952; 9,149,988; 9,156,205; 9,156,240; 9,157,465; 9,157,735; 9,168,697; 9,180,010; 9,186,270; 9,186,846; 9,186,848; 9,192,990; 9,192,999; 9,196,760; 9,199,044; 9,199,345; 9,204,945; 9,205,204; 9,211,669; 9,221,100; 9,222,932; 9,227,339; 9,227,365; 9,228,859; 9,233,506; 9,248,611; 9,254,535; 9,269,520; 9,278,483; 9,279,328; 9,283,593; 9,296,039; 9,296,129; 9,302,338; 9,308,583; 9,308,691; 9,310,188; 9,315,043; 9,320,620; 9,326,780; 9,327,056; 9,327,350; 9,327,447; 9,327,452; 9,327,453; 9,332,251; 9,341,467; 9,346,116; 9,346,127; 9,347,770; 9,352,421; 9,358,350; 9,364,888; 9,369,259; 9,370,896; 9,375,298; 9,375,782; 9,386,993; 9,387,079; 9,390,312; 9,399,256; 9,399,264; 9,399,321; 9,403,235; 9,406,483; 9,414,501; 9,415,438; 9,419,502; 9,421,715; 9,423,756; 9,439,767; 9,440,397; 9,442,105; 9,442,395; 9,446,475; 9,452,474; 9,452,489; 9,453,142; 9,456,777; 9,456,901; 9,457,428; 9,457,521; 9,460,557; 9,463,506; 9,481,931; 9,482,103; 9,482,974; 9,486,878; 9,486,944; 9,486,964; 9,499,779; 9,507,061; 9,507,274; 9,508,667; 9,511,543; 9,511,547; 9,512,544; 9,517,134; 9,523,934; 9,527,165; 9,527,240; 9,527,242; 9,527,244; 9,527,246; 9,528,705; 9,528,902; 9,533,350; 9,533,372; 9,533,450; 9,533,485; 9,533,526; 9,536,806; 9,539,064; 9,543,116; 9,545,669; 9,555,475; 9,555,612; 9,556,415; 9,557,331; 9,557,661; 9,561,622; 9,561,623; 9,566,758; 9,570,789; 9,573,193; 9,573,224; 9,573,225; 9,578,695; 9,579,718; 9,579,829; 9,579,851; 9,583,856; 9,586,285; 9,586,290; 9,586,298; 9,586,364; 9,587,317; 9,592,530; 9,596,993; 9,598,606; 9,603,711; 9,604,280; 9,611,355; 9,617,865; 9,623,512; 9,625,156; 9,626,608; 9,636,229; 9,636,769; 9,636,770; 9,636,775; 9,636,868; 9,642,727; 9,643,281; 9,643,361; 9,649,690; 9,656,429; 9,662,840; 9,664,504; 9,664,505; 9,669,583; 9,676,145; 9,676,159; 9,676,963; 9,682,166; 9,688,028; 9,690,286; 9,694,423; 9,694,545; 9,696,142; 9,707,717; 9,708,440; 9,713,843; 9,714,318; 9,715,563; 9,718,127; 9,720,363; 9,721,384; 9,721,755; 9,731,377; 9,732,239; 9,737,934; 9,744,722; 9,744,730; 9,751,610; 9,757,802; 9,764,418; 9,764,515; 9,765,727; 9,770,758; 9,770,760; 9,770,866; 9,771,400; 9,771,629; 9,772,621; 9,775,680; 9,776,243; 9,776,282; 9,776,376; 9,777,385; 9,782,932; 9,782,935; 9,783,718; 9,783,885; 9,785,064; 9,788,600; 9,795,541; 9,796,048; 9,802,253; 9,808,991; 9,815,118; 9,815,139; 9,815,268; 9,821,399; 9,821,411; 9,821,546; 9,822,045; 9,827,754; 9,828,679; 9,833,839; 9,833,949; 9,833,987; 9,836,883; 9,838,018; 9,839,977; 9,849,510; 9,849,543; 9,850,172; 9,855,369; 9,855,625; 9,855,698; 9,861,452; 9,862,146; 9,868,255; 9,869,734; 9,873,180; 9,873,228; 9,873,281; 9,873,761; 9,877,790; 9,877,805; 9,878,497; 9,882,111; 9,885,987; 9,890,091; 9,896,944; 9,897,513; 9,902,112; 9,902,588; 9,903,214; 9,903,574; 9,904,223; 9,915,583; 9,919,111; 9,919,112; 9,919,273; 9,919,360; 9,919,361; 9,919,479; 9,920,433; 9,922,759; 9,925,714; 9,925,724; 9,926,427; 9,931,695; 9,931,697; 9,931,814; 9,932,841; 9,933,718; 9,937,580; 9,943,981; 9,944,021; 9,945,032; 9,950,367; 9,950,465; 9,953,899; 9,956,047; 9,956,048; 9,956,107; 9,956,612; 9,956,725; 9,956,727; 9,959,613; 9,962,767; 9,969,000; 9,969,153; 9,969,930; 9,970,824; 9,975,179; 9,975,199; 9,975,296; 9,975,323; 9,981,425; 9,982,164; 9,982,684; 9,987,798; 9,987,804; 9,988,720; 9,993,976; 9,993,982; 9,994,339; 9,996,981; 9,999,920; 10,000,023; 10,005,227; 10,005,228; 10,005,230; 10,005,237; 10,011,076; 10,011,089; 10,011,352; 10,016,262; 10,0166,61; 10,016,942; 10,018,937; 10,022,614; 10,023,739; 10,029,422; 10,029,424; 10,029,461; 10,035,306; 10,035,920; 10,039,195; 10,040,239; 10,040,240; 10,040,250; 10,040,252; 10,040,810; 10,045,835; 10,046,494; 10,046,521; 10,046,524; 10,052,159; 10,052,691; 10,054,530; 10,058,920; 10,059,053; 10,059,057; 10,059,092; 10,059,595; 10,060,217; 10,061,221; 10,064,745; 10,065,270; 10,065,367; 10,065,371; 10,068,863; 10,071,422; 10,076,875; 10,076,876; 10,081,129; 10,086,564; 10,087,556; 10,089,413; 10,091,891; 10,093,039; 10,096,537; 10,099,309; 10,099,427; 10,105,902; 10,105,906; 10,112,345; 10,112,379; 10,118,054; 10,118,337; 10,123,807; 10,124,408; 10,124,410; 10,124,532; 10,124,539; 10,131,088; 10,131,131; 10,132,578; 10,135,109; 10,136,689; 10,137,634; 10,137,636; 10,137,642; 10,144,178; 10,144,205; 10,144,828; 10,144,840; 10,145,271; 10,149,505; 10,150,258; 10,151,049; 10,151,377; 10,153,608; 10,155,882; 10,156,185; 10,157,503; 10,160,061; 10,160,193; 10,172,400; 10,173,945; 10,174,205; 10,174,276; 10,179,640; 10,182,869; 10,183,330; 10,183,443; 10,183,477; 10,189,057; 10,189,114; 10,189,204; 10,189,210; 10,189,239; 10,190,244; 10,190,955; 10,195,629; 10,195,693; 10,200,834; 10,201,409; 10,201,931; 10,450,414; 10,456,205; 10,488,852; 10,688,716; 10,843,268; 11,026,768; 11,084,099; 11,123,798; 11,273,491; 11,406,398; 11,426,927; 11,577,317; 11,590,568; 11,733,677; 11,919,077; 11,919,079; 11,923,131; 11,944,336; 11,945,166; 62/452,811; 62/764,311; 63/057,691; 64/848,421; 98/215,431; U.S. Pat. Nos. 10,096,5371; 11,890,8071; 20010008230; 20010008317; 20020015654; 20030037989; 20030114936; 20030116542; 20030206820; 20040009340; 20040056022; 20040099996; 20040102539; 20040106691; 20040133298; 20040191106; 20050027050; 20050133527; 20050174208; 20060032838; 20060071359; 20060081571; 20060118532; 20060147332; 20060163774; 20060166159; 20060185473; 20060214335; 20070026102; 20070134096; 20070141375; 20070142914; 20070151087; 20070183918; 20070203584; 20070232753; 20080008894; 20080052904; 20080116118; 20080153947; 20080201008; 20080210413; 20080213718; 20080221225; 20080268400; 20080300353; 20080317951; 20090078864; 20090095629; 20090169664; 20090169841; 20090206065; 20090283109; 20090283119; 20090283501; 20090286008; 20100010638; 20100068464; 20100125356; 20100143601; 20100155985; 20100168890; 20100175853; 20100221567; 20100230850; 20100230859; 20100242843; 20100255327; 20100262054; 20100262272; 20100291286; 20100291401; 20100305742; 20100320649; 20110014081; 20110016939; 20110029093; 20110047799; 20110052927; 20110061591; 20110087332; 20110089610; 20110114839; 20110121113; 20110136162; 20110162506; 20110166824; 20110169924; 20110259862; 20110285061; 20110291331; 20110293840; 20110295378; 20110297081; 20120041446; 20120065755; 20120090156; 20120100031; 20120132627; 20120132631; 20120138586; 20120156323; 20120191205; 20120191420; 20120193063; 20120193335; 20120195994; 20120201960; 20120205348; 20120209394; 20120219698; 20120232669; 20120232670; 20120232671; 20120237631; 20120243823; 20120255176; 20120279441; 20120289894; 20120298873; 20120298886; 20130001834; 20130004680; 20130008879; 20130031753; 20130045093; 20130056912; 20130064706; 20130079693; 20130085500; 20130101423; 20130101729; 20130101761; 20130108460; 20130112672; 20130134637; 20130136868; 20130140741; 20130147092; 20130166256; 20130168902; 20130172898; 20130186265; 20130186514; 20130193620; 20130196118; 20130197683; 20130199013; 20130209932; 20130211531; 20130233846; 20130234355; 20130263977; 20130268085; 20130270750; 20130280091; 20130290220; 20130291385; 20130295212; 20130344258; 20140014629; 20140021171; 20140034626; 20140035205; 20140035423; 20140035995; 20140037873; 20140039451; 20140039452; 20140039631; 20140039658; 20140050921; 20140052288; 20140061165; 20140061167; 20140061977; 20140079741; 20140086780; 20140087210; 20140095107; 20140099476; 20140104133; 20140109440; 20140113021; 20140120195; 20140136154; 20140140882; 20140145522; 20140154088; 20140163445; 20140163568; 20140172111; 20140174344; 20140182170; 20140184757; 20140186205; 20140189989; 20140190942; 20140194996; 20140212677; 20140216123; 20140217647; 20140222184; 20140228860; 20140231266; 20140246809; 20140249643; 20140252668; 20140252687; 20140263209; 20140265040; 20140265046; 20140265047; 20140265048; 20140265049; 20140271328; 20140271965; 20140276856; 20140286048; 20140291886; 20140294567; 20140295087; 20140299706; 20140306380; 20140314581; 20140319735; 20140319736; 20140319737; 20140319738; 20140322374; 20140328964; 20140336680; 20140361460; 20140363585; 20140368804; 20140370111; 20140370323; 20150001093; 20150017475; 20150021379; 20150021815; 20150024169; 20150024309; 20150024319; 20150027948; 20150029485; 20150030494; 20150032215; 20150034604; 20150037601; 20150041025; 20150044415; 20150045924; 20150045928; 20150048209; 20150050463; 20150052872; 20150054193; 20150054930; 20150054944; 20150054945; 20150060422; 20150064050; 20150069668; 20150080495; 20150089881; 20150090074; 20150093283; 20150100149; 20150102531; 20150104344; 20150104345; 20150108677; 20150113993; 20150125333; 20150125335; 20150129583; 20150130754; 20150132173; 20150135897; 20150136908; 20150137400; 20150139849; 20150140230; 20150141234; 20150145174; 20150145177; 20150147585; 20150158111; 20150161299; 20150165525; 20150165545; 20150165556; 20150165690; 20150167130; 20150174827; 20150183070; 20150184540; 20150196971; 20150197064; 20150197862; 20150198052; 20150202687; 20150202716; 20150202717; 20150209162; 20150209889; 20150210013; 20150217367; 20150219133; 20150219444; 20150219521; 20150224607; 20150224710; 20150224718; 20150227062; 20150227070; 20150231796; 20150231825; 20150231828; 20150231831; 20150236428; 20150239046; 20150246482; 20150246486; 20150247474; 20150251247; 20150251250; 20150251351; 20150251353; 20150252190; 20150258735; 20150259530; 20150259790; 20150266157; 20150266158; 20150266211; 20150266237; 20150266244; 20150266285; 20150270088; 20150270089; 20150273582; 20150273586; 20150273622; 20150273631; 20150275916; 20150283613; 20150283614; 20150283642; 20150283646; 20150283649; 20150285502; 20150285504; 20150290707; 20150290711; 20150290741; 20150290875; 20150300179; 20150305198; 20150306664; 20150306665; 20150306667; 20150306699; 20150306700; 20150314389; 20150320158; 20150321250; 20150321289; 20150322808; 20150328713; 20150328719; 20150336171; 20150343564; 20150343673; 20150351493; 20150352668; 20150352770; 20150360372; 20150367415; 20150367416; 20150367417; 20150367418; 20150367419; 20150367446; 20150367447; 20150367448; 20150367453; 20150367575; 20150367577; 20150371279; 20150374915; 20150374929; 20150374930; 20150375336; 20150375340; 20150376248; 20160001364; 20160001365; 20160001401; 20160001509; 20160008887; 20160008889; 20160008922; 20160009027; 20160009028; 20160009029; 20160009030; 20160009039; 20160010457; 20160010469; 20160014906; 20160022383; 20160023272; 20160023307; 20160024293; 20160030105; 20160031010; 20160032416; 20160038633; 20160039054; 20160039851; 20160045841; 20160045967; 20160045981; 20160047255; 20160052056; 20160052057; 20160052079; 20160052087; 20160052176; 20160052208; 20160054115; 20160054121; 20160054347; 20160059154; 20160059302; 20160059315; 20160059352; 20160059437; 20160061044; 20160061381; 20160066930; 20160067766; 20160067778; 20160067779; 20160067780; 20160067781; 20160067820; 20160067928; 20160069622; 20160070254; 20160074558; 20160074938; 20160074965; 20160075089; 20160082547; 20160082550; 20160082657; 20160082658; 20160082695; 20160083516; 20160089719; 20160089859; 20160090848; 20160096326; 20160098495; 20160101643; 20160107232; 20160107261; 20160107287; 20160107290; 20160107295; 20160114431; 20160114432; 20160114458; 20160115083; 20160120040; 20160121399; 20160121430; 20160122541; 20160129503; 20160129643; 20160131564; 20160135537; 20160136759; 20160136787; 20160136885; 20160136887; 20160136889; 20160136897; 20160137838; 20160137839; 20160143744; 20160144428; 20160144430; 20160144566; 20160145722; 20160146153; 20160151859; 20160151860; 20160151861; 20160157963; 20160158843; 20160158889; 20160160077; 20160166284; 20160167160; 20160167299; 20160167303; 20160167312; 20160168453; 20160168715; 20160172655; 20160175787; 20160175929; 20160175932; 20160175934; 20160175935; 20160181217; 20160184891; 20160184925; 20160184931; 20160186620; 20160187166; 20160193695; 20160193696; 20160193697; 20160193790; 20160199933; 20160200044; 20160200045; 20160200046; 20160200047; 20160201155; 20160202042; 20160202043; 20160202101; 20160207109; 20160207112; 20160211116; 20160211119; 20160214173; 20160214211; 20160221114; 20160221115; 20160221122; 20160221262; 20160222807; 20160223041; 20160228255; 20160228929; 20160228975; 20160228987; 20160228990; 20160228991; 20160228992; 20160229005; 20160235929; 20160236299; 20160237827; 20160242853; 20160242931; 20160243620; 20160243622; 20160243644; 20160243649; 20160243652; 20160244625; 20160244980; 20160247665; 20160250688; 20160250711; 20160250715; 20160250717; 20160250724; 20160256925; 20160260261; 20160263704; 20160265362; 20160265366; 20160265776; 20160271732; 20160271870; 20160271875; 20160271877; 20160271878; 20160271879; 20160271884; 20160273074; 20160273079; 20160273368; 20160273369; 20160273687; 20160276056; 20160278793; 20160279703; 20160279706; 20160279707; 20160279708; 20160279734; 20160279735; 20160282848; 20160287868; 20160288200; 20160288209; 20160288244; 20160288254; 20160288264; 20160288265; 20160288266; 20160288414; 20160297006; 20160297007; 20160297104; 20160297141; 20160297148; 20160298218; 20160298220; 20160298268; 20160303656; 20160303687; 20160303762; 20160303798; 20160304677; 20160305256; 20160305271; 20160307678; 20160307731; 20160310077; 20160310236; 20160310279; 20160310282; 20160311020; 20160311022; 20160311160; 20160311162; 20160311165; 20160311230; 20160312338; 20160312653; 20160313306; 20160317312; 20160318072; 20160318128; 20160318129; 20160318130; 20160318253; 20160319677; 20160319678; 20160321384; 20160324581; 20160325355; 20160325358; 20160325378; 20160325383; 20160325492; 20160325498; 20160325541; 20160326338; 20160326613; 20160326880; 20160332229; 20160332250; 20160332253; 20160332259; 20160332266; 20160332366; 20160332371; 20160332376; 20160332379; 20160332380; 20160332384; 20160339516; 20160339518; 20160339520; 20160339521; 20160339536; 20160339542; 20160339639; 20160339642; 20160339646; 20160346998; 20160348203; 20160348517; 20160354064; 20160354839; 20160354842; 20160354843; 20160355904; 20160358795; 20160361765; 20160361872; 20160361873; 20160367264; 20160368050; 20160368055; 20160368056; 20160368057; 20160368213; 20160369040; 20160369096; 20160374431; 20160375676; 20160376453; 20160376674; 20160377994; 20160378004; 20160380634; 20170001253; 20170001258; 20170001263; 20170001374; 20170001377; 20170001379; 20170002978; 20170007359; 20170007360; 20170007362; 20170007363; 20170007366; 20170007367; 20170007386; 20170008080; 20170008084; 20170008085; 20170008086; 20170008123; 20170008126; 20170008236; 20170008333; 20170009584; 20170014169; 20170014235; 20170014903; 20170014909; 20170014937; 20170014950; 20170015452; 20170016093; 20170016094; 20170016781; 20170021420; 20170021452; 20170021453; 20170021454; 20170021455; 20170021456; 20170021562; 20170021565; 20170021572; 20170027624; 20170028468; 20170028472; 20170028475; 20170028589; 20170028622; 20170028631; 20170028651; 20170028703; 20170030399; 20170031639; 20170033068; 20170036238; 20170036272; 20170036300; 20170036404; 20170036783; 20170037674; 20170037867; 20170038047; 20170043395; 20170043402; 20170044416; 20170050198; 20170050241; 20170050242; 20170050254; 20170050261; 20170050268; 20170050270; 20170050271; 20170050384; 20170051386; 20170051613; 20170051675; 20170056179; 20170057013; 20170059529; 20170066051; 20170066052; 20170066187; 20170067154; 20170067344; 20170067788; 20170068774; 20170069817; 20170072465; 20170072466; 20170072467; 20170072468; 20170072635; 20170074285; 20170080641; 20170087635; 20170087661; 20170087666; 20170087670; 20170087765; 20170087771; 20170088918; 20170092400; 20170092565; 20170095858; 20170095882; 20170095888; 20170100209; 20170100210; 20170100214; 20170100215; 20170100817; 20170100888; 20170100891; 20170100893; 20170100899; 20170101707; 20170106432; 20170106438; 20170106443; 20170106444; 20170106445; 20170106446; 20170106474; 20170106477; 20170106570; 20170106593; 20170107385; 20170107764; 20170107821; 20170113303; 20170113416; 20170114233; 20170115594; 20170119531; 20170120326; 20170120332; 20170120333; 20170120334; 20170120335; 20170120336; 20170120337; 20170120359; 20170120370; 20170120376; 20170120377; 20170120385; 20170120386; 20170120387; 20170120393; 20170120416; 20170120518; 20170120519; 20170120529; 20170120530; 20170120536; 20170120537; 20170120538; 20170122322; 20170123222; 20170123237; 20170125908; 20170125909; 20170125910; 20170126087; 20170128174; 20170128961; 20170129049; 20170129052; 20170129060; 20170129168; 20170129180; 20170129184; 20170129185; 20170130591; 20170130599; 20170136540; 20170136541; 20170136542; 20170136543; 20170136545; 20170136574; 20170136578; 20170136603; 20170136699; 20170136708; 20170137327; 20170143315; 20170144219; 20170144223; 20170144224; 20170144248; 20170144250; 20170144254; 20170145578; 20170145584; 20170145586; 20170151631; 20170151718; 20170151719; 20170154713; 20170155309; 20170157841; 20170157850; 20170158816; 20170159447; 20170164700; 20170165532; 20170165751; 20170165752; 20170165753; 20170165754; 20170165781; 20170165790; 20170165791; 20170165792; 20170165916; 20170167000; 20170167269; 20170167270; 20170167274; 20170173225; 20170173628; 20170173681; 20170173683; 20170173688; 20170173691; 20170173692; 20170173693; 20170173694; 20170173695; 20170173696; 20170173697; 20170173735; 20170173736; 20170173737; 20170173747; 20170173868; 20170173872; 20170173874; 20170173877; 20170173878; 20170173879; 20170173883; 20170173892; 20170175756; 20170176978; 20170181291; 20170182556; 20170182558; 20170182560; 20170182594; 20170182596; 20170182598; 20170183497; 20170183870; 20170186143; 20170189553; 20170189961; 20170189962; 20170189963; 20170189964; 20170189965; 20170190112; 20170191177; 20170197246; 20170197278; 20170197330; 20170197359; 20170203355; 20170203363; 20170203364; 20170203365; 20170203387; 20170203391; 20170203406; 20170203408; 20170203517; 20170209908; 20170209923; 20170209927; 20170209929; 20170209931; 20170209954; 20170209958; 20170209963; 20170210070; 20170210144; 20170211331; 20170216916; 20170216921; 20170216966; 20170217093; 20170217095; 20170217105; 20170217181; 20170218228; 20170219855; 20170220030; 20170220031; 20170225227; 20170225228; 20170225229; 20170225393; 20170225394; 20170225398; 20170226362; 20170231783; 20170232511; 20170232513; 20170232514; 20170232515; 20170232518; 20170232519; 20170232549; 20170232552; 20170232557; 20170232637; 20170232674; 20170233574; 20170234138; 20170239718; 20170239719; 20170239720; 20170239721; 20170239722; 20170239723; 20170239724; 20170239725; 20170239752; 20170239887; 20170239891; 20170239892; 20170241830; 20170242424; 20170246682; 20170246689; 20170246709; 20170246804; 20170247785; 20170248319; 20170249440; 20170252787; 20170252806; 20170252812; 20170252813; 20170252814; 20170252815; 20170252816; 20170252817; 20170252818; 20170252819; 20170252820; 20170252846; 20170252851; 20170252854; 20170252860; 20170252967; 20170252978; 20170259339; 20170259502; 20170260865; 20170266357; 20170266759; 20170266879; 20170271837; 20170274454; 20170274456; 20170276023; 20170282246; 20170282247; 20170282296; 20170282297; 20170282455; 20170282457; 20170284676; 20170291077; 20170291260; 20170291261; 20170291263; 20170291362; 20170292174; 20170292195; 20170294288; 20170294291; 20170296625; 20170297097; 20170297098; 20170297099; 20170297100; 20170297101; 20170297102; 20170297103; 20170297104; 20170297106; 20170297108; 20170297109; 20170297111; 20170297267; 20170297275; 20170297674; 20170299181; 20170299973; 20170304894; 20170304895; 20170304896; 20170304897; 20170304900; 20170304944; 20170304945; 20170304946; 20170304947; 20170306221; 20170306447; 20170306448; 20170306449; 20170306450; 20170306457; 20170306458; 20170306459; 20170306460; 20170306766; 20170307859; 20170312821; 20170312822; 20170312826; 20170312857; 20170312858; 20170312984; 20170312985; 20170314109; 20170314114; 20170315538; 20170320162; 20170320168; 20170320264; 20170320277; 20170322487; 20170323627; 20170326668; 20170326681; 20170326690; 20170326788; 20170326797; 20170326803; 20170326805; 20170326816; 20170332733; 20170333994; 20170333995; 20170334023; 20170334024; 20170334133; 20170334136; 20170334725; 20170335436; 20170338392; 20170340266; 20170341141; 20170341142; 20170341146; 20170341175; 20170341182; 20170341183; 20170342303; 20170342535; 20170348458; 20170348792; 20170348906; 20170348909; 20170350259; 20170350597; 20170354805; 20170354806; 20170355135; 20170355138; 20170355146; 20170355147; 20170356068; 20170356341; 20170360534; 20170361405; 20170368603; 20170368640; 20170368647; 20170368740; 20170368816; 20170369650; 20180000501; 20180000502; 20180000503; 20180000571; 20180001423; 20180001424; 20180001547; 20180001553; 20180001556; 20180001557; 20180001567; 20180009007; 20180009054; 20180009064; 20180009134; 20180010001; 20180010221; 20180010237; 20180014844; 20180015542; 20180015564; 20180015565; 20180015566; 20180016916; 20180021473; 20180021877; 20180021878; 20180022022; 20180022065; 20180027615; 20180027616; 20180029124; 20180029125; 20180029241; 20180029294; 20180029295; 20180029306; 20180030234; 20180031028; 20180036939; 20180036945; 20180036953; 20180038167; 20180040529; 20180042718; 20180043437; 20180043455; 20180043467; 20180043629; 20180044523; 20180047700; 20180050390; 20180050423; 20180050490; 20180050493; 20180050495; 20180052087; 20180055641; 20180056389; 20180056390; 20180056391; 20180056392; 20180056396; 20180056446; 20180057142; 20180061279; 20180065144; 20180065178; 20180065181; 20180065182; 20180065186; 20180065208; 20180065209; 20180065295; 20180065298; 20180065300; 20180065304; 20180065305; 20180065306; 20180065307; 20180065308; 20180065309; 20180065316; 20180065317; 20180065318; 20180065320; 20180065322; 20180066358; 20180066603; 20180067464; 20180071819; 20180071821; 20180071825; 20180071949; 20180071986; 20180071988; 20180071989; 20180072040; 20180072630; 20180078936; 20180079003; 20180079029; 20180079033; 20180079034; 20180079125; 20180085605; 20180085826; 20180085856; 20180086004; 20180087157; 20180088462; 20180089824; 20180093325; 20180093347; 20180093418; 20180093419; 20180094953; 20180095450; 20180096175; 20180098919; 20180099331; 20180104770; 20180104892; 20180105903; 20180111191; 20180111193; 20180111194; 20180111195; 20180111196; 20180111197; 20180111198; 20180111219; 20180111317; 20180111318; 20180111319; 20180111334; 20180113445; 20180115072; 20180116762; 20180117674; 20180117675; 20180117713; 20180117845; 20180119300; 20180122541; 20180124341; 20180125365; 20180126460; 20180126461; 20180126462; 20180126487; 20180126637; 20180126638; 20180126639; 20180126640; 20180126641; 20180126642; 20180126648; 20180126649; 20180126650; 20180126655; 20180126666; 20180126720; 20180127317; 20180128803; 20180133583; 20180133801; 20180133804; 20180133839; 20180133840; 20180133956; 20180133958; 20180134027; 20180136458; 20180140392; 20180141119; 20180141123; 20180141126; 20180141127; 20180141159; 20180141160; 20180141162; 20180141174; 20180141235; 20180141267; 20180141274; 20180141305; 20180143147; 20180144934; 20180147627; 20180147628; 20180147653; 20180147654; 20180147655; 20180147669; 20180147779; 20180148378; 20180148379; 20180148380; 20180148585; 20180149039; 20180151048; 20180153205; 20180154437; 20180154438; 20180154439; 20180154440; 20180154441; 20180154442; 20180154443; 20180154444; 20180154484; 20180154574; 20180154580; 20180154591; 20180154657; 20180159016; 20180161873; 20180161874; 20180161875; 20180161932; 20180161934; 20180161935; 20180161954; 20180162013; 20180162044; 20180162047; 20180162048; 20180162053; 20180163311; 20180166251; 20180166665; 20180168254; 20180168294; 20180169351; 20180169756; 20180169760; 20180169784; 20180169950; 20180169951; 20180169952; 20180169960; 20180169970; 20180170107; 20180172369; 20180178284; 20180178285; 20180178286; 20180178287; 20180178288; 20180178292; 20180178325; 20180178326; 20180178413; 20180178491; 20180179332; 20180179956; 20180180803; 20180180812; 20180180813; 20180180874; 20180180896; 20180185098; 20180185893; 20180185921; 20180185961; 20180185965; 20180186067; 20180186078; 20180186080; 20180186081; 20180186082; 20180187509; 20180187569; 20180193916; 20180193923; 20180193953; 20180193954; 20180193955; 20180194065; 20180194080; 20180195186; 20180195395; 20180195684; 20180200790; 20180200791; 20180200792; 20180200793; 20180200794; 20180200796; 20180200797; 20180200798; 20180200800; 20180200836; 20180200960; 20180202076; 20180202293; 20180207725; 20180207749; 20180207750; 20180207850; 20180207862; 20180207863; 20180207865; 20180207866; 20180207868; 20180208762; 20180208785; 20180209381; 20180209498; 20180214874; 20180214946; 20180214947; 20180214950; 20180214951; 20180214955; 20180214984; 20180214985; 20180215094; 20180215103; 20180216501; 20180221950; 20180226917; 20180228570; 20180228612; 20180228613; 20180228737; 20180229300; 20180229434; 20180229436; 20180236546; 20180236551; 20180237325; 20180237329; 20180240691; 20180243094; 20180243097; 20180243950; 20180243977; 20180243991; 20180244862; 20180244863; 20180245281; 20180250737; 20180250739; 20180250744; 20180250745; 20180250746; 20180250771; 20180250772; 20180250773; 20180250774; 20180250775; 20180250890; 20180251645; 20180252398; 20180257138; 20180257297; 20180264551; 20180264679; 20180264719; 20180264720; 20180265417; 20180265738; 20180272464; 20180272610; 20180272652; 20180273707; 20180281236; 20180281237; 20180281282; 20180281283; 20180281284; 20180281294; 20180289493; 20180290212; 20180290373; 20180296343; 20180297113; 20180297114; 20180297117; 20180297272; 20180297296; 20180299237; 20180299359; 20180303491; 20180303616; 20180304353; 20180304359; 20180304360; 20180304361; 20180304363; 20180304364; 20180304365; 20180304369; 20180304370; 20180304440; 20180304537; 20180304540; 20180305266; 20180307209; 20180309202; 20180311731; 20180311734; 20180311735; 20180311738; 20180318657; 20180318922; 20180318925; 20180318928; 20180318932; 20180318933; 20180319081; 20180319108; 20180319150; 20180320006; 20180323514; 20180326488; 20180326663; 20180326664; 20180326665; 20180326668; 20180328673; 20180333911; 20180333912; 20180333913; 20180337110; 20180338196; 20180343749; 20180345367; 20180345382; 20180345405; 20180345411; 20180345575; 20180345576; 20180347188; 20180354304; 20180354860; 20180355199; 20180356297; 20180360609; 20180361510; 20180361660; 20180361661; 20180361666; 20180361674; 20180369918; 20180369960; 20180370114; 20180370120; 20180370125; 20180370147; 20180370846; 20180370860; 20180371244; 20180374262; 20190000166; 20190001412; 20190001553; 20190001563; 20190001564; 20190001570; 20190001576; 20190002353; 20190009472; 20190010270; 20190017185; 20190017465; 20190020105; 20190022427; 20190022428; 20190022725; 20190022752; 20190022926; 20190026499; 20190030601; 20190030602; 20190030605; 20190030809; 20190030810; 20190030811; 20190031908; 20190031911; 20190033719; 20190033737; 20190039182; 20190039294; 20190039367; 20190047047; 20190047212; 20190047214; 20190047222; 20190047277; 20190054695; 20190054696; 20190054697; 20190061250; 20190077083; 20190083110; 20190084235; 20190084236; 20190090989; 20190105991; 20190118261; 20190118475; 20190134908; 20190143406; 20190143601; 20190143602; 20190151943; 20190176395; 20190177473; 20190180291; 20190184432; 20190202114; 20190224749; 20190254660; 20190254670; 20190258748; 20190264048; 20190265150; 20190270138; 20190299362; 20190315062; 20190333622; 20190337231; 20190352455; 20190352521; 20190353265; 20200001537; 20200015896; 20200023577; 20200031993; 20200039409; 20200055241; 20200061653; 20200061655; 20200061656; 20200061920; 20200061922; 20200062952; 20200086568; 20200101535; 20200130256; 20200139622; 20200140706; 20200141337; 20200147879; 20200164322; 20200164466; 20200176225; 20200189037; 20200198229; 20200205812; 20200205813; 20200205815; 20200205816; 20200223140; 20200227763; 20200238382; 20200238383; 20200238386; 20200238387; 20200246918; 20200247045; 20200254691; 20200257933; 20200269320; 20200269496; 20200269497; 20200276753; 20200277687; 20200282247; 20200290122; 20200290278; 20200290280; 20200307077; 20200307090; 20200307095; 20200307097; 20200307099; 20200307107; 20200307147; 20200308744; 20200316832; 20200316854; 20200338639; 20200346409; 20200368965; 20200397959; 20200398481; 20200406546; 20210008615; 20210009754; 20210031459; 20210053120; 20210053280; 20210053294; 20210086251; 20210086439; 20210086449; 20210094102; 20210101334; 20210122087; 20210129425; 20210146439; 20210146449; 20210147625; 20210170495; 20210179498; 20210189374; 20210205889; 20210206092; 20210206941; 20210221063; 20210221066; 20210232120; 20210237364; 20210252788; 20210252803; 20210268727; 20210277180; 20210277192; 20210277232; 20210290342; 20210331251; 20210331382; 20210331396; 20210354388; 20210362407; 20210370406; 20210387259; 20210394268; 20210394330; 20210394438; 20220002844; 20220008999; 20220025334; 20220033593; 20220055113; 20220056305; 20220062996; 20220064758; 20220072767; 20220073677; 20220079579; 20220097135; 20220098350; 20220148802; 20220152931; 20220168948; 20220169785; 20220176454; 20220179396; 20220187847; 20220190243; 20220193995; 20220197306; 20220205363; 20220212407; 20220213319; 20220219393; 20220219402; 20220220858; 20220227686; 20220235194; 20220245574; 20220250145; 20220260968; 20220266517; 20220281172; 20220288676; 20220297376; 20220298303; 20220304679; 20220304683; 20220304684; 20220304685; 20220304686; 20220304687; 20220304714; 20220304715; 20220305553; 20220313145; 20220313245; 20220313246; 20220313247; 20220313248; 20220313255; 20220313256; 20220313257; 20220313258; 20220313259; 20220313260; 20220313261; 20220313262; 20220313874; 20220315673; 20220324177; 20220331506; 20220331673; 20220339704; 20220348363; 20220363002; 20220363799; 20220363800; 20220363840; 20220372236; 20220380536; 20220389145; 20220396510; 20220403486; 20230015620; 20230016693; 20230029131; 20230055790; 20230056427; 20230056630; 20230062971; 20230078448; 20230083724; 20230098602; 20230102048; 20230105651; 20230112233; 20230120932; 20230123322; 20230130334; 20230131878; 20230135943; 20230137027; 20230145370; 20230149647; 20230150030; 20230150203; 20230158737; 20230163276; 20230173395; 20230191402; 20230203448; 20230206329; 20230207426; 20230214925; 20230219134; 20230222454; 20230222531; 20230257566; 20230264428; 20230270191; 20230277748; 20230288911; 20230295425; 20230302533; 20230310729; 20230312841; 20230338278; 20230340211; 20230356359; 20230373158; 20230374215; 20230382025; 20230382044; 20230390825; 20230392628; 20230407357; 20230415411; 20230419304; 20240044353; 20240052167; 20240059025; 20240075528; 20240075687; 20240080991; 20240091906; 20240092014; 20240100596; 20240100775; and 20240102139.

GPU/SIMD references: U.S. Pat. Nos. 9,539,501; 9,544,451; 9,547,957; 9,549,253; 9,560,221; 9,563,599; 9,571,268; 9,571,270; 9,584,681; 9,589,590; 9,596,263; 9,600,237; 9,602,289; 9,607,462; 9,621,525; 9,641,541; 9,690,498; 9,698,979; 9,703,963; 9,722,777; 9,736,021; 9,747,172; 9,749,297; 9,767,271; 9,773,432; 9,778,912; 9,792,160; 9,811,671; 9,818,136; 9,818,249; 9,832,226; 9,846,814; 9,854,001; 9,892,661; 9,904,544; 9,904,579; 9,906,360; 9,906,552; 9,910,970; 9,912,472; 9,916,538; 9,917,850; 9,923,723; 9,923,923; 9,953,166; 9,954,579; 9,954,677; 9,9610,50; 9,965,249; 9,971,891; 9,973,334; 9,984,255; 9,990,180; 9,996,387; 9,998,426; 10,009,171; 10,009,180; 10,019,586; 10,027,487; 10,038,640; 10,044,564; 10,061,563; 10,073,985; 10,075,384; 10,089,478; 10,142,353; 10,146,810; 10,153,895; 10,153,897; 10,158,492; 10,163,137; 10,169,571; 10,171,523; 10,194,829; 10,204,233; 10,210,346; 10,212,135; 10,212,173; 10,250,572; 10,250,589; 10,255,414; 10,263,786; 10,263,793; 10,265,994; 10,275,675; 10,277,481; 10,291,408; 10,291,411; 10,296,012; 10,296,748; 10,296,752; 10,311,442; 10,311,515; 10,320,561; 10,334,037; 10,338,913; 10,341,426; 10,356,061; 10,360,395; 10,363,657; 10,367,677; 10,374,863; 10,375,037; 10,380,362; 10,382,200; 10,388,097; 10,397,039; 10,406,687; 10,412,020; 10,427,655; 10,430,263; 10,430,598; 10,437,993; 10,438,190; 10,439,812; 10,440,121; 10,445,965; 10,447,668; 10,454,674; 10,461,923; 10,461,943; 10,467,437; 10,467,694; 10,480,947; 10,484,170; 10,484,346; 10,484,361; 10,491,536; 10,495,725; 10,504,314; 10,505,917; 10,509,672; 10,516,533; 10,521,496; 10,521,775; 10,523,582; 10,523,707; 10,529,041; 10,529,042; 10,536,167; 10,536,263; 10,540,205; 10,552,588; 10,554,634; 10,574,459; 10,585,809; 10,588,002; 10,594,490; 10,599,072; 10,601,787; 20170078091; 20170085441; 20170093575; 20170099272; 20170104584; 20170113664; 20170147391; 20170169737; 20170173262; 20170213028; 20170220404; 20170230179; 20170237556; 20170253069; 20170257383; 20170264620; 20170285976; 20170288856; 20170300872; 20170301033; 20170301047; 20170310478; 20170331577; 20170331670; 20170337398; 20170352012; 20170353435; 20170359316; 20170371623; 20170374027; 20180004701; 20180004702; 20180006803; 20180007032; 20180011692; 20180074790; 20180091484; 20180115587; 20180122271; 20180131507; 20180144147; 20180157487; 20180159691; 20180183601; 20180183827; 20180197007; 20180204111; 20180205747; 20180225448; 20180225661; 20180227275; 20180232502; 20180255031; 20180255445; 20180262530; 20180275565; 20180293538; 20180300487; 20180307763; 20180309567; 20180329744; 20180330109; 20180343114; 20180351941; 20180357422; 20180357434; 20180367466; 20180367467; 20180375829; 20190007207; 20190012909; 20190020629; 20190026724; 20190028273; 20190028282; 20190028283; 20190028284; 20190043050; 20190044976; 20190052617; 20190058696; 20190068562; 20190081959; 20190087594; 20190087793; 20190089687; 20190097865; 20190102569; 20190103964; 20190104121; 20190132356; 20190149317; 20190158340; 20190166030; 20190171438; 20190171612; 20190178980; 20190199692; 20190200888; 20190201691; 20190205898; 20190207757; 20190207916; 20190213359; 20190220611; 20190224441; 20190229924; 20190236879; 20190236880; 20190236881; 20190245688; 20190247662; 20190251199; 20190253237; 20190259099; 20190265645; 20190270118; 20190273619; 20190286421; 20190312854; 20190313246; 20190321583; 20190327124; 20190356482; 20190378134; 20200007459; 20200012488; 20200013251; 20200021602; 20200027096; 20200028745; 20200036523; 20200045028; 20200050430; 20200050483; 20200051062; 20200053020; 20200058019; 20200059373; 20200064444; 20200064456; 20200067913; 20200074422; 20200082362; 20200082363; 20200082364; 20200084189; 20200086078; 20200090272; 20200099658.

1. A method of analyzing an additive manufacturing powder, comprising:
measuring a dynamic thermal response over time to a thermal wave propagating through a layer of additive manufacturing powder; and
classifying at least one characteristic of the additive manufacturing powder based on the measured dynamic thermal response to the thermal wave and at least one classification criterion.

2. The method according to claim 1, further comprising irradiating a portion of the layer with a localized energy beam, to excite the thermal wave.

3. The method according to claim 2, wherein the portion of the layer irradiated by the localized energy beam is displaced from a location of measurement of the dynamic thermal response over time to the thermal wave in the layer.

4. The method according to claim 1, wherein the at least one characteristic of the additive manufacturing powder is selected from the group consisting of a composition, a reuse history, a particle size characteristic, an aging, an oxidation, a density, a specific heat, a volumetric heat capacity, an effective thermal conductivity, a thermal conductivity of particle core, a thermal conductivity of particle shell, an interfacial thermal resistance, a phase change temperature, a phase change energy, an optical absorptivity, an infrared emissivity, a deposition thickness, an inter-particle thermal resistance, a substrate-particle thermal resistance, and an adulteration.

5. The method according to claim 1, wherein the classification comprises using a classification processor trained with empirical data, to classify the additive manufacturing powder.

6. The method according to claim 5, wherein the classification processor comprises a statistical classifier.

7. The method according to claim 5, wherein the classification processor implements at least one of a neural network, a linear discriminant analysis, a naïve Bayesian classification, a K-nearest neighbors analysis, a support vector machine, an independent component analysis, a principal component analysis, a kernel principal component analysis, a uniform manifold approximation and projection, graph network analysis, a blind source separation, a factor analysis, a non-negative matrix factorization, a multidimensional scaling, a singular value decomposition, a local linear embedding, a Laplacian Eigenmapping, and a t-Distributed Stochastic Neighbor Embedding.

8. The method according to claim 1, further comprising calibrating at least one of a characteristic of the additive manufacturing powder, and a measurement of the dynamic thermal response over time.

9. The method according to claim 1, wherein the layer is within an additive manufacturing machine having a localized energy beam adapted in a first state to excite the dynamic thermal response without causing fusion of the powder, and in a second state to induce fusion of the powder.

10. The method according to claim 1, wherein the layer is within an additive manufacturing machine having a localized energy beam to induce fusion of the powder, further comprising adjusting at least one of a focus, an energy, a scanning speed, and a scanning path of the localized energy beam in dependence on the measured dynamic thermal response.

11. The method according to claim 1, further comprising detecting a phase transition of the additive manufacturing powder in dependence on the measured dynamically measured thermal response.

12. A method of analyzing a powder, comprising:
providing a layer of the powder on a structure;
irradiating a region of the powder with a localized energy beam;
measuring a dynamic thermal response of the layer of powder outside of the region to the irradiating over time; and
classifying the measured thermal dynamic thermal response using a machine learning processor trained with data dependent on at least one classification criterion of the powder selected from the group consisting of a composition, a history of use, a particle size characteristic, an aging, an oxidation, a density, a specific heat, a volumetric heat capacity, a effective thermal conductivity, thermal conductivity of particle core, a thermal conductivity of particle shell, an interfacial thermal resistance, a phase change temperature, a phase change energy, an optical absorptivity, an infrared emissivity, a deposition thickness, an inter-particle thermal resistance, a substrate-particle thermal resistance, and an adulteration.

13. The method according to claim 12, wherein the at least one classification criterion is the composition of the powder.

14. The method according to claim 12, wherein the machine learning processor comprises a neural network.

15. The method according to claim 12, wherein the layer is within an additive manufacturing machine having the localized energy beam adapted in a first state to excite the dynamic thermal response without causing fusion of the powder, and in a second state to induce fusion of the powder.

16. The method according to claim 12, wherein the layer is within an additive manufacturing machine having the localized energy beam to induce fusion of the powder, further comprising adjusting at least one of a focus, an or energy, a scanning speed, and a scanning path of the localized energy beam in dependence on the measured dynamic thermal response.

17. The method according to claim 12, wherein the layer is within an additive manufacturing machine having the localized energy beam adapted in a first state to induce fusion of the powder, and in a second state to excite the dynamic thermal response without causing fusion of the powder, and wherein a first location of the localized energy beam on the layer of powder in the first state is different from a second location of the localized energy beam on the layer of powder in the second state.

18. The method according to claim 12, further comprising detecting a phase transition of the additive manufacturing powder in dependence on the measured dynamically measured thermal response.

19. A system for analyzing an additive manufacturing metal powder, comprising:
an energy source configured to heat a region of a layer of the additive manufacturing powder with a time varying energy irradiation, to induce a thermal wave in the layer emanating from the region;
a pyrometer or thermometer configured to measure an amplitude and phase of the induced thermal wave in the layer of powder from region spot over time; and
a machine learning processor configured to predict a characteristic of the additive manufacturing powder in dependence on the measured amplitude and phase of the induced thermal wave in the layer of powder and training data for the machine learning processor.

20. The system according to claim 19, wherein:
the characteristic of the additive manufacturing powder is selected from the group consisting of at least one of a composition, a mixture ratio, a reuse, a particle size characteristic, an aging, an oxidation, a density, a specific heat, a volumetric heat capacity, an effective thermal conductivity, a thermal conductivity of a particle core, a thermal conductivity of a particle shell, an interfacial thermal resistance, a phase change temperature, a phase change energy, an optical absorptivity, an infrared emissivity, a deposition thickness, an inter-particle thermal resistance, a substrate-particle thermal resistance, and an adulteration of the additive manufacturing powder; and
the machine learning processor implements at least one of a neural network, linear discriminant analysis, naïve Bayesian classification, a K-nearest neighbors analysis, a support vector machine, independent component analysis, principal component analysis, kernel principal component analysis, a uniform manifold approximation and projection analysis, graph network analysis, blind source separation, factor analysis, non-negative matrix factorization, multidimensional scaling, singular value decomposition, local linear embedding, Laplacian Eigenmapping, and t-Distributed Stochastic Neighbor Embedding.
